(19) United States
(12) Patent Application Publication
(10) Pub. No.: US 2014/0184471 A1
(43) Pub. Date: Jul. 3, 2014

(54) DEVICE WITH DISPLAYS

(71) Applicants: Vladislav Martynov, Moscow (RU); Anton Tarasenko, Saint-Petersburg (RU); David Slocum, St. Temecula, CA (US); Dmitry Chalykh, Moscow (RU); Arseniy Nikolaev, Moscow (RU); Alexey Roslyakov, Kolomna (RU); Alexey Sazonov, Ufa (RU); Andrey Ivanov, Saint-Petersburg (RU)

(72) Inventors: Vladislav Martynov, Moscow (RU); Anton Tarasenko, Saint-Petersburg (RU); David Slocum, St. Temecula, CA (US); Dmitry Chalykh, Moscow (RU); Arseniy Nikolaev, Moscow (RU); Alexey Roslyakov, Kolomna (RU); Alexey Sazonov, Ufa (RU); Andrey Ivanov, Saint-Petersburg (RU)

(21) Appl. No.: 14/099,169

(22) Filed: Dec. 6, 2013

Related U.S. Application Data
(60) Provisional application No. 61/787,333, filed on Mar. 15, 2013.

(30) Foreign Application Priority Data
Dec. 7, 2012 (GB) 1222054.7
Dec. 13, 2012 (GB) 1222457.2
Dec. 20, 2012 (GB) 1222987.8
Dec. 20, 2012 (GB) 1223011.6
Feb. 25, 2013 (GB) 1303275.0

(51) Int. Cl. G06F 3/14

(52) U.S. Cl. CPC G06F 3/1423
USPC 345/1.2

(57) ABSTRACT

According to a first aspect of the invention, there is provided a display assembly device comprising first and second faces, the first face arranged to present a first display and the second face arranged to present an optional second display, the device further comprising a computer system operable to run a plurality of application programs using one or more processors to execute a set of stored instructions, wherein the one or more processors is configured by the set of instructions to limit arrangements in which content is displayable on at least one of the displays as display content associated with an application program provisioned on a device infrastructure of the display assembly device.

This non-provisional patent application claims priority based upon the prior patent applications entitled “UX bible”, application number GB1222054.7, filed Dec. 7, 2012, “Device with displays”, application number GB1223011.6, filed Dec. 20, 2012, “Device with displays”, application number GB1303275.0, filed Feb. 25, 2013, “Device with displays”, application number U.S. 61/787,333 filed Mar. 15, 2013, in the name of Vladislav Martynov and Anton Tarasenko, “Reversed mode”, application number GB1222457.2, filed Dec. 13, 2012, and “Reversed mode 2”, application number GB1222987.8, filed Dec. 20, 2012, herein all such applications in their entirety incorporated by reference.

### FIELD

The field of the invention relates to display devices comprising a plurality of displays, and to related methods and computer program products.

### BACKGROUND

Present day display devices and their associated computer systems running application programs are able to display content on the display devices without limitation. This can lead to complex display output on the devices, including display of for example incoming text messages, incoming emails, meetings appointments, calendar events and incoming phone calls, sometimes simultaneously. Such complex information display can produce a sense of bewilderment or alienation in a user of the display device, especially for technophobe users or elderly users. This can lead some people to limit the use, or to avoid the use, of such technology. It is desirable to provide a device, method and computer program product which better control the use of a display of the device so as to avoid the sense of bewilderment or alienation in a user of the display device which can occur when the use of the display is poorly controlled.

The pervasiveness of computing devices is ever increasing. For example, users can interact with a traditional desktop computer, a tablet computer, a mobile phone, and so on to access a variety of functionality for work and personal uses. Additionally, the variety of functionality that is available to users of these mobile devices also continues to increase, including complexity of application workflows and multimedia capabilities.

These days the ability to interact with an application on one or more screens is available in the desktop environment, however use of one or more screens in the mobile environment is not compatible with contextual image display coordination. Current users need to leverage their devices to provide for both uninterrupted interaction of the user with device expressed functionality (e.g. executing applications) and the ability to know what state their current application and/or device is operating under. It is also desirable for power management concerns to selectively use the screen or screens of a mobile device while still providing for efficient and convenient use of the device and application functionality desired by the user.

Additionally, current mobile devices are increasing relied upon by the user to provide for virtual reality experiences and assistance with everyday tasks, as facilitated via visual displays of information. However, in the mobile environment there are always competing interests for device cost, device functionality provisions and limitations, and/or device power consumption and battery life, when considering a desired mobile device configuration to take into proper account ultimate user interest for a particular device.

Additionally, networked mobile devices allow for a certain level of interaction between the users of remote devices. The present invention aims at improving the level of interaction.

### SUMMARY OF THE INVENTION

It is an object of the present invention is to provide display data coordination for an application on a device and method with one or more screens to obviate or mitigate at least one of the above-presented disadvantages.

It is an object of the present invention is to provide display data manipulation for an application on a device and method with one or more screens to obviate or mitigate at least one of the above-presented disadvantages.

It is an object of the present invention is to provide display data coordination of an executing application on a device and method with one or more screens to obviate or mitigate at least one of the above-presented disadvantages.

It is an object of the present invention is to provide display data manipulation concerning touch gestures on a device and method with one or more screens to obviate or mitigate at least one of the above-presented disadvantages.

It is an object of the present invention is to provide haptic data manipulation concerning input/output on a device and method with one or more screens to obviate or mitigate at least one of the above-presented disadvantages.

It is an object of the present invention is to provide haptic data presentation concerning input/output on a device and method with one or more screens to obviate or mitigate at least one of the above-presented disadvantages.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to a first aspect of the invention, there is provided a display assembly device comprising first and second faces, the first face arranged to present a first display and the second face arranged to present an optional second display, the device further comprising a computer system operable to run a plurality of application programs using one or more processors to execute a set of stored instructions, wherein the one or more processors is configured by the set of instructions to limit arrangements in which content is displayable on at least one of the displays as display content associated with an application program provisioned on a device infrastructure of the display assembly device.

The device, wherein the display content is based on an identified state of the application program to result in display data transferred from the first display to the second display. The device, wherein the display content is based on an identified state of the device infrastructure to result in display data transferred from the first display to the second display. The device, wherein the display content is based on an identified state of the device infrastructure to result in display data redirected from display on the first display to display on the second display. The device, wherein the device infrastructure has the state of the first display in a powered off mode. The device, wherein the display content represents a notification message. The device, wherein the display content is from the software program that is authenticated to display data on the first display. The device, wherein the display content is based on an identified event of the application program to result in contextual display data displayed on the second display based on application workflow event performed by the software application via the first display. The device, wherein the display content is based on an identified event of the device infrastructure to result in contextual display data displayed on the second display based on application workflow event performed by the device infrastructure via the first display. The device, wherein the display content is based on an identified event of the device infrastructure or the application program to result in display data redirected from display on the first display to display on the second display. The device, wherein the device infrastructure has a state of the first display in a powered off mode. The device, wherein the display content is based on haptic input and output related to a user interface operation of the user interface of the device and haptic related data received by a network device over a communications network, a network interface of the device connected to the network interface to send and receive haptic related data.

According to a second aspect of the invention, there is provided a display method for a device assembly comprising first and second faces, the first face arranged to present a first display and the second face arranged to present an optional second display, the device further comprising a computer system operable to run a plurality of application programs using one or more processors to execute a set of stored instructions, wherein the one or more processors is configured by the set of instructions to limit arrangements in which content is displayable on at least one of the displays as display content associated with an application program provisioned on a device infrastructure of the display assembly device.

According to a third aspect of the invention, there is provided a bar form factor display device comprising front and back major faces, the front major face arranged to present a first display and the back major face arranged to present a second display different to the first display, the device further comprising a computer system operable to run a plurality of application programs, wherein the computer system is configured to limit arrangements in which content is displayable on the second display by the application programs.

The bar form factor display device can be one wherein the arrangements are limited in that just a single screen type or layer is displayable on the second display at any one time.

The bar form factor display device can be one wherein the screen type or layer is from a predefined hierarchy of screen types or layers and the highest screen type or layer in the hierarchy that is called by the computer system is displayed on the second display.

The bar form factor display device can be one wherein the hierarchy of screen types or layers includes: temporary modal notifications, render screen, temporary full screen notifications, time and date, notification collections, and wallpaper.

The bar form factor display device can be one wherein each screen type or layer stays on the second display until it is dismissed or until it is replaced by a screen of higher priority.

The bar form factor display device can be one wherein each screen type or layer stays on the second display until replaced by a new screen or layer.

The bar form factor display device can be one wherein when the second screen switches from one information layer type (e.g. notifications, commitments, wallpaper) to another, the entire second screen is replaced entirely with a different information layer image filling the entire second screen.

The bar form factor display device can be one wherein the arrangements are limited in that the entire second screen content is limited to being generated by a single application program at a given time.

The bar form factor display device can be one wherein the arrangements are generated by a small set of possible applications.

The bar form factor display device can be one wherein the set contains less than ten applications.

The bar form factor display device can be one wherein the arrangements are generated by a dedicated set of routines callable by the application programs.

The bar form factor display device can be one wherein full screen notifications are displayed on the second display until dismissed.

The bar form factor display device can be one wherein full screen notifications displayed on the second display are stacked in order of appearance.

The bar form factor display device can be one wherein full screen notifications displayed on the second display are stacked up to a maximum number of stacked notifications.

The bar form factor display device can be one wherein third party applications are operable to display full screen notifications on the second display.

The bar form factor display device can be one wherein the second display is operable to display notifications in two user-selectable modes, one mode showing notifications at a greater level of content detail than the other mode.

The bar form factor display device can be one wherein the two user-selectable modes are operable to be user-disabled.

The bar form factor display device can be one wherein the device includes a setting according to which for any application a notification is displayed on the first display which corresponds to a notification displayed on the second display.

The bar form factor display device can be one wherein the application programs are of three types in general: applications displaying on first display only, applications displaying on the second display only, and applications displaying on the first display and on the second display.

The bar form factor display device can be one wherein the different types of application programs are presented on the first display or on the second display in different icon styles.

The bar form factor display device can be one wherein applications which provide display output on the second display have a user-selectable option to move content from the first display to the second display.

The bar form factor display device can be one wherein applications which provide display output on the first display or on the second display have a user-selectable option to move content from the first display to the second display.

The bar form factor display device can be one wherein only one second screen application can display output on the second screen at one time.

The bar form factor display device can be one wherein the device is operable to receive a user instruction to select a todo list from first display and put it on the second display.

The bar form factor display device can be one wherein the device is operable to receive a user instruction to take a first display screen screenshot and place it on the second display screen without any additional action.

The bar form factor display device can be one wherein a put-to-back screenshot history of screenshots moved from the first display to the second display is selectable as a separate application icon in the first display screen.

The bar form factor display device can be one wherein the device is operable to receive a user instruction to select a screenshot from the history and put it to second display from the first display screen application.

The bar form factor display device can be one wherein displayed content includes location-dependent content.

The bar form factor display device can be one wherein displayed content includes context-dependent content.

The bar form factor display device can be one wherein the second display screen automatically displays text or images that trigger memories or remind one of past moments.

The bar form factor display device can be one wherein the second screen automatically displays text or images that trigger memories or remind one of past moments in a way that is location dependent.

The bar form factor display device can be one wherein the second display screen displays simply a brand logo as a default screen, for a period controlled by the brand owner.

The bar form factor display device can be one wherein the second display screen is operable to display a brand logo as a reward.

The bar form factor display device can be one wherein the device is operable to distribute a reward to a user in response to the user allowing the device second display screen to carry a brand logo for a defined time.

The bar form factor display device can be one wherein TXT format messages from a defined set of users are automatically re-formatted to use a predefined stylised font with a predefined size.

The bar form factor display device can be one wherein TXT format messages from a defined set of users are automatically re-formatted to use a predefined stylised font, a predefined size and a predefined layout.

The bar form factor display device can be one wherein the device can declare facts about itself with a human twist on the second display screen.

The bar form factor display device can be one including context dependent wallpaper on the second display screen.

The bar form factor display device can be one including social network feeds integrated into a wallpaper layer on the second display screen.

The bar form factor display device can be one including cameras on the first major face and on the second major face, the computer system including facial recognition software detecting which display a user is looking at.

The bar form factor display device can be one wherein the second display is a bi-stable display.

The bar form factor display device can be one wherein the first display is a touch screen, or the second display is a touch screen, or the first display and the second display are touch screens.

The bar form factor display device can be one wherein the second display is a touch screen, and wherein second screen output is configurable as a configurable response to a selectable touch input gesture on the second screen of the device.

The bar form factor display device can be one wherein the device is portable.

The bar form factor display device can be one wherein the device is a mobile phone.

The bar form factor display device can be one wherein the computer system is configured to limit arrangements in which content is displayable on the second display in that the computer system includes a secure processor configured to limit arrangements in which content is displayable on the second display.

According to a second aspect of the invention, there is provided a method of limiting the arrangement in which content is displayable on a bar form factor display device, the device comprising front and back major faces, the front major face arranged to present a first display and the back major face arranged to present a second display different to the first display, the device further comprising a computer system operable to run a plurality of application programs, wherein the computer system is configured to limit arrangements in which content is displayable on the second display by the application programs, the method comprising the step of: limiting the arrangement in which content is displayable on the second display by an application program.

According to a third aspect of the invention, there is provided a computer program product for a bar form factor display device, the device comprising front and back major faces, the front major face arranged to present a first display and the back major face arranged to present a second display different to the first display, the device further comprising a computer system operable to run a plurality of application programs, wherein the computer system is configured to limit arrangements in which content is displayable on the second display by the application programs, the computer program product operable to limit the arrangement in which content is displayable on the second display by an application program.

### BRIEF DESCRIPTION OF THE DRAWINGS

The detailed description is described with reference to the accompanying figures. The use of the same reference numbers in different instances in the description and the figures can indicate similar or identical items.

FIG. 1 shows a relation between a set of application programs, for a second screen of a mobile assembly;

FIG. 2 shows the front face and back face of an example device for the applications of FIG. 1 representing an example power reduction mode;

FIG. 3 shows the front face and the back face of a further embodiment of device of FIG. 2;

FIG. 4A shows a front perspective view of an example device of FIG. 2;

FIG. 4B shows a back perspective view of an example device of FIG. 2;

FIG. 4C shows a side view of an example device of FIG. 2;

FIG. 5 shows the front face and the back face of a further example device of FIG. 2;

FIGS. 6 to 17 show examples of first or second screen output display data of the device of FIG. 2 or 3;

FIG. 18 shows an example of a hierarchy of priorities for use in deciding which information layer of the screen output of FIGS. 6-17;

FIGS. 19 to 21 show further examples of screen output display data of the device of FIG. 2 or 3;

FIG. 22 shows a further example device of the device of FIG. 2;

FIG. 23 shows an example in which a front screen display data content is moved between screens of the device of FIG. 3;

FIG. 24 shows examples of aspects of navigating on the screen of the device of FIG. 2 or 3;

FIG. 25 shows a further example of screen output display data when music application is executed on the device of FIG. 2 or 3;

FIG. 26 shows a further example of screen broadcast output display data when a camera application is running on the device of FIG. 2 or 3;

FIG. 27 shows a further example device of the device of FIG. 2 or 3;

FIGS. 28 to 33 show examples of screen gesture user input of the device of FIG. 2 or 3;

FIG. 34 shows a further example of FIG. 23.

FIG. 35 shows an example data processing system of the device of FIG. 2 or 3;

FIG. 36 shows an example of sensors as touch sensitive areas of the device of FIG. 2 or 3;

FIG. 37 shows an example of gestures related to the sensors of FIG. 36;

FIGS. 38 to 40 show further examples of gesture input to the sensors of FIG. 36;

FIGS. 41 to 44 show examples of gesture input and haptic output for the devices of FIG. 2 or 3;

FIGS. 45 to 47 show further examples of gesture input of FIG. 36;

FIG. 48 shows a further example of gesture input and haptic output of FIG. 36;

FIG. 49 shows an example of a menu button of the device of FIG. 2 or 3;

FIG. 50 shows an example of a menu button at a bottom of a screen of the device of FIG. 2 or 3;

FIG. 51 shows an example in which a screen application selection menu of the device of FIG. 2 or 3;

FIG. 52 shows examples of the ordering of screen applications in a selection menu of the device of FIG. 2 or 3;

FIG. 53 shows an example of multiple levels of screen notifications of the device of FIG. 2 or 3;

FIG. 54 shows a notification flow diagram example for a screen of the device of FIG. 2 or 3;

FIG. 55 shows a further example notification flow diagram example for a screen of the device of FIG. 2 or 3;

FIGS. 56 to 59 show examples of custom screen notifications of the device of FIG. 2 or 3;

FIG. 60 shows an example of a Go To Market Strategy;

FIG. 61 shows a further example of gestures on a screen of the device of FIG. 2 or 3;

FIG. 62 shows examples of results of defined gestures on a lock screen of the device of FIG. 2 or 3;

FIGS. 63 to 67 show examples of notifications on the screen of the device of FIG. 2 or 3;

FIGS. 68 and 69 show examples of reminders displayed on the screen of the device of FIG. 2 or 3;

FIG. 70 shows an example of a screen of the device of FIG. 2 or 3;

FIG. 71 shows an example of a screen of the device of FIG. 2 or 3;

FIGS. 72 and 73 show examples of reminders displayed on the screen of the device of FIG. 2 or 3;

FIG. 74 shows a reminder a screen of the device of FIG. 2 or 3;

FIG. 75 shows a further example mobile assembly having a pair of display screens of the device of FIG. 2 or 3;

FIG. 76 depicts example contextual display data of the assembly of FIG. 2 or 3;

FIG. 77 depicts a further example processing system of the assembly of FIG. 2 or 3;

FIG. 78 is an alternative embodiment of the mobile assembly of FIG. 2 or 3;

FIG. 79 is a further alternative embodiment of the mobile assembly of FIG. 2 or 3;

FIG. 80 is an alternative embodiment of the mobile assembly of FIG. 2 or 3;

FIG. 81 is an example method of the device of FIG. 2 or 3;

FIG. 82 is a further example method of the device of FIG. 2 or 3;

FIG. 83 is a further example method of the device of FIG. 2 or 3; and

FIG. 84 is a further example method of the device of FIG. 2 or 3.

### DETAILED DESCRIPTION

The claimed invention can be implemented in numerous ways, including as a computer process; a computer apparatus; a computer system; a mobile assembly having one or more than one display screen, as a mobile device having multiple on-board display screens or as a display screen enabled mobile device coupled to a mobile device cover also having a display screen, a computer program product embodied on a computer readable storage medium as a physical memory, a processor, such that one or more computer processors are configured to execute instructions stored on and/or provided by the physical memory coupled to the processor(s), and/or software embodied as asset of instructions when executed by processor(s) provide for the listed functionality expressed by the set of instructions in interaction(s) between the user and the device(s), operations/communication between or as a result of one or more processes (e.g. hardware processes, software processes) on the computer device(s), and for communication of data/information (e.g. display content) between the computing device and a cover device, remote network device, and/or processor(s), such as processor(s) configured to execute instructions stored on and/or provided by the physical memory coupled to the processor(s). As such, computer components and related functionality of the present invention are considered essential in order to provide for application coordination as further discussed below. As such, the coordinated display of contextual display data based on an application state can be implemented on one or more displays as desired. It is recognised for multi-display embodiments of the mobile assembly, the ability for the application to continue interaction with a user via one display screen while at the same providing for contextual display data display on another display screen can be advantageous since one display indicates a particular state of the application while the other display can be used by the user to step through an application workflow associated with that state (e.g. multiple actions of the application while in the same state). As noted, the single or multiple display(s) 12,14 can be on the mobile device, a cover of the mobile device, or both the cover and the mobile device of the mobile assembly, as desired.

The processor(s) can be embodied as on-board computer components a mobile device and/or distributed as multiple processors on-board both a mobile device and a coupled mobile device cover. In this specification, these implementations, or any other form that the invention can take, can be referred to as techniques. In general, the order of the steps of disclosed processes can be altered within the scope of the claimed invention. Unless stated otherwise, a component such as a processor or a memory described as being configured to perform a task can be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions. The processor can use or comprise the capabilities of a controller or microprocessor, for example. Accordingly, any of the functionality of the modules can be implemented in hardware, software or a combination of both. Accordingly, the use of a processor as a computer component and/or as a set of machine-readable instructions is referred to generically as a processor/module for sake of simplicity.

A detailed description of one or more embodiments of the claimed invention is provided below along with accompanying figures that illustrate the principles of the invention. The claimed invention is described in connection with such embodiments, but the claimed invention is not limited to any embodiment. The scope of the claimed invention is limited only by the claims and the claimed invention encompasses numerous alternatives, modifications and equivalents. Numerous specific details are set forth in the following description in order to provide a thorough understanding of the claimed invention. These details are provided for the purpose of example and the invention can be practiced according to the claims without some or all of these specific details. For the purpose of clarity, technical material that is known in the technical fields related to the claimed invention has not been described in detail so that the claimed invention is not unnecessarily obscured.

The disclosure of any feature(s) within a paragraph and/or feature(s) in different paragraphs can be combined as evident to a person skilled in the art.

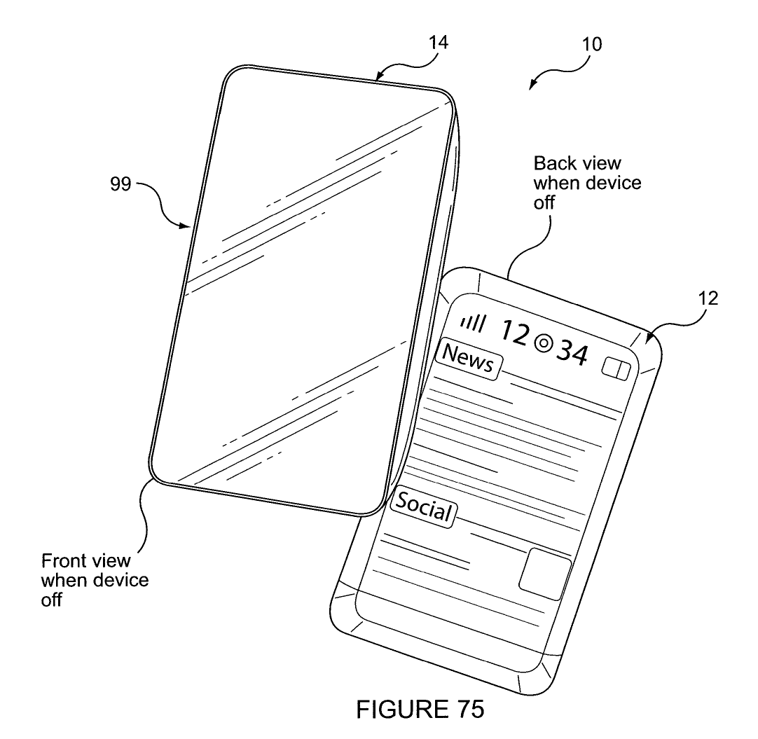

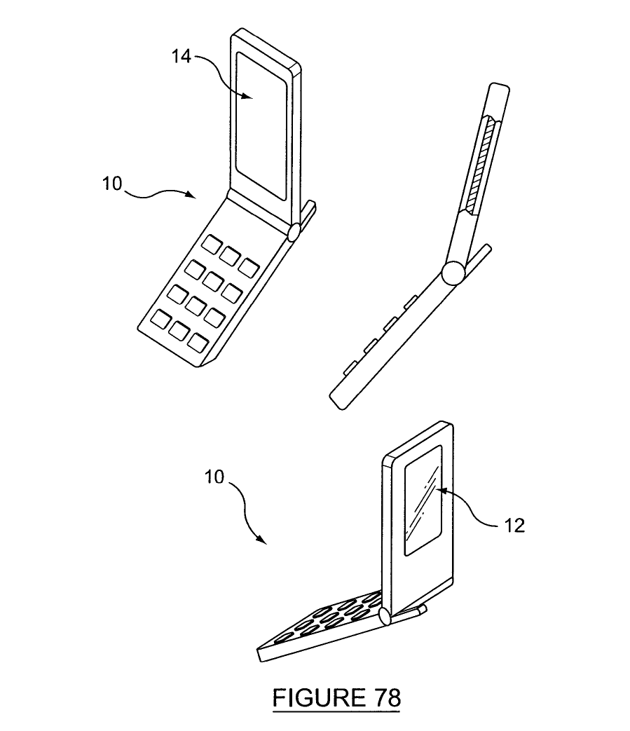

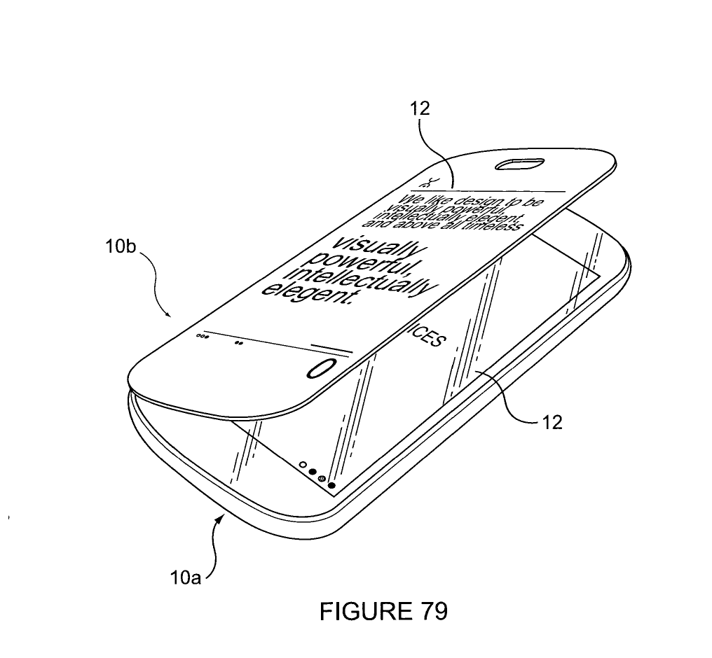

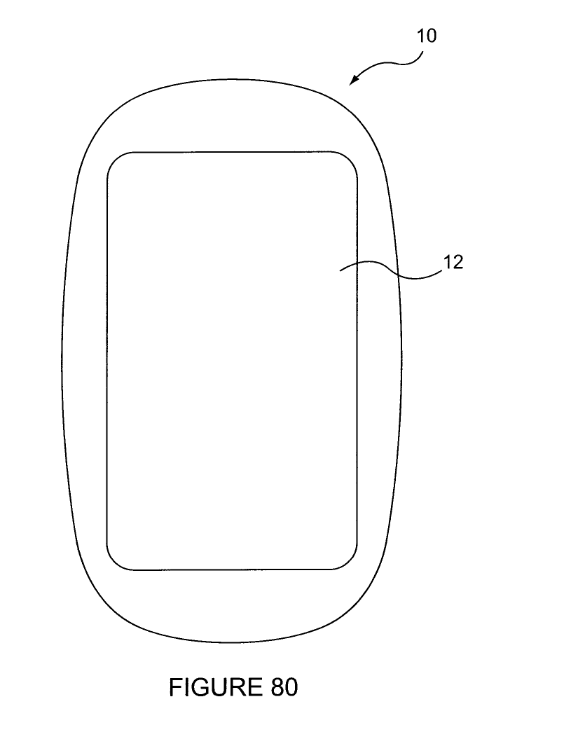

Referring to FIGS. 75 to 80, a mobile assembly 10 (e.g. single screen mobile device, a single screen mobile device cover, a dual screen mobile device (bar form factor, hinged design, etc.), a mobile device having a display screen coupled to a device cover having a further display screen, etc.) is shown configured to coordinate a display of a display data (e.g. still image, video images, text, etc.), also referred to as display data 9 that can reflect a state of an application 32 executing on a mobile assembly 10 including a pair of display screens having a first display screen 12 and a second display screen 14, the application 32 (e.g. call application, web application, camera/video application, map-based application, etc.) for interaction with a user of the mobile assembly 10. The first display screen 12 can be a bi-stable screen and the second display screen 14 can be a non-bi-stable screen. The first display screen 12 can be a non-bi-stable screen and the second display screen 14 can be a bi-stable screen. The first display screen 12 can be a bi-stable screen and the second display screen 14 can be a bi-stable screen. As noted, the single or multiple display(s) 12,14 can be on the mobile device, a cover of the mobile device, or both the cover and the mobile device of the mobile assembly, as desired, however for illustrative purposes only the mobile assembly is described by example only having a pair of display screens 12,14. It is recognised that for a single screen 12 embodiment, the display data (e.g. image) 9 can be displayed on the single display screen 12 as complementary display data or in substitution of display data of the application 32 related to workflow activities of workflow events 34 related to the application 32 execution via the display of interactive display data on the display screen 12. A general method is implemented by the mobile assembly 10, stored as a set of instructions 48 when executed by one or more computer processors 45 to implement the application 32 and/or display data 9 manipulation as display content 16,20 and/or to identify and respond to user interaction/input related to touch surfaces and/or other sensors 47 as described/demonstrated herein.

As further described below, the application workflow 30 of the determined application 32 state includes display data 9 displayed on a display (e.g. display screens 12,14) as a consequence of determination/identification of the application state that is associated with the display data 9. For example, an identification 18 of the application state is determined by a state module 36 based on application execution data received or otherwise requested from the executing application 32 and/or provided through identification of predefined user interaction activities (e.g. user presses focus button for camera application 32) identified as occurring with respect to a user interface 44 (e.g. including the display screens 12,14) by the user. As noted, the predefined user interaction activities can be identified 18 by computer processor(s) 45 (of the mobile device infrastructure of the mobile assembly 10) using electronic switching (depress of a physical switch or other physical electronic component) of hard buttons, sensor data for sensors 47 (e.g. motion sensor, temperature sensor, touch sensors related to touch screens or other touch sensitive areas, etc.), as the sensor and/or switching data is made available to the computer processor(s) 45 and associated executable instructions.

The identification 18 can include a change in a physical orientation of the mobile assembly 10, as detected by one or more sensors 47 (e.g. motion sensors, contact sensors, etc). For example, opening of a cover case 10b having one display screen 12, to reveal the second display screen 14 to the user, can be detected by the sensor(s) 47. Alternatively, the change in a physical orientation of the mobile assembly 10 can be when the mobile assembly 10 is turned around or otherwise flipped over (e.g. when the first display screen 12 is on one side of the mobile assembly 10 and the second display screen 14 is on the other side of the mobile assembly 10), as detected by motion or orientation sensors 47. Alternatively, the mobile assembly 10 can be embodied as a flip phone, such that the sensor(s) 47 can detect when the phone is opened and thus it is assumed that the user is now wanting to interact with the display screen 14 on the inside of the phone rather than the display screen 12 on the outside of the phone. In this manner, in general, it is recognised that the mobile assembly 10 is knowledgeable of which display screen 12,14 the user is using based on sensor 47 data indicating the physical orientation (i.e. change and resultant orientation) of the mobile assembly 10 itself. Alternatively or in addition to, the identification 18 can include state information provided to or otherwise requested from the application 32 during execution. Also, the identification 18 can include the detection of specified user interaction with the user interface 44 related to specific workflow events 34 (and therefore state) of the application 32.

The plurality of workflow events 34 of an application 32 workflow 30 can include sequential respective workflow events 34 involving events such as but not limited to: displaying output data of one or more ordered displays on a selected display 12,14; and receiving input data from one or more user inputs using the user interface 44 based on one or more input options represented by the output data, such that receiving and acting on the identification 18 is an event outside of the plurality of workflow events 34 of the workflow 30 of the application 32.

For example, the output data can be call data displayed as display data on a display screen 12 as a non-bi-stable screen related to the state of the application 32, the display data 9 can be displayed on the second display screen 14 as a bi-stable screen and includes call associated data. It is recognised that an example call associated data of the display data 9 can indicate call in progress, caller identifier (e.g. name, relation to the user, etc.) of the call, image associated with the state such as a telephone receiver, etc.

Alternatively, the output data can be message data displayed as display data on a non-bi-stable screen as the first display screen 12, the display data 9 is displayed on the second display screen 14 as a bi-stable screen and includes the message associated data. It is recognised that an example message associated data can be accept the message in progress, message identifier (e.g. name, relation to the user, etc.) of the message, image associated with the state such as a picture o the message sender, etc.

Other alternative embodiments of the display data 9 and identified 18 state of the application 32 can be: the application 32 is a map application such that the display data on the first display is a map related to a navigation state of the application 32 and the display data 9 includes an enlarged portion of the map displayed on the second display screen 14. In this case, the identification 18 can be a geographical position data provided by GPS or other capabilities o the network interface 40 of the mobile assembly to the computer processor(s) 45. An alternative embodiment is where the state of the mobile assembly 10 is geographical location information used in selecting the enlarged portion of the map. An alternative embodiment is where the first display 12 content is call data and the application 32 is a call-based application, such that the second display 14 having the display data 9 includes an indication that a call is in progress by the call based application 32.

Further, the state of the mobile assembly 10 (and/or application 32) can be a privacy mode used in restricting caller identification data from the display data 9. Alternatively, the state of the mobile assembly 10 (and/or application 32) is a privacy mode used in allowing caller identification data in the display data 9.

Alternatively, the application is an imaging application 32 such that the first display 12 of data is a soft interface of the imaging application 32 for workflow events 34 and the second display 14 of display data 9 includes identification of a user activity selected by the user from the soft interface. For example, the imaging application 32 includes at least one of camera functionality or video functionality as the user activity.

Alternatively, the state of the mobile assembly 10 is at least one of a sensed orientation or motion of the mobile assembly 10 used in providing instructional data to the second display 14 as the display data 9. The instructional data can be related to at least one of body positioning or a smile state of a target subject imaged in the first display 12 displayed as part of the workflow 30 of the application 32 for recording an image of the target.

Alternatively, the first display 12 of data is webpage content data and the application 32 is a web-based application, such that the display data 9 provides an indication of the state of the application 32 (e.g. websurfing in progress—do not disturb□). Alternatively, the first display 12 of data is text data and the application 32 is a reader-based application, such that the display data 9 provides an indication of the state of the application 32 (e.g. book reading in progress!!).

As discussed above, the first display 12 data can be on a non-bi-stable screen and the second display 14 data can be displayed on a bi-stable screen. As discussed above, the first display 12 data can be on a bi-stable screen and the second display 14 data can be displayed on a non-bi-stable screen. It is also recognised that both the display 12 data of the application 32 related to application workflow events 34 and the display data 9 reflecting a state identified 18 of the application 32 while processing the workflow events 34 can both be displayed to the same display screen 12,14, in particular for the embodiment of the mobile assembly 10 as a single screen device, either at the same time simultaneously or alternately as sequential display (i.e. one then the other data display on the same display screen 12).

In terms of workflow events 34 performed in relation to the first display screen 12 while display data 9 is displayed reflecting the state of the workflow events 34 shown on the first display screen 12, the output data is image data displayed as the display data on a non-bi-stable screen as the first display screen 12, the display data 9 is displayed on the second display screen 14 as a bi-stable screen. The display 12 content 16, reflecting workflow events 34 of the application 32 for a given state reflected by the display data 9, can include one or more input options as one or more image/text manipulation commands, and the input data is the user input providing a manipulation command of the one or more image/text manipulation commands. The manipulation command can be selected from the group consisting of: a pan command; a scroll command; a zoom command; and/or a remove image command. As such, the display data 9 can remain the same for a series of the manipulation commands performed on the display 12 and/or can be updated with different content as display content 20 to reflect the different or otherwise changing manipulation commands used by the user during workflow event interaction with the application 32 output provided on the display 12.

Techniques described herein can be used to manage workflow related to display data 9 (e.g. reflecting the state of the application 32), including processing (e.g. display on the first display screen 12) display content received from applications 32 (or via a network interface 40) and then displayed as updated display content on the display screen 12, such that the content of the display data 9 is statically or otherwise dynamically changed as display data 20 on the display screen 14 as the display content 16 on the display screen 12 is updated.

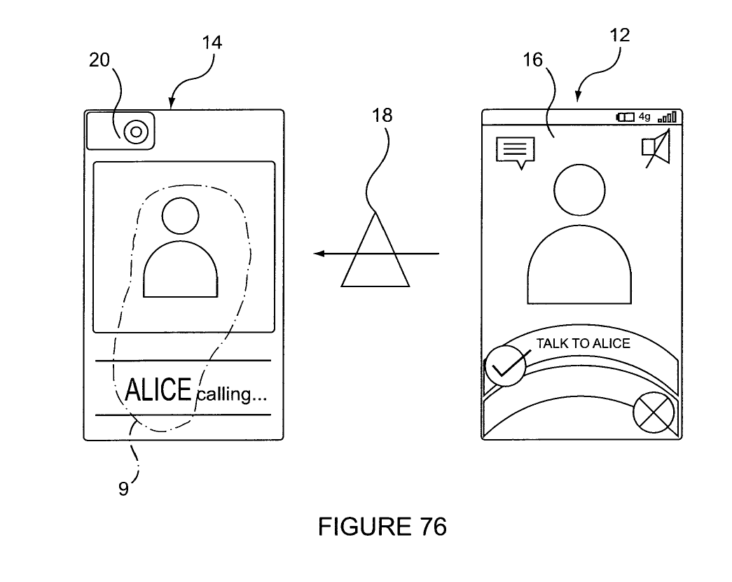

Referring again to FIGS. 76-80 a general coordination method implemented by the mobile assembly 10 is provided, stored as a set of instructions 48 when executed by one or more computer processors 45 to: identify 18 the state of the application 32 providing display content as first display data 16 to the first display screen 12; access a memory 46 storing a predefined contextual display data 9 associated with the state; select the predefined contextual display data 9 from the memory 46, the predefined contextual display data 9 including at least one of descriptive text or descriptive image reflecting the state; and display the predefined contextual display data 9 as second display data 20 on the second display screen 14.

Based on the above, it is recognised that the workflow 30 of the application 32 can be performed as a series of workflow events 34 on a single display screen 12,14, as the application 32 can be configured to perform the workflow 30 using display content 9 to a single screen 12,14 and receiving user input via the user interface 44 in response to the displayed content (i.e. display data). However, alternatively, the mobile assembly 10 is also configured to utilize a pair of display screens 12,14 to provide for the application workflow 30 on a first display screen 12 and the display data 9 provided on the second display screen 14 rather than on the first display screen 12. This use of one display screen 14 rather than the other display screen 12 is initiated by receiving the identification event 18 by the computer processor(s) 45 configured to coordinate the display screens 12,14. As such, the mobile assembly 10 is so configured to either implement the application workflow 30 ad display data 9 on a single display screen 12,14, or use the second display screen 14 for display of the display data 9 once the state has been identified 18 based on receipt of the identification event 18.

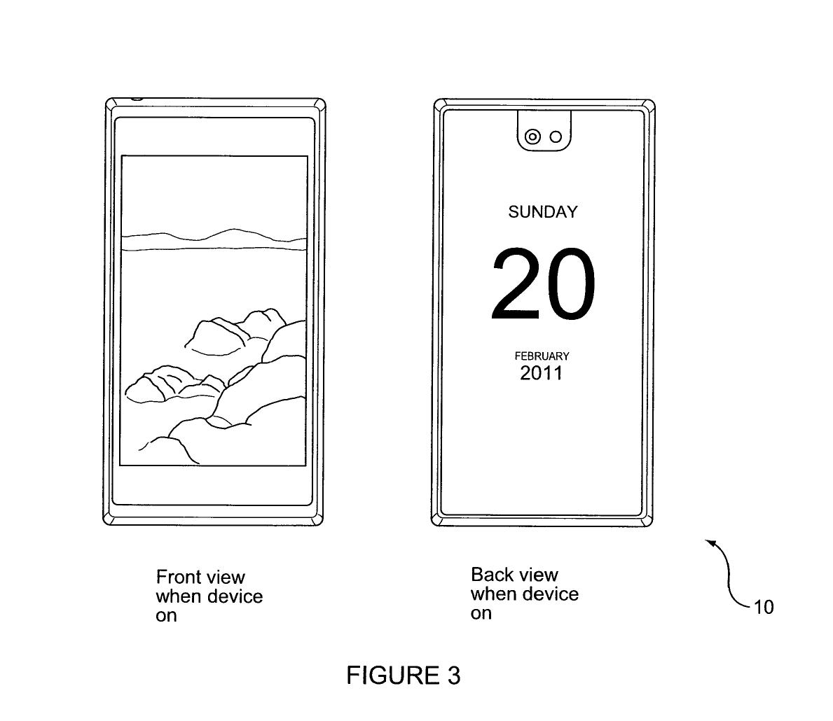

Alternatively, as further described below, the application workflow 30 includes display content 9 shared on two more of the multiple displays (e.g. display screens 12,14), such that a transfer event 18 is provided through user interaction with a user interface 44 (e.g. including the display screens 12,14). The transfer event 18 can include a change in a physical orientation of the mobile assembly 10, as detected by one or more sensors 47 (e.g. motion sensors, contact sensors, etc.—see FIG. 3). For example, opening of a cover case 10b having one display screen 12, to reveal the second display screen 14 to the user, can be detected by the sensor(s) 47. Alternatively, the change in a physical orientation of the mobile assembly 10 can be when the mobile assembly 10 is turned around or otherwise flipped over (e.g. when the first display screen 12 is on one side of the mobile assembly 10 and the second display screen 14 is on the other side of the mobile assembly 10), as detected by motion or orientation sensors 47. Alternatively, the mobile assembly 10 can be embodied as a flip phone, such that the sensor(s) 47 (e.g. motion sensor, temperature sensor, touch sensors related to touch screens or other touch sensitive areas, etc.) can detect when the phone is opened and thus it is assumed that the user is now wanting to interact with the display screen 14 on the inside of the phone rather than the display screen 12 on the outside of the phone, as the sensor and/or switching data is made available to the computer processor(s) 45 and associated executable instructions. In this manner, in general, it is recognised that the mobile assembly 10 is knowledgeable of which display screen 12,14 the user is using based on sensor 47 data indicating the physical orientation (i.e. change) of the mobile assembly 10 itself.

As further described below, the transfer of display content 9 from one display screen 12 to the other display screen 14 (as facilitated by one or more computer processors of the mobile assembly 10 configured to implement the display content 9 transfer) can be implemented using display format changes and/or taking into account operational characteristic difference(s) of the display screens 12,14. For example, the ability for the user to complete one part of application workflow over another can be dependent of the lack of (or presence of) an operational characteristic (or suitable level thereof) of one display screen 12,14 as compared to the other display screen 12,14.

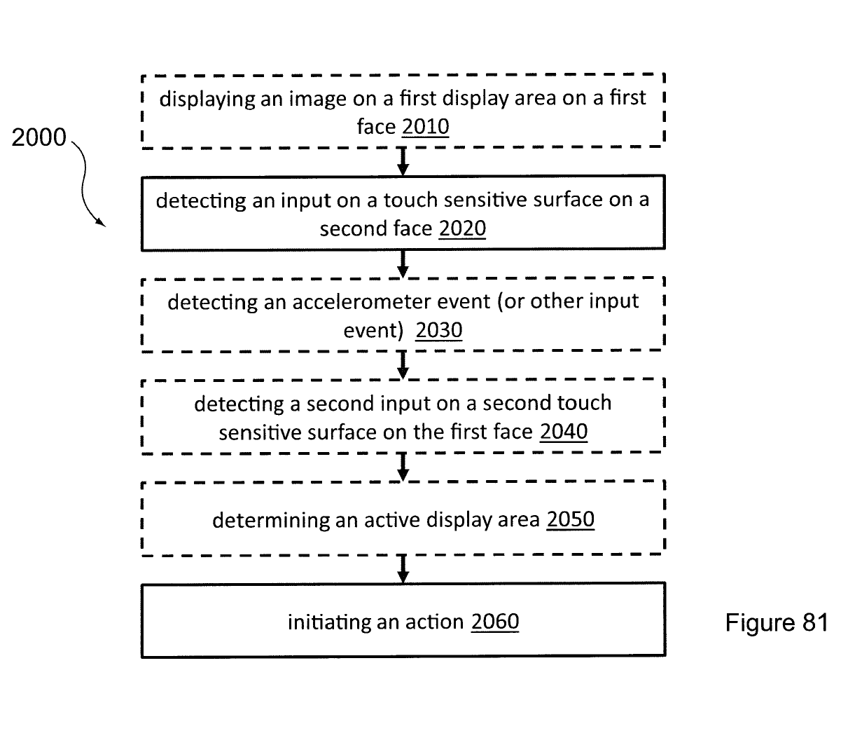

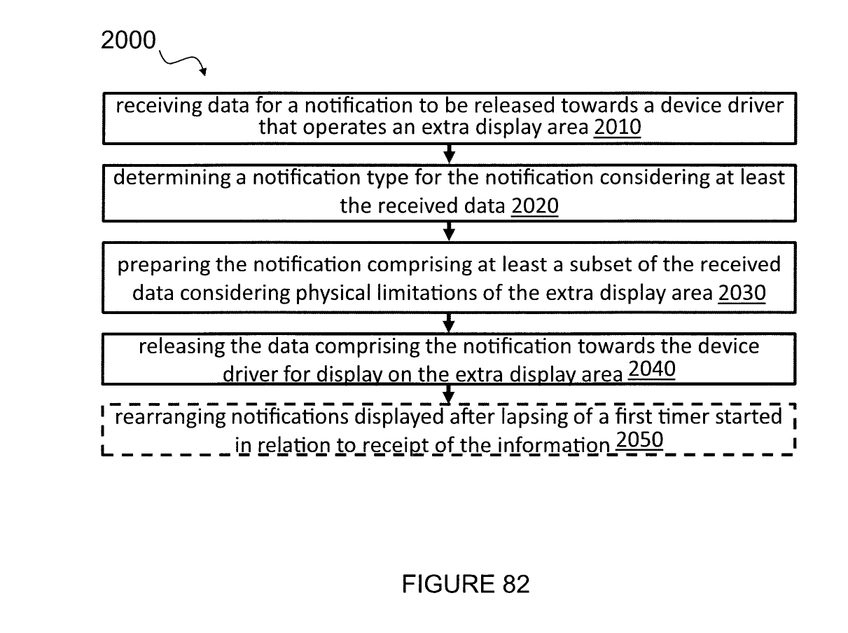

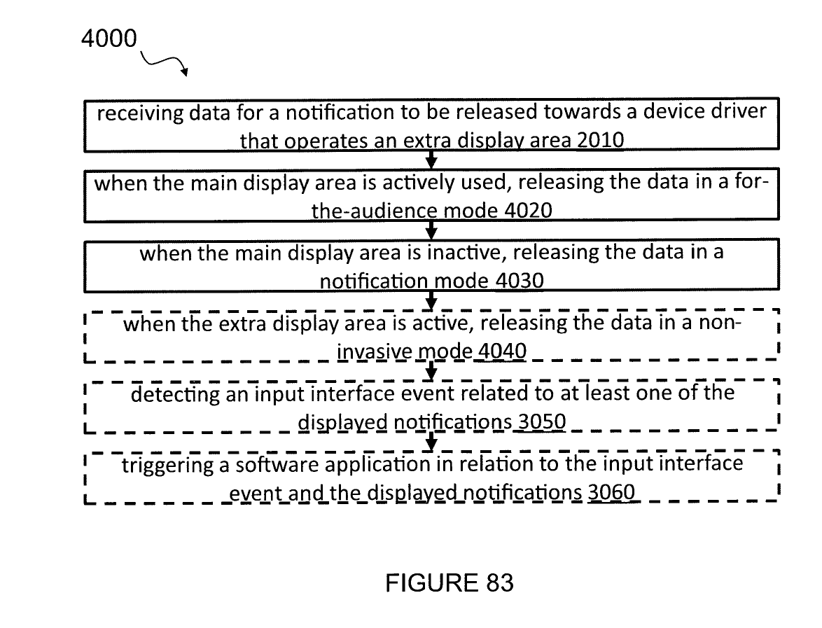

Alternatively, referring to FIG. 81,82 concerning notification message processing 2000, following reception of the data (2010), a notification type is determined for the notification, using the processor module 45, considering at least the received data (2020). Exemplary notification types include real-time notification type, call notification type, messaging notification type, reminder notification type, location-based notification type, voicemail notification type, social network and system notification type, not-categorized notification type, etc. The notification type can be inherent from the received data and determined there from by the processor module 45 (e.g., phone call data is call notification type) or can be explicitly mentioned in the received data (e.g., a specific field in the received data) and read from the received data by the processor module 45.

The processor module 45 then prepares the notification comprising at least a subset of the received data (2030). The processor module 45 considers physical limitations of any extra display area of the display 12,14 in order in the preparation of the notification. For instance, the notification would be prepared differently for the extra display area in the example where the extra display area is of bi-stable technology or Electronic Paper Display (EPD) technology compared to Liquid Crystal Display (LCD) technology or active-matrix organic light-emitting diode (AMOLED) technology, to mention only a few technologies. Other characteristics such as resolution, size, refresh rate of the extra display area can be consider as physical limitations. Concerning the bi-stable technology, preparing the notification by the processor module 45 can use conversion of an image content from the received data into a grayscale image further stored into the memory module 46. Other physical limitations (e.g., location and characteristics of physical cutouts into the extra display area) can be considered for preparing the notification.

The display device 10 then detects, through the touch control module 47 (e.g. touch sensitive surface associated with a display screen 12,14 (e.g. overlaying the display screen 12,14 or otherwise separate from and not overlapping the display screen 12,14), an input on the touch sensitive surface 47 on a second face of the display device 10 (step 2020), also referred to as reverse mode as the touch sensitive surface on the second face is different from the face containing the display screen 12,14 (e.g. the second touch surface could be of the face for display screen 14 when the user is interacting with display screen 12). The input represents a detectable input occurrence, e.g., on the touch sensitive surface. The input, or gesture, can take different forms (e.g., tap, double tap or multi-tap, swipe, double swipe, fingerprint, complex figure as an iconic gesture, etc.). The different forms of the input can also depend on the touch detection technology used by the touch sensitive surface 47 (e.g. touch control module 47 as a sensor or touch control module 36 as a software component) (e.g., resistive, surface acoustic wave, capacitive (surface capacitance, projected capacitance (mutual capacitance, self-capacitance)), infrared grid, infrared acrylic projection, optical imaging, dispersive signal technology, acoustic pulse recognition, etc.). While different touch detection technology can be used, the capacitive technology is currently dominant and the examples of can take the characteristics and limitations of the capacitive technology into account. However, other technology could also be used without affecting the present invention. Specifically, a touch detection technology that could also provide some measurement of the pressure exerted by or during the input (or gesture) could be used to enhance the different use cases related to the present invention. The input can also be caused by different detectable elements in close or direct contact with the touch sensitive surface 47, such as one or more fingers of a user, one or more stylus, one or more nails, etc.

The display device can also further detect an accelerometer event (step 2030) from the accelerometer module 47, if ever present (or, similarly, another additional input event from the additional input module). The accelerometer or additional input event can be detected (step 2030) concurrently or sequentially with the input detected on the touch sensitive surface at step 2020 (i.e., before, with at least some time overlap or after). Following the reception of the data (2010), which display area is actively used can be determined. When the main display area is actively used, then notification data comprising the notification can be released towards the device driver for display on the extra display area in a for-the-audience mode (4020). When the main display area is inactive (powered off or in dark mode), the notification data comprising the notification can then be released towards the device driver for display on the extra display area in a notification mode (4030). When the extra display area is actively used, the notification can then be displayed on the extra display area in a non-invasive mode (4040).

An input interface event related to at least one of the displayed notifications can also be detected by the processor module 45 (e.g., via the touch control module 36,47 the accelerometer module 47, etc.) (3050). The input interface event can be a touch input detectable, e.g., on the touch sensitive surface 47. The touch input, or gesture, can take different forms (e.g., tap, double tap or multi-tap, swipe, double swipe, fingerprint, complex figure as an iconic gesture, etc.). The different forms of the touch input can also depend on the touch detection technology used by the touch sensitive surface 47 and the touch control module 36,47 (e.g., resistive, surface acoustic wave, capacitive (surface capacitance, projected capacitance (mutual capacitance, self-capacitance)), infrared grid, infrared acrylic projection, optical imaging, dispersive signal technology, acoustic pulse recognition, etc.). The touch input can also be caused by different detectable elements in close or direct contact with the touch sensitive surface 47, such as one or more fingers of a user, one or more stylus, one or more nails, etc. The input interface event can also be an accelerometer event from the accelerometer module 36,47, if ever present (or, similarly, another additional input event from additional input modules). For instance, as the electronic device 10 is rotated, the notification is removed from the extra display area and a corresponding notification is added to the main display area (e.g., leaving the notification on the active display area). The accelerometer 47 or additional input event can be detected concurrently or sequentially with the touch input detected on the touch sensitive surface 47 as the input interface event.

A software application 32 in relation to the input interface event and the displayed notifications can then be triggered (3060). Triggering the software application 32 can comprise launching a predefined software application 32 to run on the processor module 45, launching a voice-recognition function of the electronic device 10, performing a predefined function in an active software application currently running on the processor module 45, launching a predefined networked software application 32 to run on, or performing a predefined function in an active networked software application 32 currently running on, the processor module 45 (e.g., an iconic gesture input (drawing a heart or other symbol) on the touch sensitive surface 47 over the extra display area initiates a messaging application (e.g., new message or reply to the contact mentioned in the notification) by the processor module 45). The processor module 45 can further provide an interactive display by the software application on the main display area 12 of the electronic device 10 and remove the prepared notification from the image displayed on the extra display area.

The display device 10 shows the optional second touch sensitive surface 47 and the optional second display area 14. It should also be understood that any combination of the areas 12,14 could be display areas and that each face of the display device 10 could be separated in any number of separate display areas 12,14 (e.g., there could be at least as many display areas 12,14 as there are faces to the display device 10). Only the top face and one lateral face are described of the device case 99, as an example, but skilled person will readily understand that the bottom face and/or other lateral face could be used as well. The second touch sensitive surface 47 is shown on the same face as the first display area 12, but other combinations could be made. The second display area 14 is shown together with the touch sensitive surface 47. However, in some other embodiments, the touch sensitive surface 47 and the second display area 14 can be on separate faces of the display device 10 (not shown) or the touch sensitive surface 47 and the second display area 14 can be on an accessory (not shown) connected to the display device 10, which does not affect the teachings of the present invention.

In some embodiment (now shown) the first display area 12 and the second display area 14 can be on the same face of the display device 10 and can further be based on different display technologies (LED/AMOLED vs. EPD/bi-stable). In the context of the example shown, a second input is detected, by the touch control module 36,47, on the second touch sensitive surface 14 on the first face (step 2040). The second input, if present, can be provided concurrently or sequentially with the first input (i.e., before, with at least some time overlap or after).

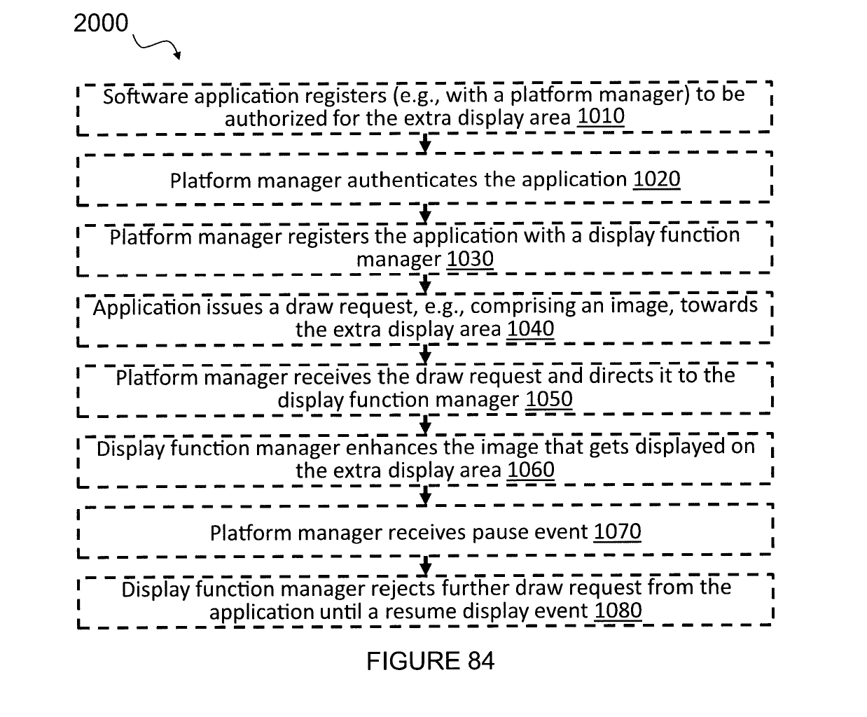

Alternatively, in the example depicted on FIG. 84, a software application 32 registers (e.g., with the platform manager 36) to be authorized for the extra display area (1010), such as the second display screen 14 provided as a bi-stable display. The platform manager 36 authenticates the application 32 (1020) and registers the application 32 with the display function manager 36 (1030). When the application 32 issues a draw request, e.g., comprising an image, towards the extra display area 14 (1040), the platform manager receives 36 the draw request and directs it to the display function manager 36 (1050). The display function manager 36 enhances the image that gets displayed on the extra display area 14 (1060). If the platform manager 36 receives pause event (1070), then it informs the display function manager 26 that rejects further draw request from the application until a resume display event is further received (1080). It is recognised that the mangers 36 can be the same or different software components (or hardware components) of the device infrastructure of the processing system of the device 10.

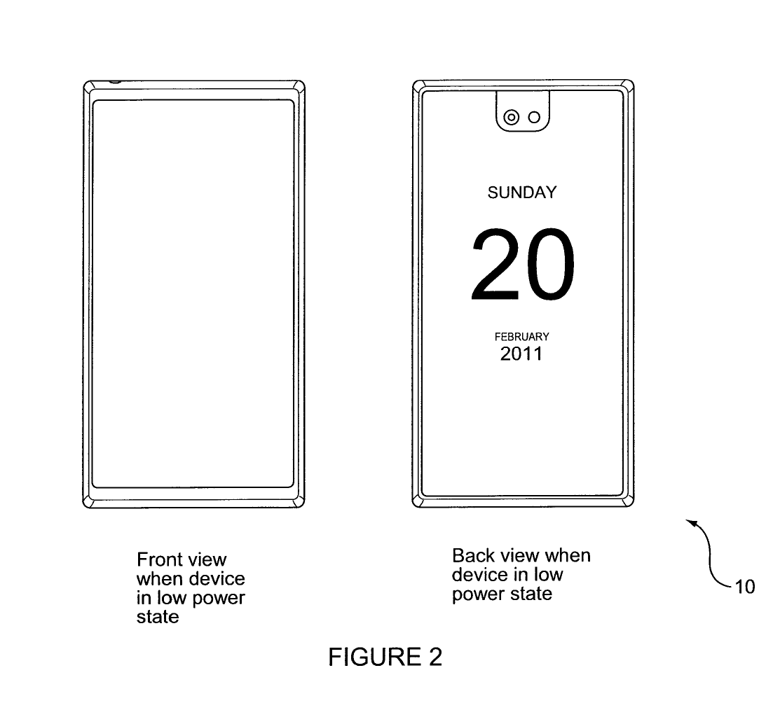

Alternatively, for the device 10, see by example FIG. 2 or 3, an input is received by the device infrastructure 42. In some embodiments, the input is received from the input interface module 44. The input can thus be received from one or more hardware module of the mobile device 10 (e.g., an accelerometer event, readings from various sensors (47), etc.). The input can further be received be received from a software application 32 executing on the processor module 45 of the mobile device 10. The input can also be received through the processor module 45 as an inter-process communication from a software application 32 executing on the processor module 45 of the electronic device 10. The input can also be related to a procedure call received from the software application 32 executing on the processor module 45 of the electronic device 10. The input can also be received over the network interface module 40 of the mobile device 10 (e.g., as a SMS, MMS, email, network coverage related notification (loss, change, recovery; detected locally or received from outside the device. etc.). In some embodiments, the input can be received from more than one source. For instance, upon reception of an SMS over the network interface module 40, a touch input 47 event can further be received. The received SMS and the touch input 47 can form the input received by the mobile device 10.

In response to the received input, the mobile device 10 can send a message addressed to a second mobile device (not shown), via the network interface module 40, for providing haptic response at the second mobile device. An example of software application 32 that can execute on the processor module 45 is a send-something application, for which settings can be adjusted from a first display 12,14 area application icon. A “local” send-something application is able to pair with one or more “remote” send-something applications executing on remote mobile devices having an second display area (not shown). Once paired, the local send-something application can send data to one or more remote send-something applications, e.g., for display on the remote mobile devices' second display area. The send-something application can allow for choosing from a predefined list of send-something templates stored in memory 46, editing text in each template, editing haptic instructions in each template, adding his/her own image, choosing several send-something screens and switch therebetween (e.g., with a touch input from a touch sensitive surface 47 near or at the second display 12,14 area such as a left/right swipe at the back screen), adding one or more remote mobile devices and sending send-something data directly to at least one of them.

Upon completion of the sending of the message over the network 11, the haptic response can further be provided via a return communication via the network 11 by the mobile device 10.

The haptic module 36 of the mobile device 10 can be used to correlate an image, a text, a video or a sound associated with the message. The haptic module 36 can comprise a hardware vibration component. The haptic response can be a mechanical movement of the hardware vibration component. The haptic module 36 can further comprise a speaker module. The haptic response can be a mechanical movement of a speaker of the speaker module. The speaker can be a flat panel loudspeaker. The input can be a pressure measurement obtained from the flat panel loudspeaker.

The processor module 45 can further be for, upon completion of the sending of the message, providing the haptic response at the mobile device 10 though the haptic module 36. The input can be at least one of a key press event from a physical or virtual keyboard of the mobile device 10 and a discrete input from a button of the mobile device 10. The mobile device 10 can further comprise an accelerometer module 47. The input can be an accelerometer event from the accelerometer module. The haptic response can be correlated by the processor module 45 in at least one of magnitude, speed and amplitude with the accelerometer event. The mobile device 10 can further comprise the touch sensitive surfaces 47. The input can be a gesture event from the one or more touch sensitive surfaces 47. The haptic response can be correlated by the processor module 45 in at least one of magnitude, speed and amplitude with the gesture event.

The input can be haptic data received via a cover 10b of the mobile device 10a. The haptic data can comprise a gesture from a touch sensitive surface of the mobile device 10a and/or cover 10b. The instructions for providing a haptic response can be prepared such that the haptic response matches the haptic data.

The instructions for providing a haptic response can also be prepared considering limitations of the second mobile device such that some aspects of the haptic data cannot be considered and the haptic response partially matches the haptic data.

For example, the haptic response can be related to an image, a text, a video or a sound associated with the message. The haptic response can be a mechanical movement of a hardware vibration component. The haptic response can be a mechanical movement of a speaker, e.g. the speaker is a flat or curved panel loudspeaker. Further, the input can be pressure measurement obtained from the panel loudspeaker.

### Display Device Assembly 10 System Examples

It is recognised that for a single screen 12 embodiment of the mobile assembly 10, the display data (e.g. image) 9 can be displayed on the single display screen 12 as complementary display data or in substitution of display data of the application 32 related to workflow activities of workflow events 34 related to the application 32 execution via the display of interactive display data on the display screen 12.

Also described are examples where the display of the display content 9 as first display data 16 on the first display screen 12, according to the first workflow event 34, can be performed while the relevant application 32 (i.e. that application 32 needed to implement the second workflow event 34 and/or subsequent workflow events 34) is inactive (i.e. unlaunched or otherwise existing as a dormant executable process on mobile assembly device infrastructure—alternatively as partially unlaunched or otherwise existing as a partially dormant executable process on mobile assembly device infrastructure) during the display of the display content 9 as first display data 16 on the first display screen 12. As such, the relevant application 32 is (in whole or in part) placed in an activated state in order for the second workflow event 34 to be executed using the active application 32, after the display content 9 is displayed as the first display data 16 on the first display screen 12. An example of this is where a device manager receives the display content 9 from a network interface 40 or other active application and then sends the display content 9 directly to the first display screen 12 without using the associated application 32 (for the display content 9) to assist or be otherwise aware of the display content 9 known to the device manager. When the display content 9 is transferred to the second display screen 14, the device manager informs the associated application 32 of the display content 9 present on the second display screen 14 and that a second workflow event 34 is the next step in the application workflow 30 (as the first workflow event 3 of display of the display content 9 has already been performed by the device manager on behalf of the associated application 32).

The following sections describe examples of a variety of different techniques that relate to application display content 9 (e.g. notifications), such as receipt of display content 9 (for example via the network connection interface 40, analyzing contents of the display content 9 to determine which application 32 corresponds to the display content 9 received, selection of one or more portions of the display content 9, amending the format of the display content 9 based on operational characteristic(s) of the display screens 12,14 and/or launching the relevant application 32 or otherwise reviving the relevant dormant application 32 (e.g. after receipt and display of the display content 9 on the first display screen 12 as first display data 16 for the first workflow event 34) in order to provide for the display of the display content 9 as second display data 20 on the second display screen 14 according to the second work flow event 34 executed by the relevant and (e.g. now) active application 32. The configuration of the executable instructions 48 to define use of one display screen 12,14 over the other display screen 12,14 is relevant to the differing operational characteristics of the display screens 12,14, e.g. operational power differences, screen geometrical configuration differences, active verses disabled difference, display screen orientation difference (e.g. one display screen 12,14 is considered/known by the processor(s) 45 as viewable by the user while the other display screen is considered/know to be unviewable or otherwise of limited view by the user), etc.

This switch or transfer from one display screen 12 to the other display screen 14 mid workflow 30 is initiated by receiving the transfer event 18 by the computer processor(s) 45 configured to coordinate the sharing of application workflow 30 across different display screens 12,14. As such, the mobile assembly 10 is so configured to either implement the application workflow 30 on a single display screen 12,14, or to transfer mid workflow 30 (e.g. first workflow event 34 on the first display screen 12 and the second workflow event 34 on the second display screen 14 of the workflow 30) based on receipt of the transfer event 18.

Optional steps can be, step 114, display an intermediate display of a lock screen on the second display screen 14 prior to accepting the user input from the user interface 44 as the activity associated with execution of the second workflow event 34. Also to receive an unlock input from the user interface 44 before accepting the user input from the user interface 44 as the activity associated with execution of the second workflow event 34. Alternatively, step 114 can be, receive an unlock input from the user interface 44 before accepting the user input from the user interface 44 as the activity associated with execution of the second workflow event 34, such that display a user unlock request along with the second display data. Also, display additional content data related to the display content along with the second display data after receiving an unlock input in response to the user unlock request. For example, where the additional content data is supplemental content such as a contact name.

In terms of user interaction or assembly configuration for triggering the display of the data 9 and/or otherwise updating the content of the data 9 as displayed, this can be defined by actions (user or system) such as but not limited to: a touch gesture using a touch sensitive surface of the user interface 44 associated with the first display screen 12 or the second display screen 14; a motion gesture using a motion sensor 47 of the user interface 44; a voice command using a microphone of the user interface 44; user touch on multiple external surfaces of the mobile assembly 10 as sensed by sensor(s) 47 and/or touch sensitive areas (e.g. touch screens); gesture without touch; application related request; a timer event based on a lapse of a predefined period of time; action sent from a remote computer device via a network 11 connection; a geo-location based event or action; and/or a button activation using a hard or soft button of the user interface 44. In terms of user input, this can be defined by actions such as but not limited to: a touch gesture using a touch sensitive surface of the user interface 44 associated with the display screen(s) 12,14; a motion gesture using a motion sensor 47 of the user interface 44; a voice command using a microphone of the user interface 44; user touch on multiple external surfaces of the mobile assembly 10 as sensed by sensor(s) 47 and/or touch sensitive areas (e.g. touch screens); gesture without touch; and/or a button activation using a hard or soft button of the user interface 44.

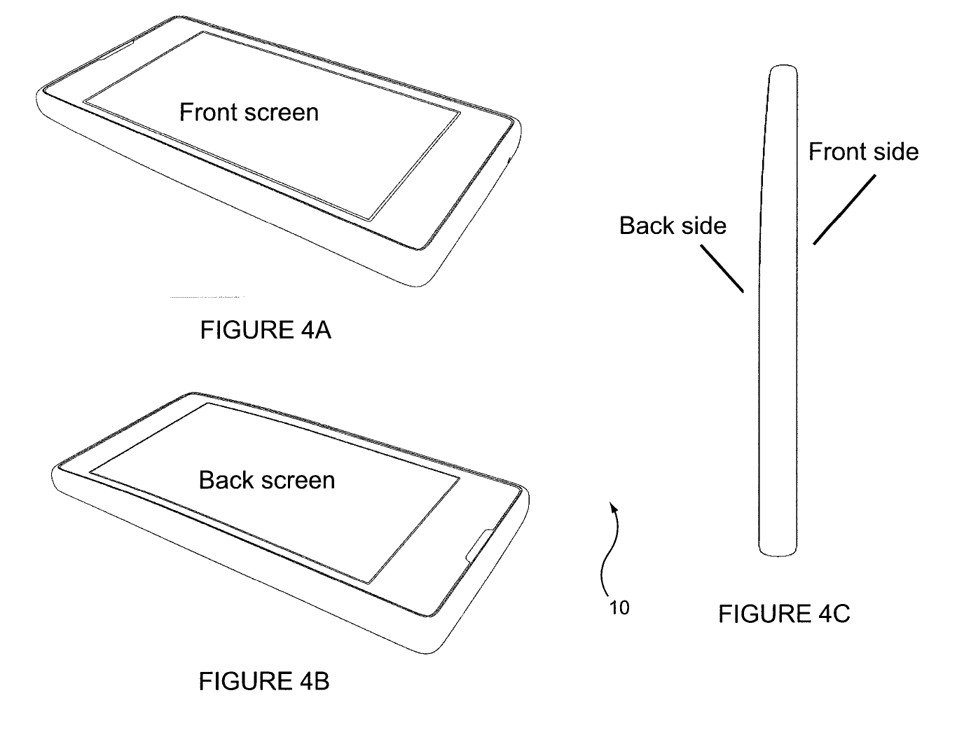

As such, it is recognised that that the workflow events 34 can be performed on the first display screen 12 while the contextual display data 9 is displayed on the second display screen 14. It is also recognised that the user is actively involved in making the decision to continue the workflow 30 (to perform further workflow events 34) by interacting with the application 32 via information displayed on the first display screen 12 or other parts of the user interface 44 (e.g. voice commands/output received via the microphone and speakers of the user interface 44). The active involvement of the user can include a change in the physical orientation of the mobile assembly 10 (e.g. flip the mobile assembly 10 over to indicate a change in state of the application 32, open cover case of the mobile assembly 10 to indicate a change in state of the application 32, open flip phone to indicate a change in state of the application 32, and/or a user input recognised by the user interface 44 (see FIG. 4) such as but not limited to: user double taps (taps or swipes it left) or other recognised user gesture for touch screen or non-touch screen based gestures; touch on every point of the surface of the mobile assembly 10; gesture without touch such as shaking of the phone or other voice command; application related user input (like requests from games, applications); timer input based on timeout of a predefined period of time; user input action sent from a remote computer system or smart phone/tablet; and/or geo-location events/actions.

Accordingly, it recognised that the identification 18 can be based on a detected change in the physical orientation as detected/identified by the sensor(s) 47. Accordingly, it recognised that the identification 18 can be based on a detected user input detected/identified by the computer processor(s) 45 via the user interface 44. Accordingly, it recognised that the identification 18 can be based on a detected change in the physical orientation as detected/identified by the sensor(s) 47 followed by a user input detected/identified by the computer processor(s) 45 via the user interface 44. Accordingly, it recognised that the identification 18 can be based on a detected user input detected/identified by the computer processor(s) 45 via the user interface 44 followed by a change in the physical orientation as detected/identified by the sensor(s) 47.

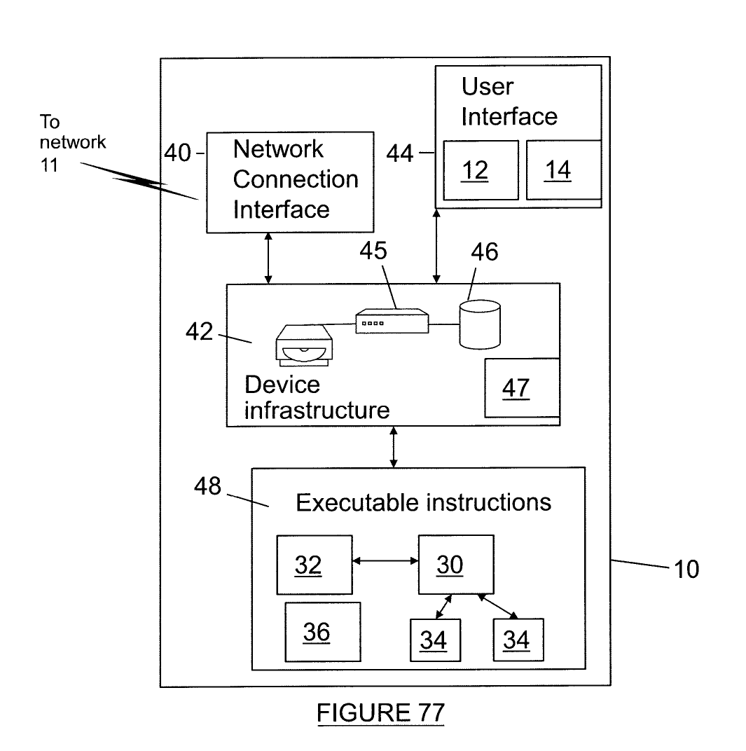

A computing device 10 (see FIG. 77) implementing functionality of the application (e.g. state) coordination system can include the network connection interface 40, such as a network interface card or a modem, coupled via connection to a device infrastructure 42. The connection interface 40 is connectable during operation of the devices to the network 11 (e.g. an intranet and/or an extranet such as the Internet), which enables networked devices to communicate with each other as appropriate. The network 11 can support the communication of the applications 32 provisioned on the device infrastructure 42. An alternative embodiment of the mobile device assembly 10, a mobile device 10a is coupled (e.g. mechanically, electrically, mechanically and electrically, etc) to a device case 10b. One example of the network connection interface 40 is a local network (e.g. Bluetooth) used to facilitate the display of the display data 9 on the display screens 12,14, as desired. An example single display screen 12 mobile assembly 10 for implementing the image data 9 display thereon. The device 10 can also have the user interface 44, coupled to the device infrastructure 42, to interact with the user. The user interface 44 can include one or more user input devices such as but not limited to a QWERTY keyboard, a keypad, a stylus, a mouse, a microphone and the user input/output device such as an LCD screen display, bi-stable screen display, and/or a speaker. If the display screen is touch sensitive, then the display can also be used as the user input device as controlled by the device infrastructure 42. Also considered is a capacitive, resistive, or other touch sensitive area (e.g. strip) not associated with the display screen(s) 12,14, provided on a case of the mobile assembly 10, that is configured to interact with the user and can be considered as part of the user interface 44.

Operation of the device 10 is facilitated by the device infrastructure 42. The device infrastructure 42 includes one or more computer processors 45 and can include an associated memory 46. The computer processor 45 facilitates performance of the device 10 configured for the intended task (e.g. of the respective module(s)) through operation of the network interface 40, the user interface 44 and other application programs/hardware 32,48, 36 of the device 10 by executing task related instructions. These task related instructions can be provided by an operating system, and/or software applications located in the memory 46, and/or by operability that is configured into the electronic/digital circuitry of the processor(s) 45 designed to perform the specific task(s). Further, it is recognized that the device infrastructure 42 can include a computer readable storage medium coupled to the processor 45 for providing instructions to the processor 45 and/or to load/update the instructions (e.g. applications 32). The computer readable medium can include hardware and/or software such as, by way of example only, magnetic disks, optically readable medium such as CD/DVD ROMS, and memory cards. In each case, the computer readable medium can take the form of a small disk, diskette, cassette, hard disk drive, solid-state memory card, or RAM provided in the memory module. It should be noted that the above listed example computer readable mediums can be used either alone or in combination.

Further, it is recognized that the computing device 10 can include the executable applications 32,48,36 comprising code or machine readable instructions for implementing predetermined functions/operations including those of an operating system and the modules, for example. The processor 45 as used herein is a configured device and/or set of machine-readable instructions for performing operations as described by example above, including those operations as performed by any or all of the modules. As used herein, the processor 45 can comprise any one or combination of, hardware, firmware, and/or software. The processor 45 acts upon information by manipulating, analyzing, modifying, converting or transmitting information for use by an executable procedure or an information device, and/or by routing the information with respect to an output device. The processor 45 can use or comprise the capabilities of a controller or microprocessor, for example. Accordingly, any of the functionality of the modules can be implemented in hardware, software or a combination of both. Accordingly, the use of a processor 45 as a device and/or as a set of machine-readable instructions is referred to generically as a processor/module for sake of simplicity. The computer processor(s) 45 can be provided in the mobile device 10a and/or the mobile case cover 10b, as desired. For example, the processor 45 can be provided in the mobile device 10a for coordinating/managing the display 12 while the processor 45 can be provided in the cover case 10b to coordinate/manage the display screen 14 alone or in combination with the processor 45 provided in the mobile device 10a.

Preferably, the communications network 11 comprises a wide area network such as the Internet, however the network 11 can also comprise one or more local area networks 11, one or more wide area networks, or a combination thereof. Further, the network 11 need not be a land-based network, but instead can comprise a wireless network and/or a hybrid of a land-based network and a wireless network for enhanced communications flexibility. The communications network 11 is used to facilitate network interaction between the devices 10,10a,10b and other network devices 10. In terms of communications on the network 11, these communications can be between the computer devices (e.g. device 10 and device 10) consisting of addressable network packages following a network communication protocol (e.g. TCPIP), such that the communications can include compliance characteristic data communicated using appropriate predefined encryption as used between the device infrastructure 42 and the secure network device 10 (e.g. server, gateway, etc.).

As illustrated by example, a dual screen bar form factor computer device 10 (e.g. phone) with two displays 12,14 (e.g. a bi-stable display, LCD display, LED display, etc.). An advantage of a dual screen bar form factor phone is that one screen can be always visible, whichever way up the device 10 is placed on a table. By displaying an incoming message (or other application state) of display 12 content (e.g. notification) on one screen, this can provide for the image data 9 can be visible when the second screen 14 of the device 10 is facing away from the user. The first display screen 12 can use electrowetting technology. The second display screen 12 can use electrowetting technology eg. Liquavista. LCD/AMOLED (liquid crystal display/Active-matrix organic light-emitting diode) displays 12,14 can be used for desired always-on mode and higher power consumption over use of bi-stable screens 12,14.

For example, only one of the screens 12,14 would be a bi-stable screen. The device 10 can be a bar form factor display device as a slate device, as a bar or candybar device, as a slab-shaped form. Alternatively, the computer device 10 can be a hinged clam shell design. It is also recognised that the display screen 12 can be a touch enabled screen interface. It is also recognised that the display screen 14 can be a touch enabled screen interface.

It is recognised that the applications 32 can be, for example, corporate email applications, corporate address books, work calendars, and other enterprise applications, games, downloaded custom apps, and music apps. Alternatively, the applications 32 can be corporate/Work Calendar; Corporate/Work Mail; Corporate/Work Directory and Address Book; Company News (e.g. RSS, XML, etc); Instant Messaging (e.g. What's app, Skype, etc); Job dispatcher, Tasks and to-do-list; Recorder for meeting; Notes; Storage, reports and documents (e.g. xls, ppt, doc, etc); Stock prices; Secured network connectivity/connection manager. Examples of applications 32 can include applications such as but not limited to: Social Networking (e.g. Facebook, Blog, Twitter, Line, Sina, etc); Multimedia recording, playback and sharing (e.g. video, audio, photo, music, etc); Games and apps; Personal Alarm and tasks; Instant Messaging (e.g. Yahoo!, Google, What's app, MSN, Skype, etc); Point of Interests, Navigation and Geo-fence (e.g. Map tools); My wallet (e.g. banking, statement, NFC payment, auction & bidding/taoboa, etc); Storage and backup on 3Cloud; Utilities/Tools (e.g. stock, apps, widgets, calculator, weather, etc); Tariff and unbilled usage counter/widget (personal) for a network 11 data/usage plan.

The computer device 10 can be configured such that one of the display screens 12,14 (e.g. bi-stable display screen) is operatively coupled via a data connection (not shown—as a wired or wireless connection) coupled for power and/or data to the computer device 10a by a detachable cover 10b. As such, the display 14 is part of the cover 10b, as illustrated by example, for example positioned on a front face of the cover 10b or positioned on a back face of the cover 10b. It is recognised that the operating system of the mobile assembly 10 is able to recognize and communicate to the bi-stable display screen 12,14 via the connection, for example or the purpose of sending the contextual display data 9 for display on the other display screen 12,14, as reflective of the application 32 state.

The client device 10 is further illustrated as including an operating system. The operating system is configured to abstract underlying functionality of the client to applications 32 that are executable on the client device 10. For example, the operating system can abstract processing, memory, network, and/or display functionality of the client device 10 such that the applications 32 can be written without knowing “how” this underlying functionality is implemented. The application 32, for instance, can provide display data 9 containing content (e.g. text, image data) to the operating system (e.g. via module 36) to be processed, rendered and displayed by a display device 12,14 without understanding how this rendering will be performed.

The operating system of the device infrastructure 42, as implemented via the executable instructions 48 and associated processor(s) 45, can also represent a variety of other functionality, such as to manage a file system and a user interface that is navigable by a user of the client device 10. An example of this is an application launcher (e.g., desktop) that is displayed on the display device 12,14 of the client device 10. The desktop can include representations of a plurality of the applications 32, such as icon, tiles, textual descriptions. The desktop can be considered a root level of a hierarchical file structure. Further, operating system can have one or more processors 45 used to execute instructions 48 to perform operations and functionality/processing (e.g. rendering display of display content 9 to the display 12,14, accessing memory 46) of the operating system as well as to perform operations and functionality/processing of the applications 32 (e.g. analyzing and performing formatting of the display data 9 for subsequent generation and display to the display screen 12,14 as a reflection of the state or orientation of the application 32, device 10, electronic component such as a display screen 12,14 pertaining to one or more workflow events 34.

Specific embodiments of the mobile assembly 10 can be provide as a mobile device 10a coupled to a mobile device cover 10b, the mobile device 10a having a device case with a first device face having the second display screen 14 and the mobile device cover 10b having a cover case with a first cover face having the first display screen 12, the device case mechanically coupled to the cover case. In terms of the one or more processors 45, this can include a first computer processor 45 as an electronic component housed in the device case of the mobile device 10a and a second computer processor 45 as an electronic component housed in the cover case of the mobile device cover 10b, the second computer processor 45 coupled to a display driver (of the device infrastructure of the first display screen 12 for rendering the first display data and the first computer processor 45 coupled to a display driver of the second display screen 14 for rendering the second display data. Alternatively, the mobile assembly 10 is a mobile device 10 having a device case with a first device face having the first display screen 12 and a second device face having the second display screen 14, such that the one or more processors 45 are electronic components housed in the device case of the mobile device 10 and the one or more computer processors 45 are coupled to a display driver of the first display screen 12 for rendering the first display data and to the same or different display driver of the second display screen 14 for rendering the second display data.

It is recognised that the operating system and associated application(s) 32 and display module 36 can be optionally configured to operatively (as implemented by the processor 45) generate the contextual display data 9 for display on the display 12,14 (e.g. bi-stable, LCD, LED, etc.) by the module 36 in substitution of the application 32 hosted on the computer device 10, the application 32 responsible when in an identified 18 state (e.g. running and therefore recognised as an active process by the operating system) for representing or otherwise providing the display data 9 for subsequent display on the display 12,14. For example, the application 32 can be in an inactive state (e.g. not running and therefore recognised as an inactive process by the operating system) and the display data 9 can be displayed on the display 12,14 to reflect that the application 32 (or a set of applications 32) are in a powered down or off state. For example, all network connections (or a subset of network connections) could be in a off state and the display data 9 could contain content to reflect this state. For example, in a powered down mode, the first display screen 12 could be in a off state, i.e. dark (see FIG. 75,79 by example), while the second display screen 14 could display display data 9 reflective of one or more application 32 states being executed (or not executed) on the device infrastructure while the first display 12 is in the off state/mode.

For example, if when the first display screen 12 is in a off state, i.e. dark, the network connection 40 could fail and thus the manager 36 could send the display data 9 to the second display screen 14 indicting that there is a problem with the network connection state identified 18. Alternatively, if when the first display screen 12 is in a off state, i.e. dark, the network connection 40 could be operative and thus the manager 36 could send the display data 9 to the second display screen 14 indicting that there is active connectivity with the network connection 40 state identified 18 by the manager 36. Another example is where the first display screen 12 is in a off state, i.e. dark, display content for an application 32 (in an active or inactive state) could be received by the network connection 40 and thus the manager 36 could send the display data 9 to the second display screen 14 indicting that the display content identified 18 has been received by the network connection 40 (e.g. incoming call, received notification, received message, etc.).

It is also recognised that the module 36 can be configured to select and send the display data 9 to another display screen 14 of the computing device 10 rather than to the display 12. For example, the display 12 can be an LCD or LED based display and the another display 14 can be a bi-stable screen (e.g. electronic paper display (EPD), e-ink, etc.). Alternatively, the display 12 can be a bi-stable screen and the another display 14 can be an LCD or LED based display.

As such, in view of the above, described is display data 9 for display as part of messaging or other identified state of the application 32 and/or device 10 and/or of individual on-board components of the device 10 (e.g. operation or inoperation of network interface 40, user interface 44, and/or display screen(s) 12,14, etc.). A display content is received that is to be displayed. For example, the display content can be received at the module 36 of the client device 10 from an application 32 executed on the client device 10, from a web server, and so on. In another example, the module 36 of the web server can receive the display content from the device 10 and manage processing and distribution of the display content. A variety of other examples are also contemplated.

### Differences in Operational Characteristic(s) of Display Screens 12,14

Preferably, operational characteristics of the display screens 12,14 of the mobile assembly 10 are different, such that an operation characteristic level of one of the display screens 12,14 can be less than an operational characteristic level of the other of the display screens 12,14. For example, an operational characteristic is operational power consumption used by the display screens 12,14 to display the display content 9 associated with application workflow 30 (e.g. one display screen 12,14 uses less power consumption to display the display content 9 than the power consumption of the other display screen 12,14 or one display screen 12,14 uses higher power consumption to display the display content 9 than the power consumption of the other display screen 12,14).

Preferably, operational characteristics of the display screens 12,14 are different, such that an operation characteristic level of one of the display screens 12,14 can be greater than an operational characteristic level of the other of the display screens 12,14. For example, an operational characteristic is screen refresh rate used by the display screens 12,14 to display the display content 9 associated with application workflow 30 (e.g. one display screen 12,14 lower screen refresh rate to display the display content 9 than the comparable higher screen refresh rate of the other display screen 12,14).

Preferably, operational characteristics of the display screens 12,14 are different, such that an operation characteristic level of one of the display screen 12,14 can be present/provided, as compared to a lack of the operational characteristic of the other display screen 12,14. For example, an operational characteristic is touch screen used by the display screen 12,14 to display the display content 9 associated with application workflow 30 (e.g. one display screen 12,14 has a touch screen to facilitate manipulation of the display content 9 while the other display screen 12,14 does not have touch screen capability).

For example, another operational characteristic is computer graphics resolution level (e.g. higher or lower as appropriate to the specific workflow event 34—higher for the first workflow event 34 and lower for the second workflow event 34 or lower for the first workflow event 34 and higher for the second workflow event 34) provided by the display screens 12,14 to display the display content 9 associated with application workflow 30 (e.g. one display screen 12,14 provides lower computer graphics resolution to display the display content 9 than the computer graphics resolution of the other display screen 12,14).

For example, another operational characteristic is computer graphics colour/shading level (e.g. higher or lower as appropriate to the specific workflow event 34—higher for the first workflow event 34 and lower for the second workflow event 34 or lower for the first workflow event 34 and higher for the second workflow event 34) provided by the display screens 12,14 to display the display content 9 associated with application workflow 30 (e.g. one display screen 12,14 provides lower computer graphics colour/shading level to display the display content 9 than the computer graphics colour/shading level of the other display screen 12,14).

For example, another operational characteristic is display screen refresh rates (e.g. higher or lower as appropriate to the specific workflow event 34—higher for the first workflow event 34 and lower for the second workflow event 34 or lower for the first workflow event 34 and higher for the second workflow event 34) provided by the display screens 12,14 to display the display content 9 associated with application workflow 30 (e.g. one display screen 12,14 uses a lower display screen refresh rate to display the display content 9 than the display screen refresh rate of the other display screen 12,14).

For example, another operational characteristic is display screen geometrical configuration (e.g. higher or lower as appropriate to the specific workflow event 34—higher for the first workflow event 34 and lower for the second workflow event 34 or lower for the first workflow event 34 and higher for the second workflow event 34) of the display screens 12,14 to display the display content 9 associated with application workflow 30 (e.g. one display screen 12,14 provides a greater degree of geometrical curved surface to display the display content 9 as compared to a lesser degree of geometrical curvature—e.g. planar surface—of the other display screen 12,14).

For example, another operational characteristic is display screen cut out regions (e.g. present or not present as appropriate to the specific workflow event 34—present for the first workflow event 34 and not present for the second workflow event 34 or not present for the first workflow event 34 and present for the second workflow event 34) provided by the display screens 12,14 to display the display content 9 associated with application workflow 30 (e.g. one display screen 12,14 can accommodate a cut out region in the display screen surface while displaying the display content 9 while other display screen 12,14 cannot accommodate cut out regions in the display screen surface).

For example, another operational characteristic is touch screen input (e.g. higher or lower as appropriate to the specific workflow event 34—higher for the first workflow event 34 and lower for the second workflow event 34 or lower for the first workflow event 34 and higher for the second workflow event 34) or (e.g. present or not present as appropriate to the specific workflow event 34—present for the first workflow event 34 and not present for the second workflow event 34 or not present for the first workflow event 34 and present for the second workflow event 34) provided by the display screens 12,14 to display the display content 9 associated with application workflow 30 (e.g. one display screen 12,14 can accommodate touch screen gesture input by the display screen surface while displaying the display content 9 while the other display screen 12,14 cannot accommodate appropriate touch screen input capabilities).

It is recognised that some or all of the above operational characteristics can be provided by display screens 12,14 of different unit costs and/or durability of the display screen material, as representative of their expressed operational characteristic differences. For example, a monochrome display screen can be lower in cost than a full colour display screen. For example, a display screen with a higher refresh rate and/or screen resolution level can be higher in cost that a display screen with a comparative lower refresh rate and/or screen resolution level. For example, a touch screen enabled display screen can be of higher cost as compared to a non-touch screen enables display screen. As such, each of the display screens provides an operational characteristic (and/or level thereof) that is preferred by the executable instructions 48 over the operational characteristic (and/or level thereof) of the other display screen.

It is also recognised that some display screens 12,14 have operational characteristic(s) that are optimized for specific workflow events 34 of the application workflow 30. In terms of an e-reader application 32, for example, navigation of the application 32 (e.g. ordering e-books, selecting books/pages from the user's cloud storage and/or local storage, etc.) is best (or preferred by the user) performed using an LCD touch screen display while reading interaction with specifically selected content (e.g. display content 9—such as a page or portion of an e-book) of the application 32 is best (or preferred by the user) performed using a bi-stable screen display (e.g. an EPD display).

Further, it is recognised that the display content 9 (e.g. notifications (e.g. text messages) can be received by the processor(s) 45 to display information 16 (e.g. SMS notification, email, phone call, etc.) as the first workflow event 34 without having the user (or the operating system) specifically launch the application 32, or can be obtained from the application 32 with the user having launched the application 32. For example, a weather application 32 can send for display on the first display 12 a notification (e.g. display content 9) that describes current weather conditions. Another example of a notification (e.g. display content 9) sent for display on the first display 12 can be a text message (e.g. one friend sending an electronic message of hello to another friend) sent from another computer device connected via a communication network 11 to the computer device 10 displaying the notification on the first display 12 without interaction (e.g. application 32 is an inactive process on the active process stack implemented by the processor(s) 45 as either an unlaunched application 32 and/or a dormant application 32).

There is provided a bar form factor display device comprising front and back major faces, the front major face arranged to present a first display and the back major face arranged to present a second display different to the first display. The device can further comprise a computer system operable to run a plurality of application programs. The computer system can be configured to limit the arrangements in which content is displayable on the second display by the application programs.

A bar form factor display device comprising front and back major faces, the front major face arranged to present a first display screen and the back major face arranged to present a second display screen different to the first display screen. In one example, the back face screen is a bi-stable screen.

A method of providing notification messages on a bar form factor display device operating at low power, the bar form factor display device comprising front and back major faces, the front major face arranged to present a first display screen and the back major face arranged to present a second display screen different to the first display screen, wherein the second display screen is a bi-stable display screen, comprising the steps of:

i) Executing software on the device, the software operating the device in a low power notification mode in which the first display screen is off and in which the device is operable to receive a notification message;
ii) The software on the device receiving a notification message;
iii) Displaying the notification message on the bi-stable display screen.

### Further Embodiments

In the following description, these are example embodiments of the device 10 described above, including: the configured device 10 for event driven/coordinated presentation of display data 9 on the display screens 12,14; presentation on the display screens for notifications and their notification types and order/placement of presentation with respect to one or more of the display screens 12,14; use of a touch surface (e.g. touchscreen) of the device 10 to control operations on a display surface of a display screen 12,14 that does not have the touch surface (e.g. the display screen 12,14 is on one face of the device 10 and the touch surface is on a different face of the device 10 that has the display 12,14); execution of a software application 32 (e.g. provisioned on the device 10 computer framework) involving draw requests for authenticated applications 32 for submitting display data 9 to one or both of the display screens 12,14, as selected; and/or coordination of display of display data 9 based on state of the application 32 and/or computer component(s) (e.g. display screen in powered off mode) submitted for display on one or more of the display screens 12,14.

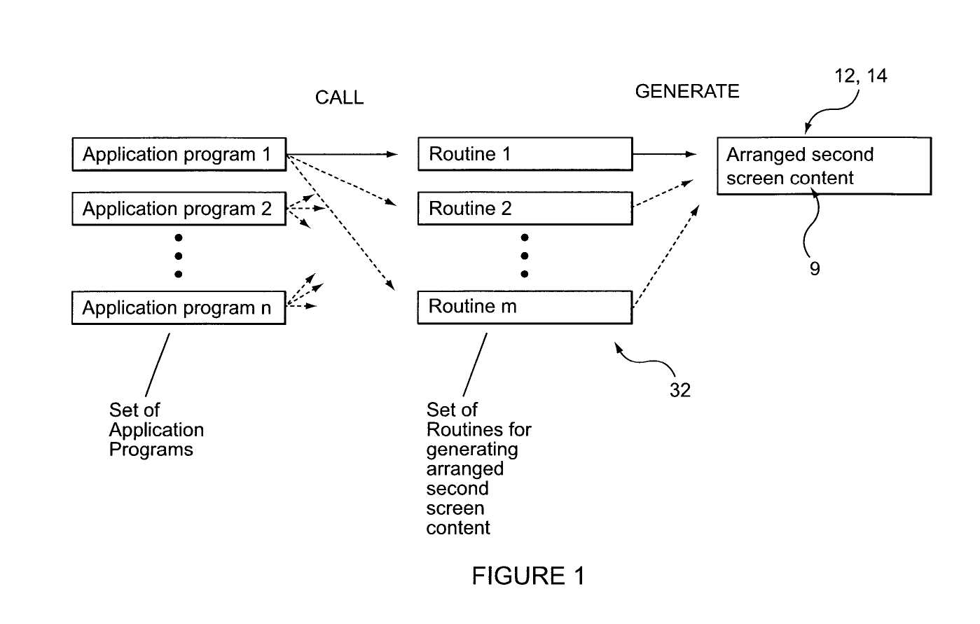

FIG. 1 shows an example of an implementation. In this example, a set of n application programs 32 on a device 10 are not able to generate screen content 9 on the second screen 12,14. The application programs can be unable to generate screen content on the second screen, for example, because second screen output is controlled by a particular processor 45 (eg. a secure processor) which uses an input key in order to provide second screen output. The key can be unknown to the set of n application programs, but it can be known to the set of m routines 32, hence when one of the m routines is called, it can generate second screen output. So an application program in the set of n application programs can call one of a set of m routines, where each of the set of m routines is for generating content that is arranged in a predetermined way on the second screen. When a particular routine is called it generates content arranged on the second screen. A routine can be called with parameters which are used to provide arranged second screen content. For example, a Date & Time routine can be called with a specific date and time, to provide the date and time in a predetermined arrangement. The date and time can vary, depending on the selected time zone, for example. Based on FIG. 1 and its associated description, other examples will be obvious to those skilled in the art.

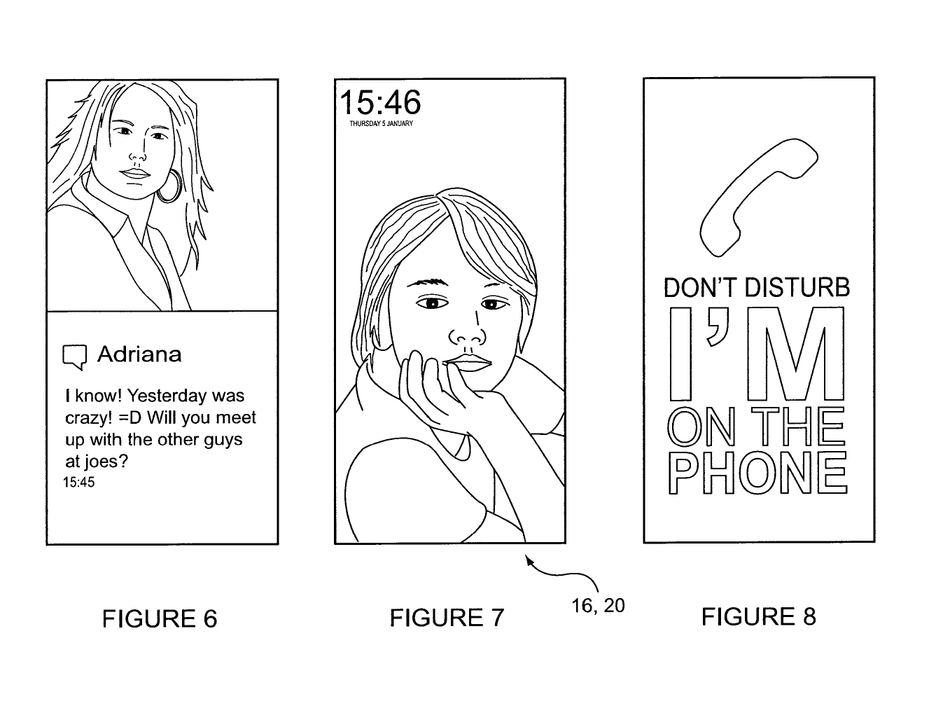

FIG. 6 shows an example of second screen output 16,20 in which the second screen content arrangement has been limited. In this example, an incoming message is displayed in an arrangement in which the photo of the message sender is shown (if available) at the top of the screen, followed by the name of the message sender, followed by the message in a predetermined font and size, followed by the time the message was sent. This is an example of a Notification that is full screen, discrete and modal.

FIG. 7 shows an example of second screen output 16,20 in which the second screen content arrangement has been limited. In this example, a wallpaper image is provided, which is arranged to fill the screen, with date and time information provided in the top left in a predetermined arrangement, presented using predetermined fonts and sizes.

FIG. 8 shows an example of second screen output 16,20 in which the second screen content arrangement has been limited. In this example, an application broadcast message is provided on the second screen. The application broadcast states that the user is on the phone.

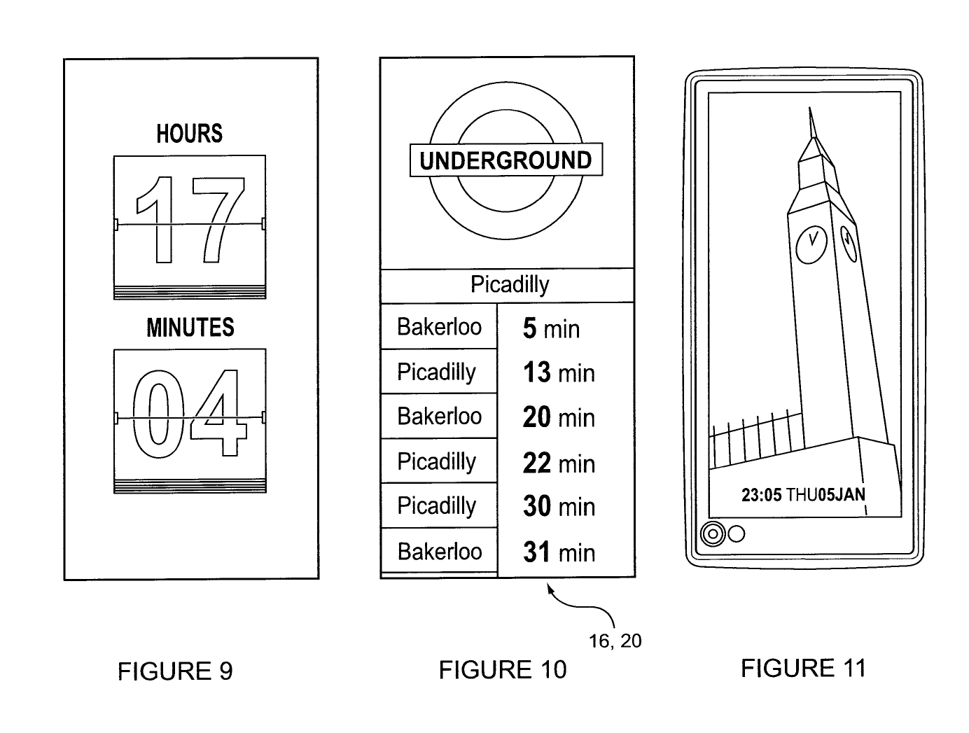

FIG. 9 shows an example of second screen output 16,20 in which the second screen content arrangement has been limited. In this example, the time is presented in a predetermined arrangement, presented using predetermined fonts and sizes. The output is that of a clock widget.

FIG. 10 shows an example of second screen output 16,20 in which the second screen content arrangement has been limited. In this example, public transport information is presented in a predetermined arrangement, presented using predetermined fonts and sizes. The output is that of a wallpaper application.

FIG. 11 shows an example of second screen output 16,20 in which the second screen content arrangement has been limited. In this example, weather for a particular location is presented in a predetermined arrangement; time and date information is presented using predetermined fonts and sizes, in a predetermined arrangement. The output is that driven by a wallpaper application. Here the location is London, the weather is snow, the time of day is night and the season is winter.

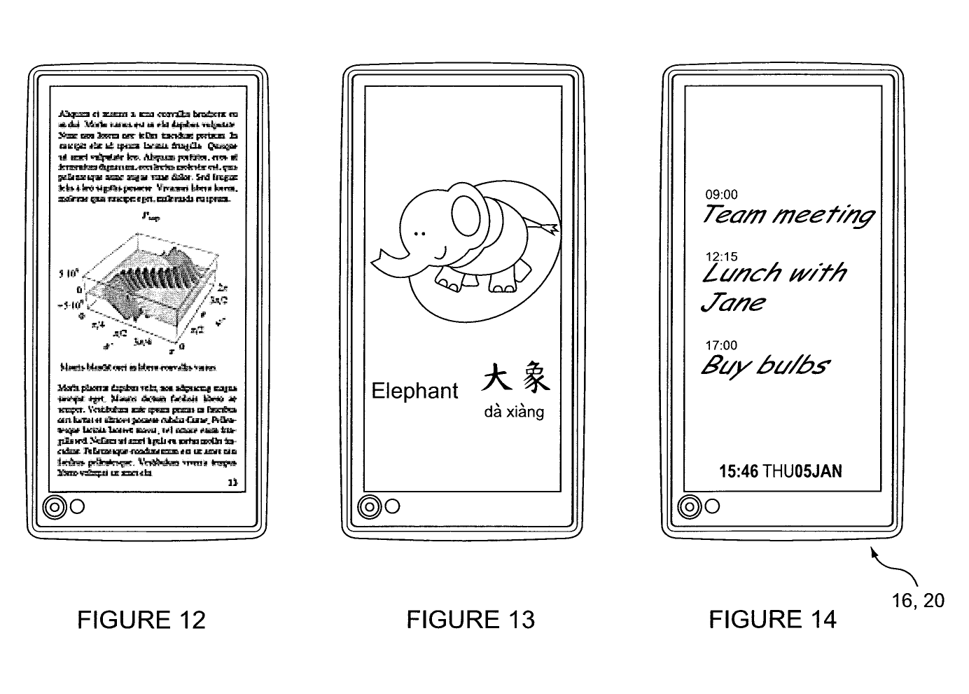

FIG. 12 shows an example of second screen output 16,20 in which the second screen content arrangement has been limited. In this example, the second screen displays a page from an electronic book and no other screen output is present to obscure or to complement the display of the page from an electronic book.

FIG. 13 shows an example of second screen output 16,20 in which the second screen content arrangement has been limited. In this example, the second screen displays a word in English and the corresponding symbol and reading in Mandarin Chinese, together with an image. The application is for learning Mandarin Chinese.

FIG. 14 shows an example of second screen output 16,20 in which the second screen content arrangement has been limited. In this example, diary information has been arranged to resemble the contents of a hand-written diary, using predetermined fonts and sizes, in a predetermined arrangement.

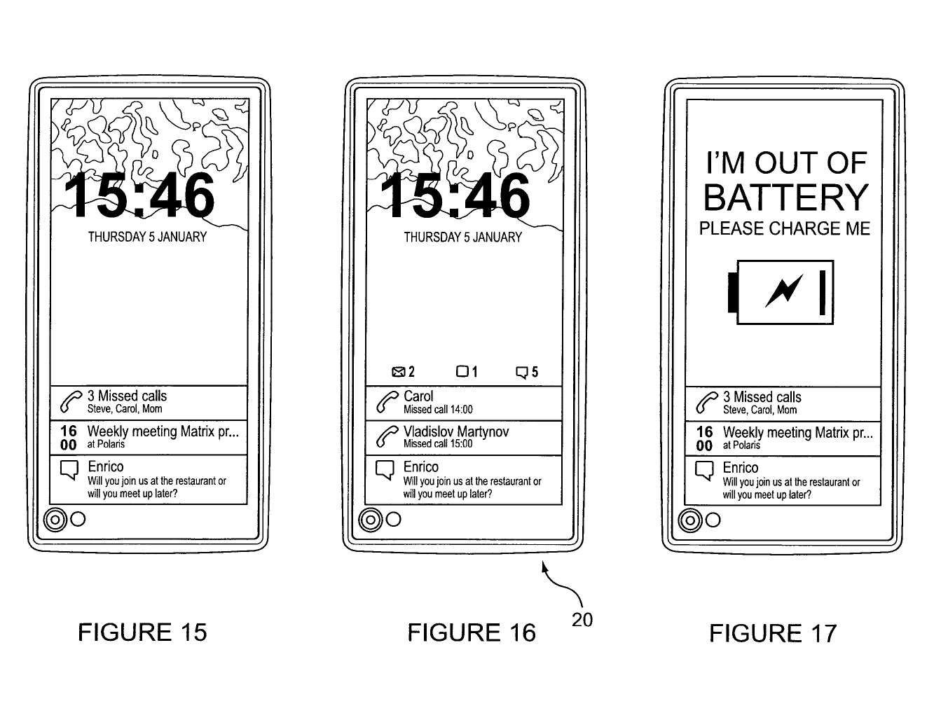

FIG. 15 shows an example of second screen output 16,20 in which the second screen content arrangement has been limited. In this example, the second screen content is arranged to provide a preselected image at the top of the screen, with the date and time overlayed in a predetermined arrangement, presented using predetermined fonts and sizes. Below there is arranged information about missed calls, the next meeting call, and the latest text message.

FIG. 16 shows an example of second screen output 16,20 in which the second screen content arrangement has been limited. In this example, the second screen content is arranged to provide a preselected image at the top of the screen, with the date and time overlayed in a predetermined arrangement, presented using predetermined fonts and sizes. Below there is arranged information using a predetermined priority order showing a missed call from the wife, a missed call from the boss, and a text message from a friend.

FIG. 17 shows an example of second screen output 16,20 in which the second screen content arrangement has been limited. In this example, the second screen content is arranged to provide a “nearly out of power”-type image message at the top of the screen. Below there is arranged information about missed calls, the next meeting call, and the latest text message. In a further example, a ‘battery discharged’ notification appears before device goes to off state. An “out of power” screen such as that shown in FIG. 17 can be displayed on the second screen even when the battery is fully discharged.

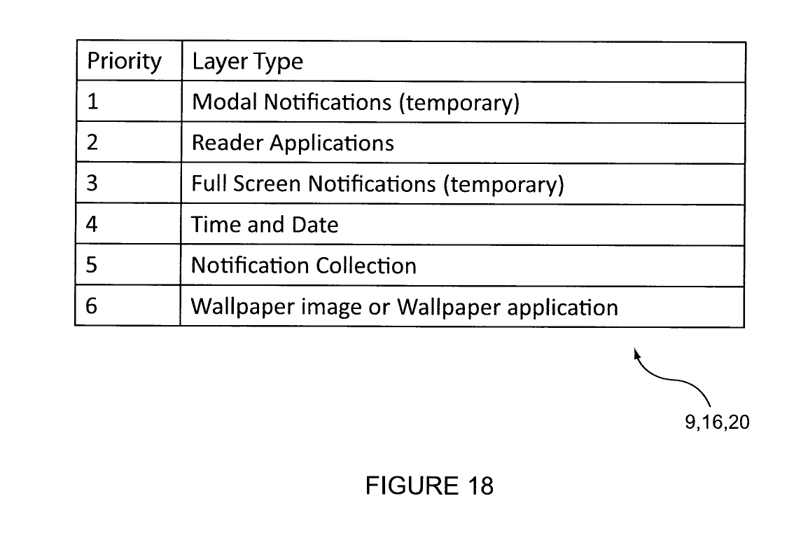

FIG. 18 shows an example of a hierarchy of priorities for use in deciding which information layer to present on the second screen. Different screen types are different information layers—each screen type or layer stays on the screen until replaced by a screen of higher priority. In this example, 1 is the top priority and the priority level decreases to 6 which is the lowest priority. The priority can be related to notification type and priority of notification level processing and display, as described herein.

In further examples, there are provided device battery/turn off notifications (e.g. display data 9 and/or as processed display data 9 for display as display content 16,20) as messages processed for display data 9 on the display screen 12,14. Before the battery is fully discharged, there is provided a specific notification which can be shown on the second screen eg. a EPD screen. For example: if battery charge falls to 5% charged, the device shows “Out of battery, Charge me” on the second screen eg. a EPD screen. Or for example: if battery charge falls to 10% charged, device shows last calls, last sms, next events on the EPD before going to turn off state. In a further example, see the change from FIG. 15 to FIG. 17 in response to a battery level falling below a defined threshold: the text at the bottom is the same, but the image has changed. In a further example, when the charge level of battery falls to a defined level, what information to show can be configurable by a user.

In further examples, there are provided visible marks notifications. In an example, an icon/small image appears on the second screen eg. a EPD screen, depending on some event, wherein the event is or is not configurable by a user. In an example, an Icon/Image changes its size (eg. size becomes bigger) depending on how a related value is changing. The notification represents the value. In an example:

i. User has <500 USD on his billing account, small image with US dollar appears.
ii. User has <100 USD on his billing account, image becomes bigger
iii. User has <10 USD, user sees big notification/big image on his second screen.

Notifications are provided which can react to a user's touch on the back touch panel. If a notification is activated in response to a back swipe, this means the notification is some pre-defined (or user-configurable) action i.e. what phone is doing in response to the gesture. In another example, in response to an incoming SMS notification, if a user swipes from right to the left, there could be an action, when on the front screen, wherein the User is taken directly to an SMS reply window. Each notification described in this document, can react or not react in response to a user input gesture—this depends on final settings/configuration. As such, the format of the notification 9,16,20 can be changed as desired, based on display screen 12,14 constraints (e.g. operational characteristics) and/or application 32 execution constraints and/or device component (e.g. user interface 44, screens 12,14, etc.) operational constraints or state(s).

What's special about the Screen: controlled output on the back screen 12,14.

It's the complete opposite to the main screen 12,14 (the front screen)—which is increasingly an indiscriminate pipe to a confusing and disorganised mass of information and experience.

The screen is the antidote; it is a distillation of what is to you.

It's about emotional impact, not sterile data. It will speak wherever high emotional impact messaging is true and surprising. It will say less, but be heard more—the paradox of information. It will do less, but move you more. It will be simple and bold.

How can we extend our understanding of how we can use the screen?

The screen can be non-interactive—the messages are declaratory. Screen is your inner voice, as though a part of you is talking to you—an intimate engagement. Where else do you hear this inner voice? If we can understand that, we can map out the contours of where the screen can be most sympathetically deployed. Reflects and guides only your most thoughts and actions. It channels the commitments you've made to yourself—to be fitter or healthier etc. For example, the screen can remind the user of their progress in giving up smoking. See e.g. FIG. 70.

Messages belong to a small set of possible applications (e.g. just a grid of 9 different applications). The choice is left deliberately constrained to impose simplicity.

No more than a maximum (e.g. ten) words on the screen at any one time.

Complete opposite of the current trend, which is to embed more and more information into the display. We take that away and permit just a single message 9,16,20 at any one time. And each screen message fills the entire display (see e.g. FIG. 6)—unlike conventional notifications which e.g. are squeezed into the top in iOS, the operating system of an iphone™

Phone 10 can declare facts about itself with a human twist—if it is dropped or banged an ‘Ouch’ message. If it is too hot, then an “I'm too hot” message. If it is lost, can declare ‘I'm lost!’

Context dependent wallpaper 9,16,20 (see e.g. FIG. 11). Social network feeds integrated into wallpaper. Notifications 9,16,20 can be always on.

The second screen could be a touch screen display or use a simple capacitive touch sensitive controller at the bottom and/or top of the screen.

### Religion

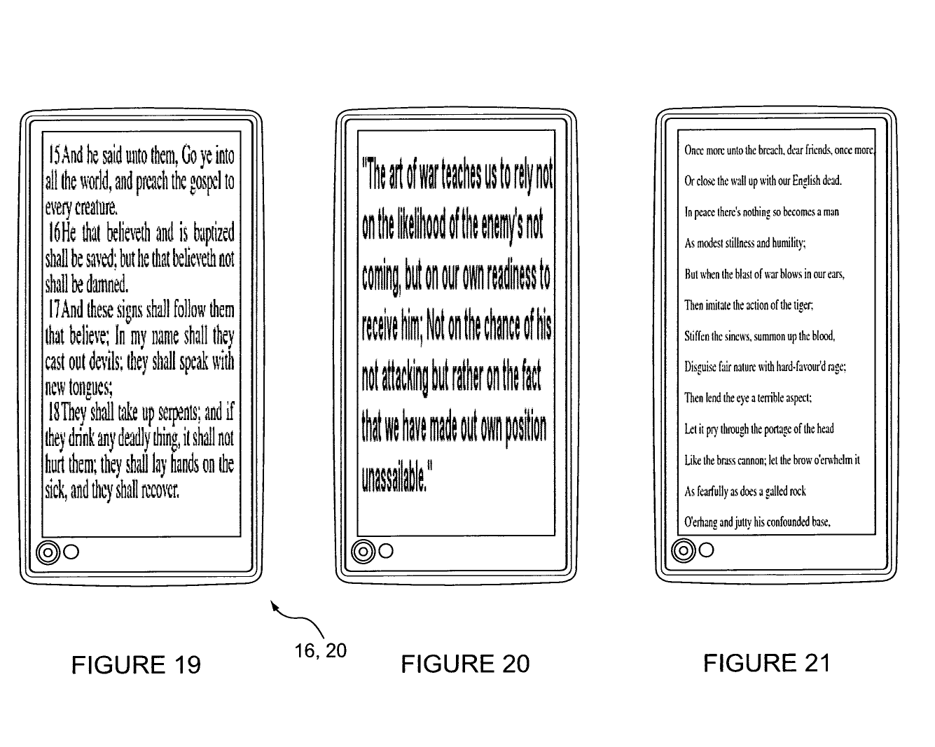

The first sacred phone, Eg. Islamic phone, with the Koran 9,16,20 on the second screen. Or Christian phone with Bible text 9,16,20 on the second screen. See eg. FIG. 19.

### Personal Motivation

The Anthony Robbins phone, with motivational messages 9,16,20 and targeted programs. Or Sun Tzu phone, see eg. FIG. 20. Or Shakespeare phone, see eg. FIG. 21.

### Financial Phone

Constant updates to the financial data 9,16,20 that is really to you eg. The first Bloomberg phone.

### Learning

Language learning flash cards on the second screen (see eg. FIG. 13). Other key facts or questions, but presented as single full screen image 9,16,20. The first Rosetta Stone phone.

### Health

Messages 9,16,20 critical to your health—perhaps medication reminders 9,16,20, or something more basic such as a reminder to drink some water (eg. FIG. 74), encouragement to take your medication (see eg. FIG. 71), other messages to counter the huge problem of non-compliance. The first Health Phone.

### Advertising

A new paradigm for advertising messages 9,16,20—just as the format of the 20+ second TV advert revolutionized TV experience, could provide graphical strong, high emotional impact advertising (e.g. could powerful slogans like Nike's ‘Just Do It’ work sympathetically with the second screen?) The second screen could change the face of advertising.

Capitalising on people's love of brand logos, the second screen could just carry a pure unadorned brand logo 9,16,20. Brand owners could reward customers who enable their second screens to carry their logos as the default screen. Or it could be reserved only for special customers—something to aspire to and a reward in itself.

Short trailers 9,16,20 for upcoming film or TV releases could also be pushed to the second screen.

Second screen content 9,16,20 could be location dependent—eg. “you bought those lovely Tods shoes when you last walked down this street”.

Messages 9,16,20 from Loved Ones

Converts SMS text messages from loved ones to large font, stylized images—software on the phone converts the TXT.

### Memories

Second screen could display text or images 9,16,20 that trigger memories or remind one of past moments—this might be location dependent—perhaps when you visit somewhere you've not been for a while, it reminds you of an image you took when last here (could be cloud stored; an excellent use for Google's all encompassing data about one).

### Comics

Second screen as comic display screen.

### Fun

Context sensitive graphics 9,16,20—if using the front facing camera to take photos, then rear screen displays a stylized back 9,16,20 of a photo camera; if using the front facing camera to take movies, then rear screen displays a stylized back of a movie camera, an example of event driven display 9,16,20.

It is recognised that the following is described by example only calling the display screen 14 as a “back” screen. However, it is also contemplated interchangeably that the bi-stable screen (e.g. EPD) can also be positioned on the front as a front screen of the device 10. In that manner, the terminology front and back can be used interchangeably, depending upon the screen setup of the mobile assembly 10 (e.g. one screen, dual screen, etc. enabled device). It is also recognised that is the device 10 dies not have an identifiable typical back/front configuration, then the terminology of back/front can be used to denote the particular screen 12,14 and its orientation on the respective face of the case 99 of the device 10, considering that front and back is only relative to user perception.

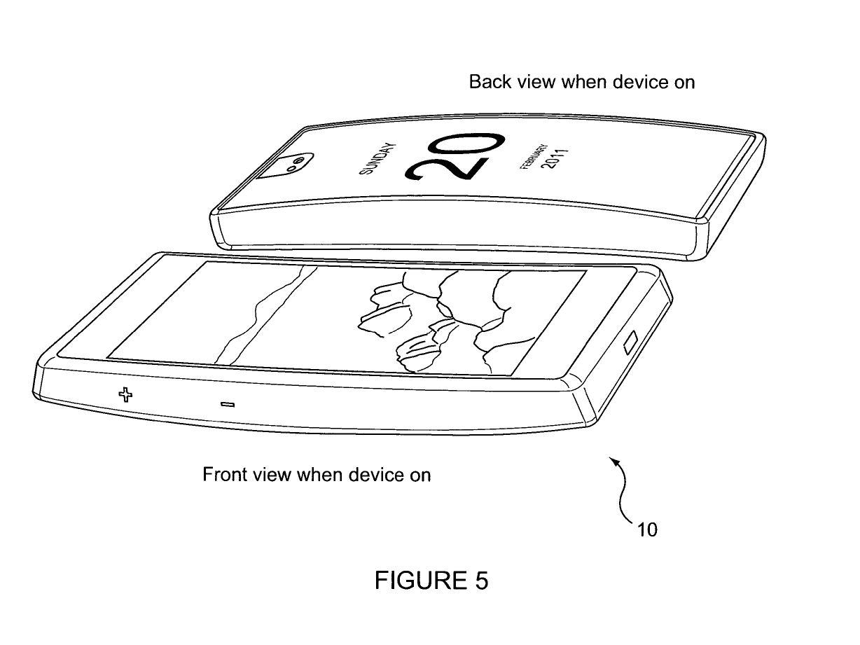

The Yota device 10 is a unique product and the first of its kind to hold a secondary e-ink display 12,14 on the back (or front) of the device 10 case 99. See eg. FIGS. 2 to 5. This brings new possibilities in creating a more superior user experience, it brings beauty, it brings the possibility to stand out and be aware about what is going on without having to do anything. Here we describe a direction and concept of the device, both in terms of content 9,16,20 and main usage.

When starting the phone 10 for the first time the user can be greeted by an introduction movie/slide show 9,16,20 that goes through the basics of using the phone. The areas to be described and explained are:
Gestures for the main screen
What the back-screen 12,14 is and how it works
Gestures for the back-screen

Once the new user experience has been gone through the user can be guided through the standard Setup sequence.

For example, the back-screen is always “on” since it's an e-ink display 12 that doesn't drain any or little) power even though it's showing content 9,16,20. The user can be able to pick up the phone and quickly and easily interact with the back-screen without cumbersome locks or activation gestures. The back-screen can over all be simple, intuitive and beautiful and be seen as an add-on to the phone rather than a 2nd screen with full functionality. It can make information easily available to the user and never feel complicated or overloaded with features.

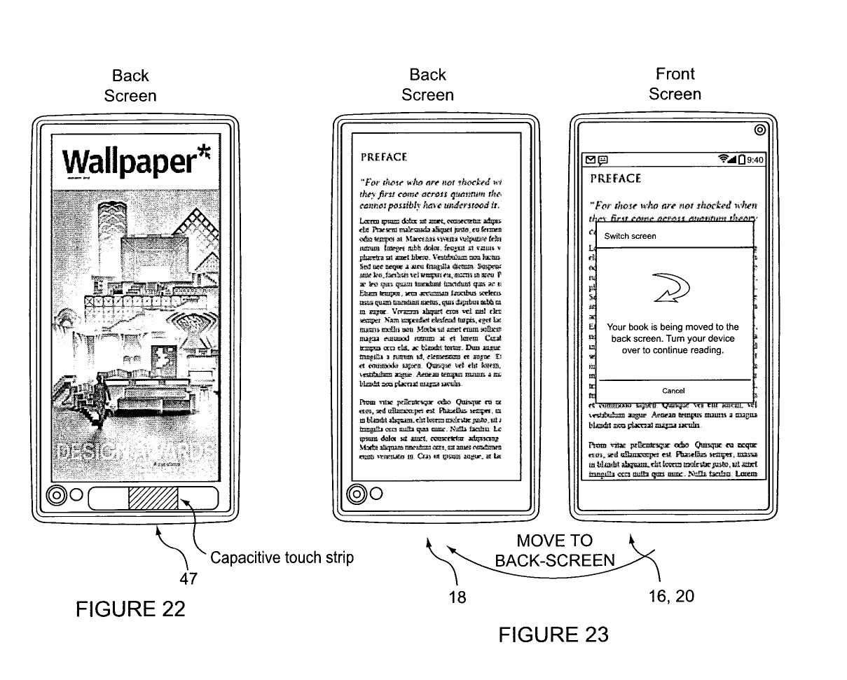

The current hardware has a touch capacitive touch strip 47 located under the screen 12,14 (i.e. non-overlapping in surface area). E.g. a simple lock slider button on the device would make sure that the back-screen is never used unintentionally. See eg. FIG. 22.

The design of the back screen is now based on the idea that accidental presses might happen, but that they can not be frequent.

The touch strip 47 can be only active when the phone is locked, making it inhibited to trigger it involuntarily when interacting with the main screen. The swipe gestures and long press are ways to make sure that the touch strip only is activated when it's meant to be; the full gesture needs to be completed to trigger any actions.

The back-screen is divided into two separate main states: In Application 32 and the Application 32 switch menu. There are different ways to interact with the back-screen via the touch strip; swipe left, swipe right, tap and long tap. The actions connected to the gestures of the touch strip 47 depend on which state and application 32 that is in focus of the user (i.e. field of view. The general rules of navigation are:

### In Application Switch Menu

Swipe right—Switch to the previous application
Swipe left—Switch to the next application
Tap—Select application
Long press at the center—close the Application switch menu

### In Application

Swipe right—Next action
Swipe left—Previous action
Tap—Application specific action
Long press at the center—bring up the Application switch menu

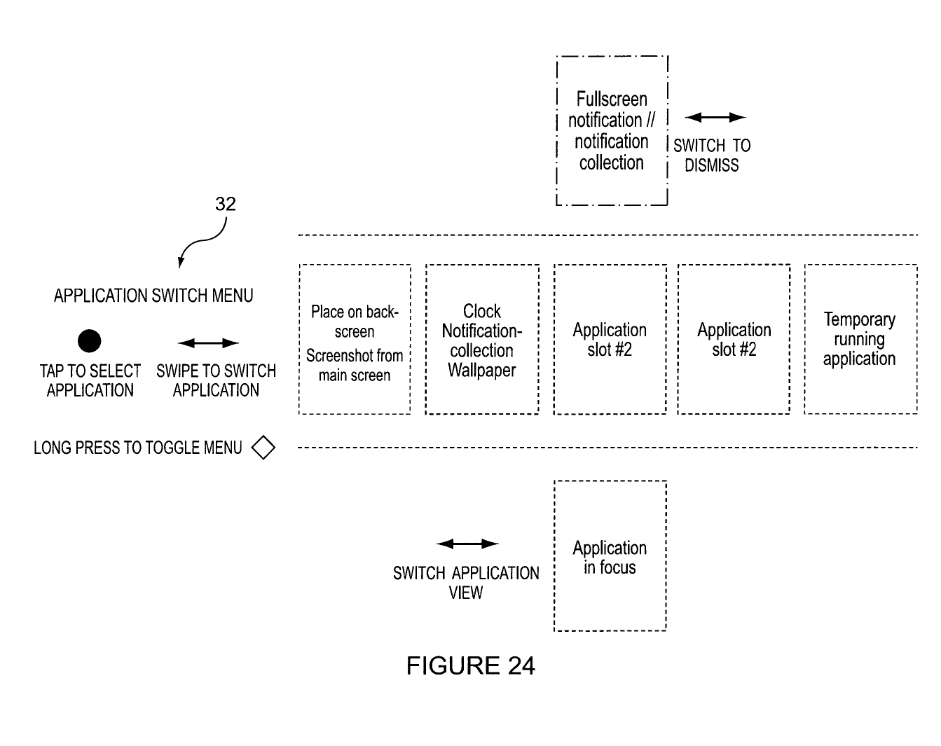

See eg. FIG. 24.

There can be a number of applications 32 that can be available in the device 10 at launch.

There are three types of applications available in the device: Dedicated Back screen 14 applications 32, dual screen 12,14 applications 32 and regular Android applications 32 for front screen 12.

Back-screen applications can always be full screen and can have one or several views. Discrete navigation tips that time-out can be added to the applications that allow navigation within the application.

Dual screen applications are applications that fulfill a user need and the user can choose to use the application 32 on the back screen, front screen or both.

### Wallpaper & Clock—Back Screen Application

Wallpapers 9,16,20 on the back-screen can be Static or Live, live in the sense that they can change depending on external data, e.g. time and location or a simple slideshow.

Live wallpapers 9,16,20 can not be designed so that they use frequent updates; this eliminates “animated wallpapers”. The reason for this is that it drains power to frequently update the screen 12,14 and that the e-ink display can not be able to update quickly enough to make animations look good. The user can choose from a number of uniquely designed clocks 9,16,20 to place on top of the wallpaper. See eg. FIG. 11.

### Information Setup/Source

Wallpapers are set from the main screen settings. Since the main screen and the back-screen are very similar in aspect ratio, images used as wallpaper 9,16,20 for the main screen can also fit the back-screen.

### Static Image 9,16,20

One or several images can be set as wallpaper 9,16,20, or the entire photo library. If several images are set there's a timing option for how long they can be shown. Images can be selected from the local storage 46 or from an online source (“Rich Site Summary” often dubbed “Really Simple Syndication” (RSS) feed).

### Social Network Live Wallpaper 9,16,20

Wallpaper 9,16,20 can show dynamic information from the user's social networks obtained via the network interface 40, such as Facebook and Twitter with beautiful typography and photos.

### Ever-Changing Live Wallpaper 9,16,20

Wallpaper can use the current location, weather information, time of day and season to provide a unique and interesting wallpaper 9,16,20 that is always slightly changing.

eReader—Dual Screen 12,14

The reading experience can always start in the Library application 32 where all books, magazines and other publications 9,16,20 are stored. Resuming reading can be done directly from the back-screen 14 by launching the eReader application 32. Reading can be done on the both the main screen and the back-screen. Reading on the back-screen can be easier on the eyes thanks to paper-like appearance of the e-ink display and it will use far less power.

There's an action 18 in the reading application 32 on the main screen to move the reading from the main screen to the back-screen. When the action 18 is selected there can be a popup showing that the book is being transferred to the back-screen and after a short time-out the main screen can be turned off and the back-screen can switch to Reading mode, showing the same publication 9,16,20 that was just on the main screen. See eg. FIG. 23.

### Flipboard/RSS—Back Screen Application 32

Reader for RSS feeds 9,16,20 of choice, swipe to navigate to next previous article 9,16,20.

### Information Setup/Source

RSS sources 9,16,20 are set up in the back-screen settings application on the main screen.

### Music Player—Back Screen Application 32

The music player 32 allows the user to resume the latest played song/playlist 9,16,20 and swipe for next or previous song. The album cover art, the artist name, the name of the song and the album are displayed on the back screen 14 as contextual data 9.

### Information Setup/Source

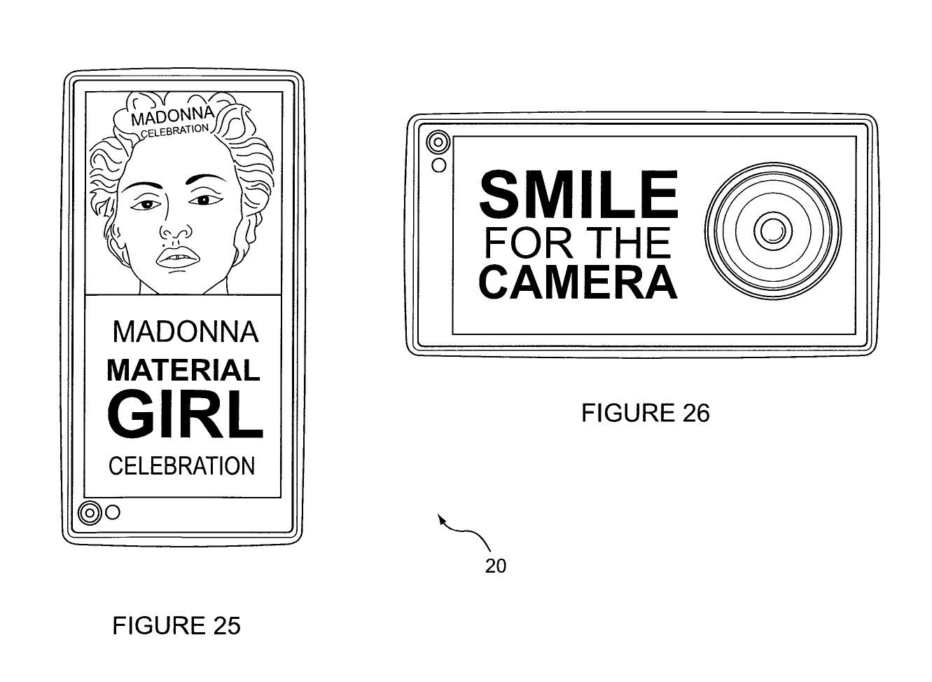

Music can be stored on the device 10 and played in the native Android music player. See eg. FIG. 25 for possible corresponding back screen output.

### Calendar/Agenda—Back Screen Application 32

A simple and clear view of upcoming events.

### Information Setup/Source

Meetings and reminders 9,16,20 from the native Android calendar.

### To-do List—Dual Screen Application 32

What do you have to remember, the digital post-it 9,16,20 that's always with you.

### Information Setup/Source

A separate to-do list application 32 that makes it quick and easy to create to-do lists 9,16,20, the lists can then be seen both in the application on the main screen and on the back screen.

### Put to Back

Screenshots 9,16,20 can be captured from the main screen and put 18 on the back-screen.

### Weather—Back Screen Application 32

Shows the current weather and forecast 9,16,20 for the current position or cities of choice, swipe to switch between locations.

### Information Setup/Source

The application 32 is set up on the main screen. External service that can provide appropriate information needs to be decided.

### Quote/Fact of the Day—Back Screen 20

A random inspiring quote or fun fact 9,16,20 is presented each day, swipe for next quotes.

### Information Source

Easiest way to handle this is probably to gather a large amount of quotes and facts, store them locally and randomly display them.

### Emotion-Messages—Regular Android

Friends that have been given permission can send messages 9,16,20 directly to the back-screen. See eg. FIG. 6.

### Information Source

Messages can be created and sent through a separate Emotion message composer application on the main screen. The composer can support drawings, text, photos, frames on top of photos, and stickers on top of photos 9,16,20. There can be predefined templates in which the user can add text and or photo to quickly create a message.

This can be a standard Android application 32 that can be downloaded from Google Play by people who don't have a Yota device, but they can still be able to create and send messages directly to the back-screen of a Yota device.

### Setting Up the Back-Screen 14

To avoid branching and patching to Android's core functionality setting up the back-screen can be done in a separate back-screen settings application 36 that handles all aspects of the back-screen. The back-screen settings application can scan the phone for any back-screen compatible applications 32 and they can appear within the application making it possible to set them up as well as assign them to applications slots.

Applications 32 for the back screen can behave just like any other Android application in the sense that it can be downloaded from Google Play and that it can reside in the all apps screen. The look and feel of the back-screen application 32 and dual screen application icons 32 can be harmonized so that they can easily be distinguished from regular android applications and each other. Pre-loaded back-screen and dual screen applications 32 can be placed in a separate group/folder.

Tapping on a back-screen application on the main screen can launch the back-screen application's 32 settings on the main screen. From here the user can set up the application e.g. stations for the timetable or location for the weather. It can also be possible to assign the application to an application slot on the back-screen or remove it from the back-screen.

Tapping on a dual screen application 32 can launch the application on the main screen just like a regular Android application. In the application the user can access the back-screen settings (same experience as tapping on a back-screen application). Depending on the design of the application the back-screen settings can contain different types and numbers of settings, but adding the application to and removing the application from the back-screen can always be part of the back-screen settings.

There's also one central back-screen settings application 36 where the user can add, remove and re-arrange applications. This is also where the back-screen notifications are set to either public mode or private mode. This setting can most likely not be changed very often.

### Application Broadcast

Application used on the main screen can broadcast 18 to the back-screen with additional information and visuals 9,16,20. The broadcast can inform others on what you′re doing with your phone as well as just being pure aesthetics. There are five standard applications 32 that can broadcast 18 to the back-screen:
Camera (See eg. FIG. 26.)
Video camera
Ongoing call (See eg. FIG. 8)
FindMyPhone—web service that can send messages directly to the back screen in the case it is lost.
Ouch message—if the phone is dropped to the ground.

### Notification Messages

There can be two settings for notifications: Private mode and Public mode. When the phone 10 is set to Private mode then notifications 9,16,20 can appear in full screen, but only show as icons/simple visuals 9,16,20 that tells what type of notification it is, but not any details on who it's from nor its content.

When the notification setting is set to Public Mode notifications can display a photo 9,16,20, if available, of who it's from and some or all of its content (see eg. FIG. 6). Swiping the touch strip can dismiss any notification.

If the phone receives several notifications at the same time then they can be stacked on top of each other on one screen, the notifications collection 9,16,20. The user can see what has happened since she last looked at the phone and dismiss all the notifications with a swipe, just like a single notification. Notifications 9,16,20 are not cleared from the back screen and as long as they are treated as unhandled notifications, which means that as long as the notifications are shown in Android's status bar on the main screen they are treated as unhandled on the back-screen as well.

Some notifications are time critical e.g. Incoming call, Clock alarm and Timer alarm. These notifications can be dismissed with a swipe just like any other notification. The difference is that the swipe also performs an action. The swipe gesture on the mentioned notifications can result in the following actions:

### Incoming Call

Swipe—mute ring tone
Long press—send busy tone—results in a missed call notification

### Alarm

Swipe—snooze alarm
Long press—turn off alarm

### Timer Alarm

Long press—turn off alarm

Unhandled notifications can be seen at any time in the wallpaper application as discrete icons on top of the wallpaper.

The back-screen can support all standard Android notifications, which can be designed specially for the back-screen. There can also be a Generic application notification—this notification can be used for all other 3rd party applications 32 that can trigger notifications that appear on the back-screen.

### Active Back Screen Usage

When in actively using the back screen 14, e.g. reading a book or RSS feed, then notifications can be shown as a discrete overlay 9,16,20 at the top of the screen and can time out automatically. When using the back-screen actively the most likely thing the user wants to do is read and not to be disturbed by full screen 9,16,20 notifications. To know what's going on in more detail the user can simply flip the phone over 18 to see the notification 9,16,20 on the main screen 12.

### Gestures on the Phone's Front

Above and below the main screen there are two capacitive areas 47 that are used for general navigation of the device and work as a replacement for the traditional hardware or on-screen Android buttons.

At the bottom of the screen is the navigation bar; this is where the main navigation in Android is done. There are three main areas which works as thresholds for how long a touch motion 47 on the navigation bar is to be before it is detected as a gesture.

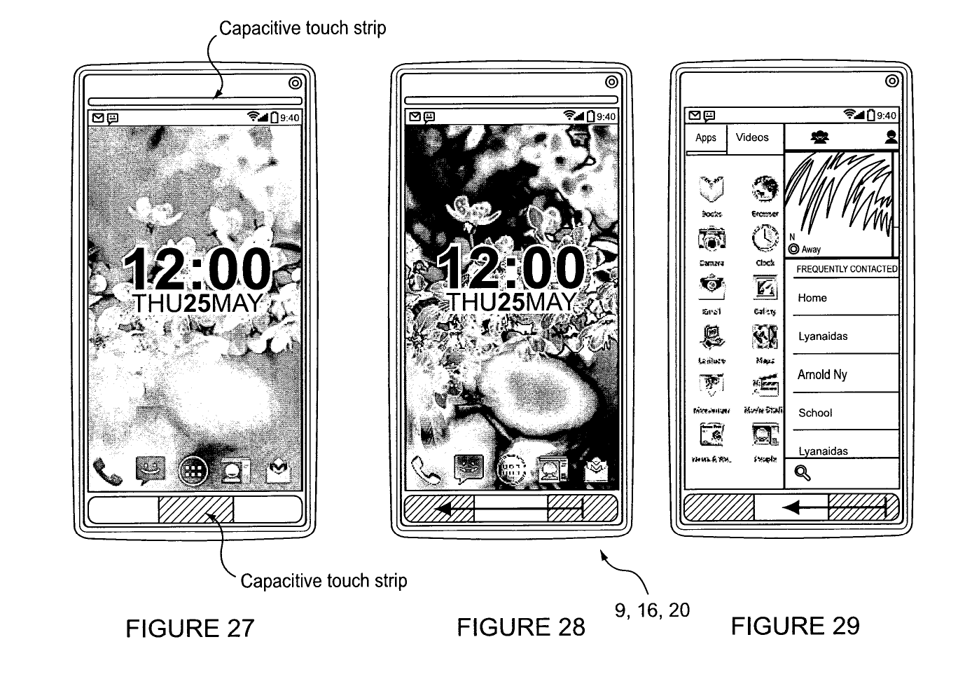

In an example, there are seven gestures on the phone's front (See eg. FIG. 27.)
Home
Back
Multitasking
Menu
Next running application
Unlock
Put to back

### Home Gesture

Swiping from right to left across the entire navigation bar (or across the screen in another example) can trigger the Home action, which takes the user to the Home screen. See eg. FIG. 28.

### Back Gesture

Swiping from the right to the left across half the navigation-bar (or across the screen in another example) can trigger the Back action, which takes the user one step back in the navigation history. See eg. FIG. 29.

### Multi-Task Gesture

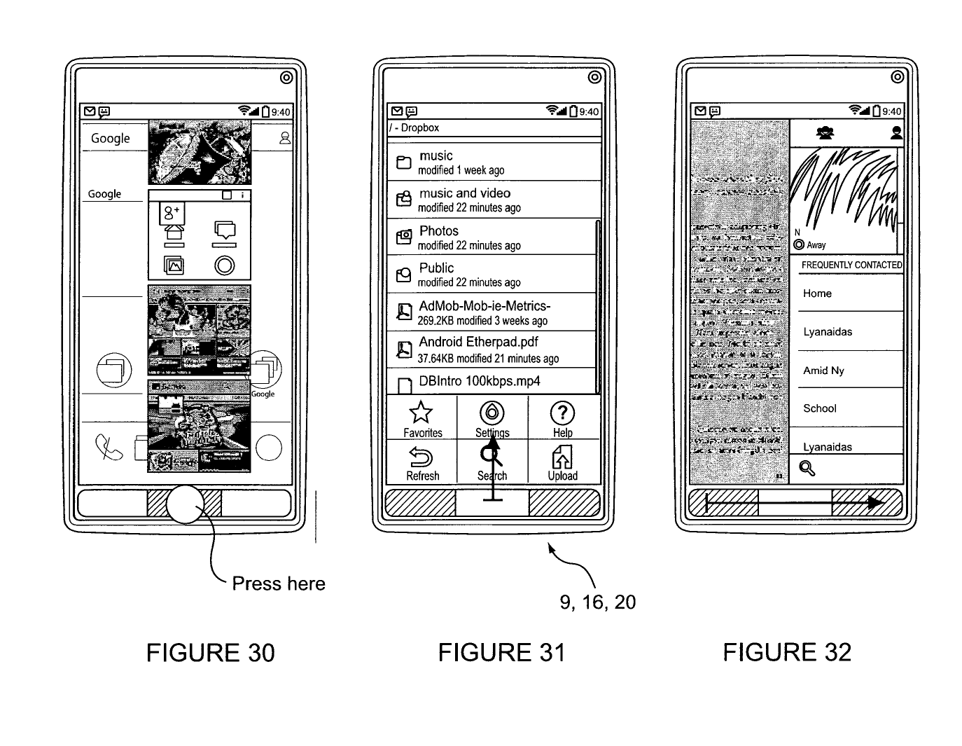

To quickly switch between applications and tasks is essential in Android; long press on the navigation bar (or on the screen in another example) can trigger the multi-task menu. See eg. FIG. 30.

### Menu Gesture

Swiping upwards on the navigation bar (or across the screen in another example) can trigger the Menu action. Older Android applications, which are not adapted to ICS, need access to the Actions menu. This gesture could only be available in these older applications and nowhere else. See eg. FIG. 31.

### Next Running Application Gesture

Swiping from left to the right the entire navigation bar (or across the screen in another example) can trigger the Next app action, which takes the user to next running application, a quick and easy way to switch between recent applications. See eg. FIG. 32.

### Lock/Unlock Gestures

There are two ways of locking and unlocking the device; the first way is to press the lock/unlock button on the top of the device—Android standard behavior.

The second way to unlock the device is to swipe one finger from the bottom capacitive strip and up over the screen across the threshold-line. The difference between the unlock gesture and pressing the lock/unlock button is that the device unlocks straight in to the application that was last used without passing through the standard Android lock screen.

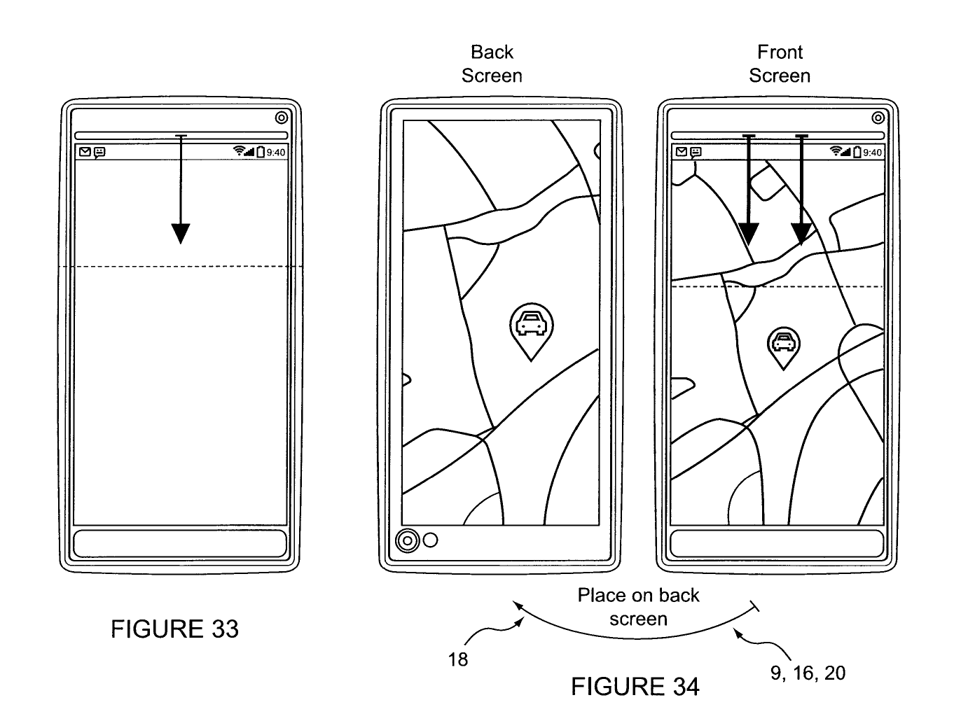

Swiping with one finger from the top capacitive strip and down over the screen across the threshold-line (or across the screen in another example) can lock the device. See eg. FIG. 33.

### Put to Back Gesture 18

At any time when using the device normally on the main screen the two finger gesture 18 from the top capacitive bar 47 down across the threshold-line (or across the screen in another example) can trigger 18 the possibility to take a screenshot 9,16,20 of what is currently on the main screen and place it 9,16,20 on the back-screen. There's a special application slot for the screenshot in the Home screen mode on the back-screen.

The gesture first triggers 18 a dialog 9,16,20 which gives the user the possibility to replace what is currently placed on the back-screen or to simply remove what is currently there. The later option removes the Put to back application 32 from the back-screen, making it possible to keep it tidy and clean. The Put to back application 32 can be added to the back-screen again once the user chooses to place something new on it. See eg. FIG. 34.

3rd party applications 32 for the back-screen: 3rd parties can be able to develop applications to produce output on the back-screen. The goal is to have a wide array of fun, beautiful and useful applications to run on the Platinum device. All applications can go through an acceptance process at Yota before being published on Google Play for purchase and download.

Applications running in the main screen can also create add-ons for application broadcast to the back-screen.
Brings surprise and delight
Plays on the tension between permanence and temporary
Niche and loveable
Is made better by a low-fi, limited visual experience—people should want to leave the e-ink screen facing up.
Doesn't interrupt unless you want it to
Highly customisable and modifiable

Each case-example of use is designed to demonstrate the breadth of use and inspire developers about the beauty, wonder and emotion delivered by a Dyad (two-screen) experience.
personal relationships
being local
niche interests
embracing personal tastes and combining them with surprise and delight

Insights: people love self-improvement, popularity of Pinterest

In a nutshell: inspirational eating ideas one/day provides simple recipes based on what you want to cook/eat more of:
Fresh juices and smoothies
Artisan breads
Dessert/baked treat recipes
Sauces
Salads

Functions: Save to favourites; Send ingredients to Shopping List

Sponsors: Celebrity chefs/food brands/supermarkets

Insights: If you go offline, weather forecasts 9,16,20 disappear; everyone has a subjective view of what makes for good weather; local needs only

In a nutshell: live-updated local super simple weather forecast in beautiful symbols; subjective description of how you like your weather
Chance of rain
How much sun
Wind direction and strength
Feather rated on a scale of 1-10 “fantastic weather”

Functions: Create profile of what comprises a fantastic day based on rain, cloud, crispness, temperature,

Sponsors: Weather channel/Met Office

Insights: Typically people will be looking for the same type of shops/services on a map

In a nutshell: hyper-local map (5-10 min walk) with the things you usually like
Sushi restaurants
Banks
Bakeries
Coffee Shops
Pharmacy

Functions: Programme your own maps with the types of stuff you like

Sponsors: Local brands/Community Councils/Tourist Boards

Insights: If you fly a lot, it's to have a simple updated departure board

In a nutshell: Low-fi updated departure board from your airport. An equivalent for the public transport London underground subway system example is shown in FIG. 10.

Functions: Programme which airports you want to know about

Sponsors: Airtravel brand (BA/SAS/Lufthansa etc)

Insights: A demonstration of the hyper-niche interest in interesting slow-fi stuff

In a nutshell: Where is the Mars Rover now?

Functions: possible photo app on the reverse; or none, just infographic of the Mars Rover.

Sponsors: NASA

Insights: People probably can only get to a handful of venues, but want to see what is going on for last-minute entertainment/activities for culture vultures

In a nutshell: Local what's-on event listing for tonight/tomorrow
Shows/DJs/Exhibitions/Private Views/Lectures/etc.
Ie. @ Southbank Centre; Barbican; Tate Modern

Functions: Create profile of local venues you′re interested in knowing about; simple graphics illustrate: free/ticket availability/times

Sponsors: Alcohol brands, Local Councils, Arts Council

Inspiration from TED, in quote form. Updated daily based on your interests and newly loaded talks. An equivalent for the sayings of Sun Tzu is shown in FIG. 20.

Function: programmed based on your interests.

Sponsor: TED

Insights: A bit of inspiration/info about what produce is in season is quite appealing when shopping

In a nutshell: based on where you live, a list of what produce should be in season to reference when shopping
Courgette
Apples
Pears
Plums
Lettuces
Tomatoes

Functions: Programme foods you dislike so you don't see them

Sponsors: Waitrose-type upscale supermarket brand

Insights: If you′re going to the cinema, chances are you'll go to the same one regularly and only want to know what's on, on the day.

In a nutshell: based on your cinema preference, a list of movie times and ticket availability using ultra-simple graphics

Functions: Programme which cinema you prefer

Sponsors: Cinema brand (Odeon); Coca Cola; Cadbury

Insights: Reflects the highly niche interest in infolust

In a nutshell: how many people are where, right now?
In the sky
In space
In a submarine

Functions: Programme what sort of info you want

Sponsors: News agency, Ipsos, PWC, etc.

In a nutshell: At a glance simple graphic financial information based on:
Your preferred stocks
How many days you want to know about
Last month; last week; yesterday; today

Functions: Programme stock preferences and days covered

Sponsors: Waitrose-type upscale supermarket brand

Insights: People tend to follow one league or event at a time, want to be inspired by it, have updated information on it, etc.

In a nutshell: Single event/league/team daily info based on your preferences, for example with the Tour de France:
The day's stage—mini map
Leaders
Mini-story about the stage or an interesting rider

Functions: Programme events/player/rider/league you want to follow

Sponsors: Emirates, ASO, F1, Adidas

Insights: Hayfever sufferers care a lot about pollution and pollen levels

In a nutshell: A daily, local pollen/pollution count illustrated with charm

Sponsors: Allergy medicines, Boots/Pharmacy Brands

Insights: Simple list of the day's food, to keep people on-track with their diets

In a nutshell: a list of the day's planned meals to keep you on track
Breakfast: Coffee (no sugar/milk), small cup Orange Juice, ½ cup muesli with soya—350 cals
Lunch: Salad with fish or chicken, small fruit smoothie, 3 squares chocolate—500 cals
Snack: nectarine—50 cals
Dinner: Clams with Spaghetti in white white broth with side salad, glass of white wine—800 cals

Functions: Once a week planned eating programmed

Sponsors: Weight watchers/Supermarket/Gym

Insights: A little reminder is sometimes all it takes

In a nutshell: A one-a-day motivational quote to get you moving
“Persistence is stronger”
“It's not buffering, this is me, standing still”—Usain Bolt

Functions: What kind of motivation/humour level you want

Sponsors: Gym brand, Adidas, Reebok, Puma, etc

Insights: People who are into a specific sport/fitness practice are often very keen to know exactly what they should do and for inspiration

In a nutshell: A beautifully explained/illustrated pose/day along with tips and information

Functions: Save to favourites, programme level of ability

Sponsors: Sweaty Betty, Lululemon

### Flipcards 9,16,20—Education

Insights: When waiting, a basic, un-cheat-able flip card is great for learning all sorts of things, especially if you can programme it yourself

In a nutshell: Basic flipcards for learning any subject matter
Vocabulary
Capitals, Names, History dates, etc
Math
Science
Foreign language (see eg. FIG. 13 for Mandarin Chinese)

Functions: Programme all the questions you want to ask, with a simple forward/back flip 18 function

Sponsors: Education brand

Insights: A top-line overview of the day's headlines is sometimes all you need—and usually from one paper is enough

In a nutshell: The headlines from your newspaper of choice

Functions: Programme which newspaper/topics you′re interested in

Sponsors: Guardian, The Times, BBC, etc.

Insights: A seamless way for parents to know who is going where/when in the neighbourhood to play is necessary

In a nutshell: A location-based service to indicated where/when different parents are taking their kids/dogs to play
Jenny taking Elliot to Wandsworth Common Swings @ 11 am
Sandy taking Tilda to Wandsworth Common Swings @ 11 am
Eric taking Margot to Tooting Bec Lido @ 11:30

Functions: Programme where you're going, when, for how long

Sponsors: Mumsnet, Mommas & Papas, Mothercare

Insights: People who are into religion never get tired of their favourite stories, but also love discovering a story they forgot

In a nutshell: Bite-sized (Bible) stories/passages for inspiration. See eg. FIG. 19.

Functions: Programme what version (Bible) you want

Sponsors: religious publishers

Insights: Currently already used, but not very beautiful, in text format

In a nutshell: A geo-fenced notification from your favourite shops with discount vouchers in the form of beautiful digital ephemera

Functions: Sign up to specific brand/store notifications

Sponsors: . . . any retailer

Insights: Sometimes simple information is all you want about what tickets are going to be available and when, to your favourite venues/artists

In a nutshell: Ticket sales information in a simple single list
This week; Today; This Hour
By Venue
By Artist
By Genre (Comedy/Rap/Rock/Ballet/Opera)
By dates you're interested in

Functions: Programme preferences

Sponsors: Theatres, Venues, Coca Cola, etc.

Insights: If you′re a history-buff, you′d love to explore an area based on historical imagery

In a nutshell: Based on geo-location, an image (and mini description) from that location as archived in the British Museum (for example)

Functions: Programme your favourite historical era; save to favourites

Sponsors: British Museum; Victoria & Albert Museum; Oxford Historical Society

Insights: Beautifully designed ephemera based on events you′re attending

In a nutshell: Conference schedule, wedding programme, shop sale, Christmas market, etc. Might include mini-map, announcements, speakers, times, etc.

Functions: Get sent a link to event ephemera, which is then available on the day for reference; designed by host.

Sponsors: Paperchase/Stationers, Event-by-Event paying

Insights: For parents with small children and very simple pastime can be a life-saver

In a nutshell: Shapes and numbers for kids to learn, with the help of parents
Geometry: Triangle/Circle/Square/Trapazoid
Numbers
Animals
Letters/Words

Functions: Programme birthdate of child for appropriate level of learning

Sponsors: Mumsnet/education brands etc.

Insights: Whatever your interest, it's always fun to deepen it with daily inspiration

In a nutshell: Once a day, a nice image of a thing of your interest
Flower of the day—for garden lovers (image, growing info, Latin name)
Constellation of the day—for astronomy lovers (image and info)
Chair of the day—for design lovers (image and info)
Shakespeare quote of the day—see eg. FIG. 21.

Functions: Programme your interest

Sponsors: Dezeen, Royal Horticultural Society, Kew Gardens, NASA, Royal Shakespeare Company (RSC) etc

Insights: Top rated restaurants/bars are always nice to know of

In a nutshell: Based on 5-10 min walk, what are the 4-5* rated bars and restaurants highlighted on a map with simple symbols

Functions: Programme food types you dislike so you don't see them

Sponsors: Time Out, Top Table, Zagat, Trip Advisor, etc

Insights: People like cats. The internet likes cats.

In a nutshell: Each time you open the app it gives you a single black and white version of a Cat/Dog (or anything #tagged) from Instagram in your area.

Functions: Programme what #hashtag you want to follow from Instagram

Sponsors: Battersea Cats/Dogs Home, depending on how specific we make it.

Insights: Intimate social exchange with the people you′re closest to can be the nicest

In a nutshell: Send an image and up to 200 characters note in the form of a low-fi digital postcard

Functions: Programme on a “front screen”, received on a “back screen”

Insights: keeping up with the conversations is sometimes better to do if you′re not able to obsessively refresh

In a nutshell: A basic hashtag Twitter trend list, downloaded only when you go the app

Functions: Programme the #hashtag you want to follow

Sponsors: Twitter

Insights: Based on your art interest, a single image is sometimes all you want, with a bit of information

In a nutshell: Once a day, a nice image of an art image
Modern Photography
Cycling Photography (contemporary or historical)
Nature/Wilderness
Illustration/comic

Functions: Programme your art interest

Sponsors: Tate, Team Sky, etc.

### Application Programming Interface (API) Example

Base Android OS platform does not have any support for unique device 10 hardware (e.g. second screen 12,14), especially the second screen. To fully utilize that hardware, and to have ability to interact with it from Android user application layer, we implement various changes across Android Framework Java API's. This hardware includes extended gestures support (utilizing top & bottom extended capacitive areas), and drawing on eInk Back Screen.

Yota Devices don't need complete “dual screen” support in Android: we don't need to modify Activity, View and Layout framework. From Android platform point of view—BackScreen can be just some additional hardware (HW) device, and interaction with it is done via small extensions in Android framework API. It can not use any major changes in Android framework, and won't break any compatibility.

Note, that all additional API's can NOT be available for call from any 3rd party user application. See the next section “API Security Requirements” for detailed security requirements.

### API Security Requirements

All Platinum API methods are available only for trusted applications. All broadcasts are protected by permission.

### API Permission Protection:

To access protected APIs, applications shall have permission and correct signature.

<uses-permission android:name=“com.yotadevices.permission.PLATINUM”/>

For information purposes new <uses-feature> is added.

<uses-feature android:name=“com.yotadevices.platinum”/>

Separate system services for API calls is created (each service is defined in each corresponding document section).

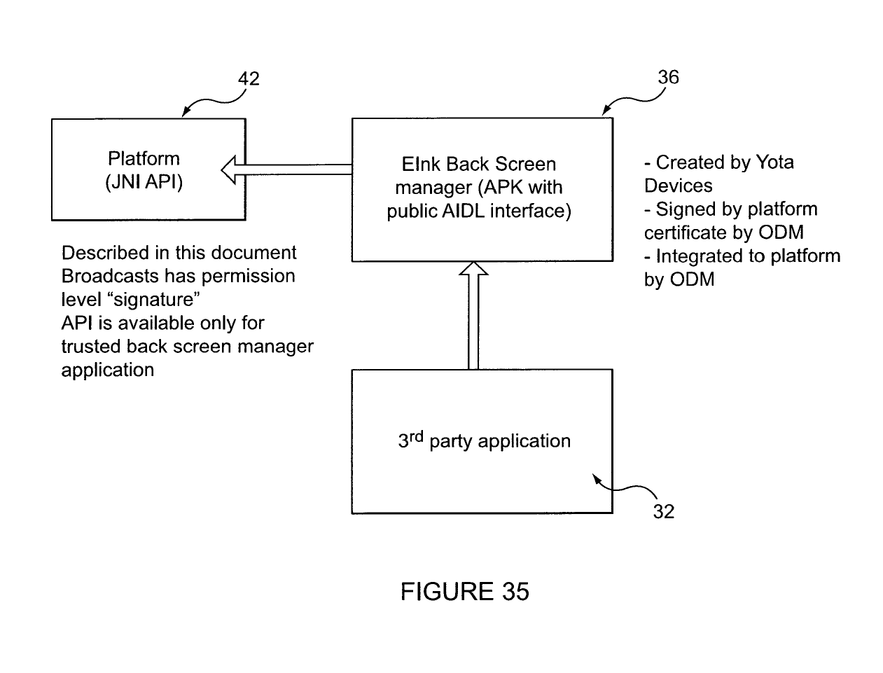

BackScreen Drawing Manager module 36: See FIG. 35 for example. With reference to FIG. 35, JNI is Java Native Interface, APK is Android application package file format, AIDL is Android Interface Definition Language, and ODM is Original design manufacturer. In FIG. 35, a 3^{rd} party application 32 uses the EInk Back Screen Manager to access the Java Native Interface API.

EInk Back Screen Draw Manager 36 is created by Yota Devices and supplied to ODM to integrate into platform build. Draw Manager 36 is signed by platform certificate for access to Back Screen drawing API and broadcasts.

### Extended Gestures

### Main Display Extended Capacitive Areas 47:

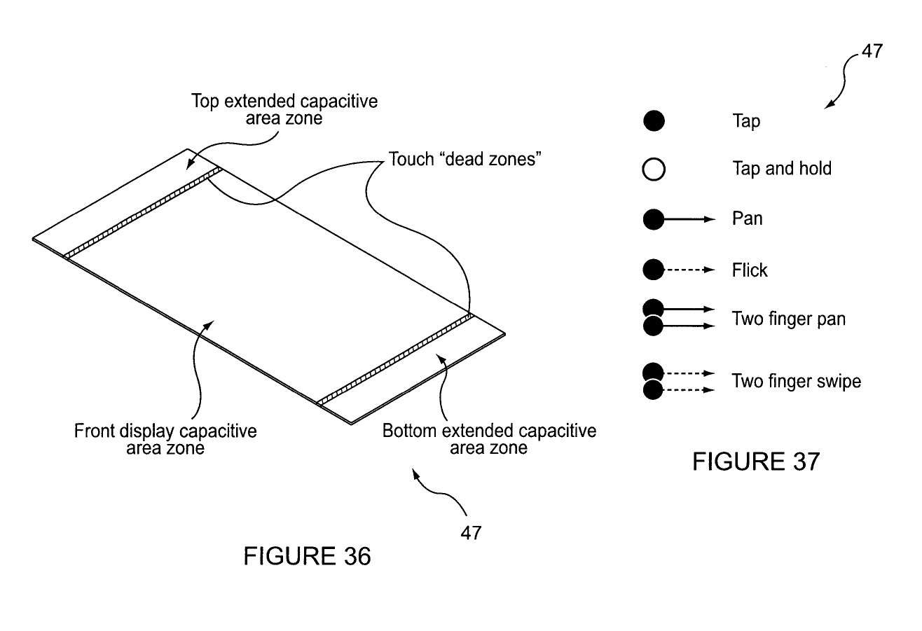

Touch panel 47—is solid, divided to 3 areas: upper zone, screen touch zone, bottom zone (above display panel). There are small gaps (“dead zones”) between screen touch zone and up/bottom touch zone—to eliminate unexpected lock or menu gestures when user interacts with phone at the border of the screen. See FIG. 36 for example.

Gesture Icon Description: see FIG. 37 for example.

Gesture Haptic Feedback, for example display data 9,16,20 as well as sensor 47 or other electronic component of the user interface 44:

Haptic feedback can be implemented for gestures using vibration service.

End-user can be able to enable/disable it in Android System Settings, Sound section. There can be additional checkbox, that enables/disables haptic feedback for all extended gestures as a whole.

### Extended Gestures—Action Button Replacement:

Target—replace Android ICS software buttons with extended capacitive area 47, that is located below the main screen 12,14.

These gestures can be captured on Android OS layer, and translated to Android Java layer emulated as press of related button, so we call this “Action button replacement”.

These gestures can be translated to calls of interface View.OnKeyListener from standard Android Java API.

### “Back” Gesture:

Panning right-to-left from the start section and releasing on the back section results in back command.

1. Start area length (35% of the screen width)
2. Back area length (35% of the screen width)
3. Home area length (30% of the screen width)

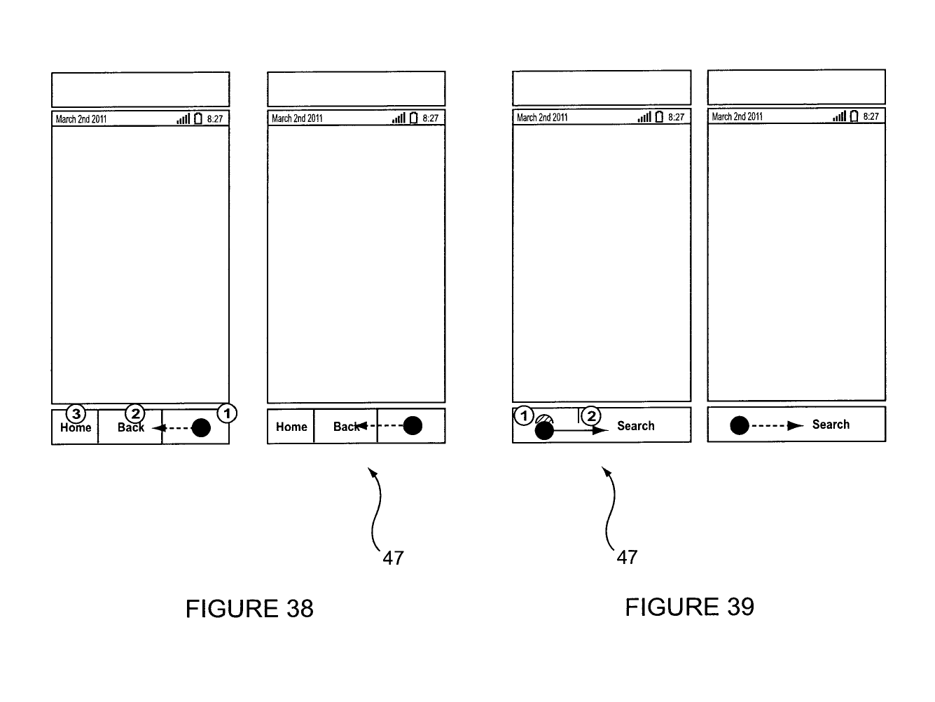

Flick right-to-left anywhere within the extended area results in back command. See FIG. 38 for example.

### “Home” Gesture:

Panning right-to-left from the start section and releasing on the home section results in home command. See FIG. 28 for example.

### “Search” Gesture:

Panning left-to-right from the start area and releasing on the search area results in the search command. See FIG. 39 for example.

1. Start area size (35% of the screen width)
2. Search area size (65% of the screen width)

### “Google Now” Gesture:

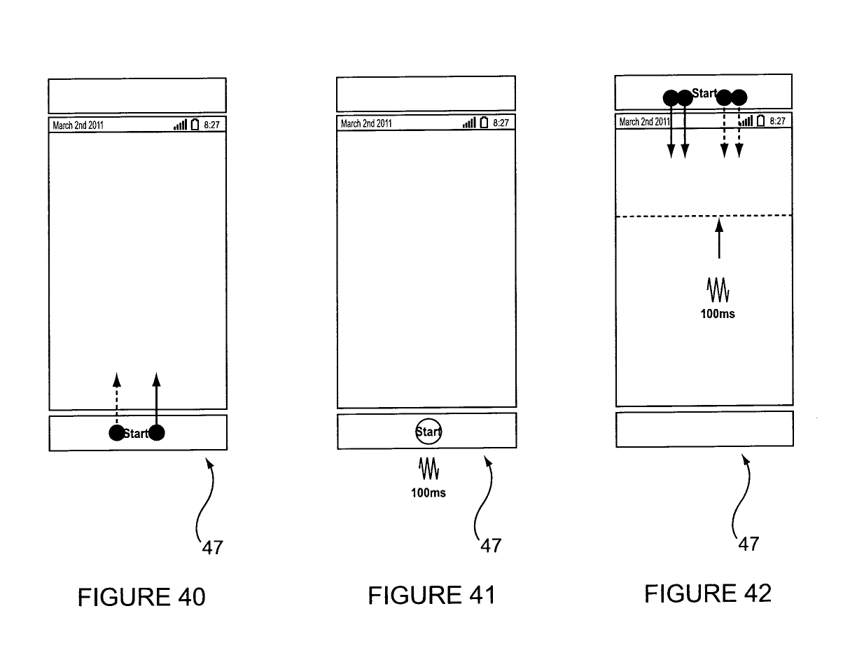

Panning or flicking from bottom up opens the Google Now application (com.google.android.googlequicksearchbox.SearchActivity). See FIG. 40 for example.

### “Recent Applications” Gesture:

Long press on the active area below the screen opens the recent applications menu. Duration of long press can be default for Android (500 ms). See FIG. 41 for example. 100 ms vibro after 500 ms long press delay to indicate to the user that event has been completed.

### Extended Gestures 18—“Put To Back”:

Two finger pan or flick 18 from outside the top of the screen puts the content to the back screen. A cut-off point of 50% of the screen height puts the content to the back screen. See FIG. 42 for example.

Haptic feedback 18 on the border where the put to back command is activated indicates to the user that releasing the input results in the action.

### “Put To Back” Gesture Event 18 Notification:

Because Put to Back gesture 18 capture can be captured and implemented at Android framework level, but actual application-level logic can implemented by Yota Devices—Yota Devices need to have event notification (Android intent) to ‘catch’ the gesture action.

When Put to Back gesture 18 is completed—it can raise broadcast intent. public static final String BROADCAST_ACTION_XGESTURES_P2B=“com.yotadevices.gestures.BROADCAST_ACTION_XGESTURES_P2B”;

Broadcast String constants can be defined in com.yotadevices.PlatinumGestures class. All broadcast events can be protected with com.yotadevices.permission.RECEIVE_GESTURES permission.

### Extended Gestures—“Screen Off/Screen On”:

### “Screen Off” Gesture

Panning top-down turns off main display. A cut-off point of 50% turns off main display.

The flick gesture does not need to be as long as the pan if the speed is enough to take the screen over the ScreenOff border.

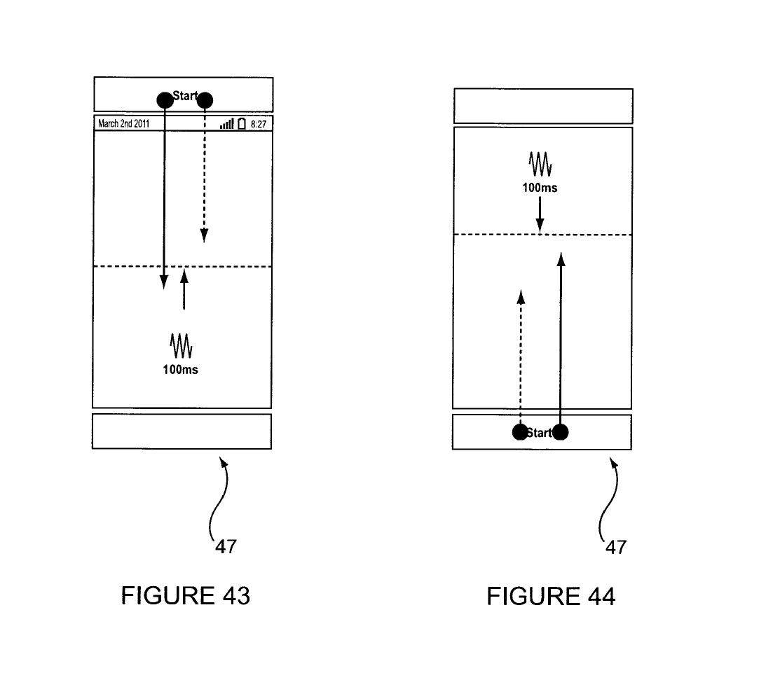

There is a non-active area between the top capacitive area 47 and the screen edge to separate ScreenOff gesture from notification bar drop-down gesture (Android built-in). See FIG. 43 for example.

Haptic feedback 18 on the border where the ScreenOff command is activated indicates to the user that releasing the input results in the action.

### “Screen On” Gesture

Panning bottom-up turns on main display. A cut-off point of 50% turns on main display.

The flick gesture does not need to be as long as the pan if the speed is enough to take the screen over the ScreenOn border. See FIG. 44 for example. Haptic feedback 18 on the border where the ScreenOn command is activated indicates to the user that releasing the input results in the action.

### “Screen On”/“Screen Off” Gestures and PIN Lock:

### Android Unlock Screen Behavior

PIN/face unlock/pattern unlock disabled—platinum unlock gesture can open

### Android Launcher Home Screen

PIN/face unlock/pattern unlock enabled—platinum unlock gesture can open PIN/face unlock/pattern unlock screen
   “Screen on”/“Screen Off” Gestures Event Notifications

When lock/unlock gesture is detected—broadcast intent can be raised in the system:

public static final String BROADCAST_ACTION_XGESTURES_LOCK=“com.yotadevices.gestures.BROADCAST_ACTION_XGESTURES_LOCK”;
public static final String BROADCAST_ACTION_XGESTURES_UNLOCK=“com.yotadevices.gestures.BROADCAST_ACTION_XGESTURES_UNLOCK”;

Broadcast String constants can be defined in com.yotadevices.PlatinumGestures class. All broadcast events can be protected with com.yotadevices.permission.RECEIVE_GESTURES permission.

### Top Extended Capacitive Area 47 Event Notifications:

Yota Devices have application, that can detect long-press on top extended area. (Long-press detection can work the same, as for ‘Recept Apps’ gesture in bottom extended area). And that application also can detect, when long-press event is stops (user raises his finger). To be able to detect such events, additional event notifications (Android intents) can be implemented:

### When Long-Press Event is Captured:

public static final String BROADCAST_ACTION_XGESTURES_TOP_LONG_PRESS=“com.yotadevices.gestures.BROADCAST_ACTION_XGESTURES_TOP_LONG_PRESS”;

### When Long-Press Event Stopped (Finger Raised):

public static final String BROADCAST_ACTION_XGESTURES_TOP_UP=“com.yotadevices.gestures.BROADCAST_ACTION_XGESTURES_TOP_UP”;

Broadcast String constants can be defined in com.yotadevices.PlatinumGestures class. All broadcast events can be protected with com.yotadevices.permission.RECEIVE_GESTURES permission.

### BackScreen Extended Capacitive Area Gestures:

There is one more extended capacitive touch panel 47 under back screen. The panel can send broadcasts for the following user actions.

Touch panel is divided to 3 equal parts (33.3% of the screen width)

Broadcast String constants can be defined in com.yotadevices.PlatinumGestures class. All broadcast events can be protected with com.yotadevices.permission.RECEIVE_GESTURES permission.

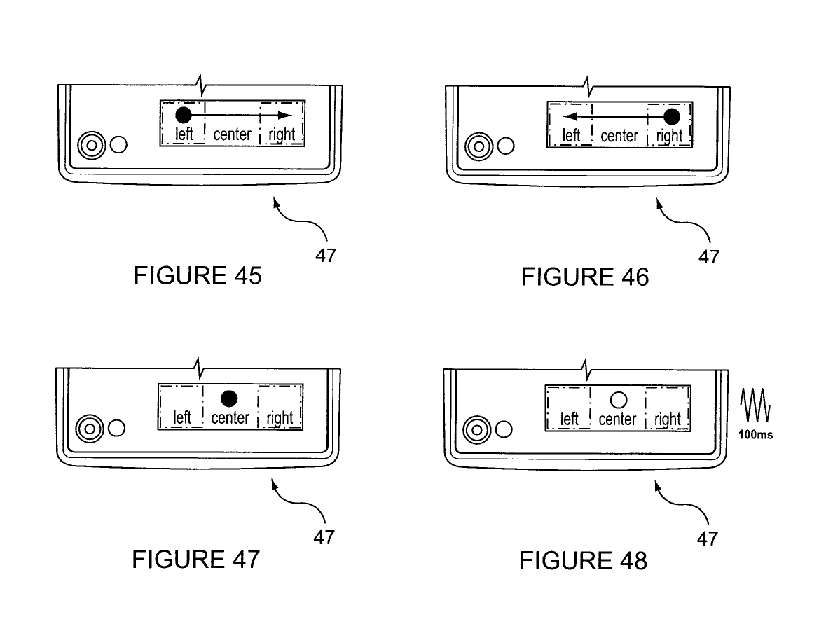

Flick/swipe from left to right: see for example FIG. 45.

public static final String BROADCAST_ACTION_XGESTURES_BS_LR=“com.yotadevices.gestures.BROADCAST_ACTION_XGESTURES_BS_LR”;

Flick/swipe from right to left: see for example FIG. 46.

public static final String BROADCAST_ACTION_XGESTURES_BS_RL=“com.yotadevices.gestures.BROADCAST_ACTION_XGESTURES_BS_RL”;

Single tap: see for example FIG. 47.

public static final String BROADCAST_ACTION_XGESTURES_BS_LONG_PRESS=“com.yotadevices.gestures.BROADCAST_ACTION_XGESTURES_BS_SINGLE_TAP”;

### Long Press (Tap and Hold):

Duration of long press can be default for Android (500 ms). See for example FIG. 48.

public static final String BROADCAST_ACTION_XGESTURES_BS_LONG_PRESS=“com.yotadevices.gestures.BROADCAST_ACTION_XGESTURES_BS_LONG_PRESS”;

100 ms vibro after 500 ms long press delay to indicate to the user that event has been completed.

### Android Three Dots Menu Bar and Menu Compatibility Mode:

For Platinum device software Android on screen buttons can be disabled.

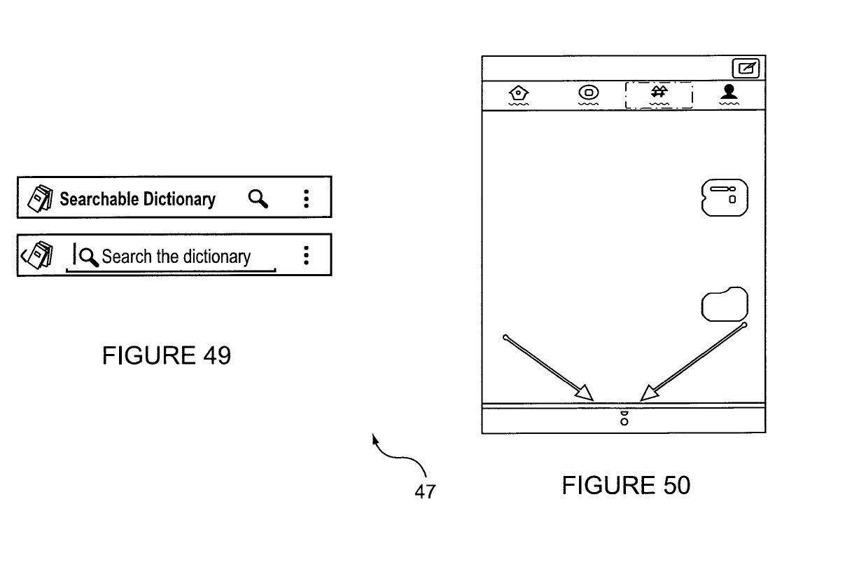

3-dots menu button can be available in action bar fot ICS or later applications. See FIG. 49 for example.

For backwards compatibility (for applications with API target level<14) menu soft panel can appear at the bottom of the screen with only menu button option. See FIG. 50 for example.

### Lock Screen

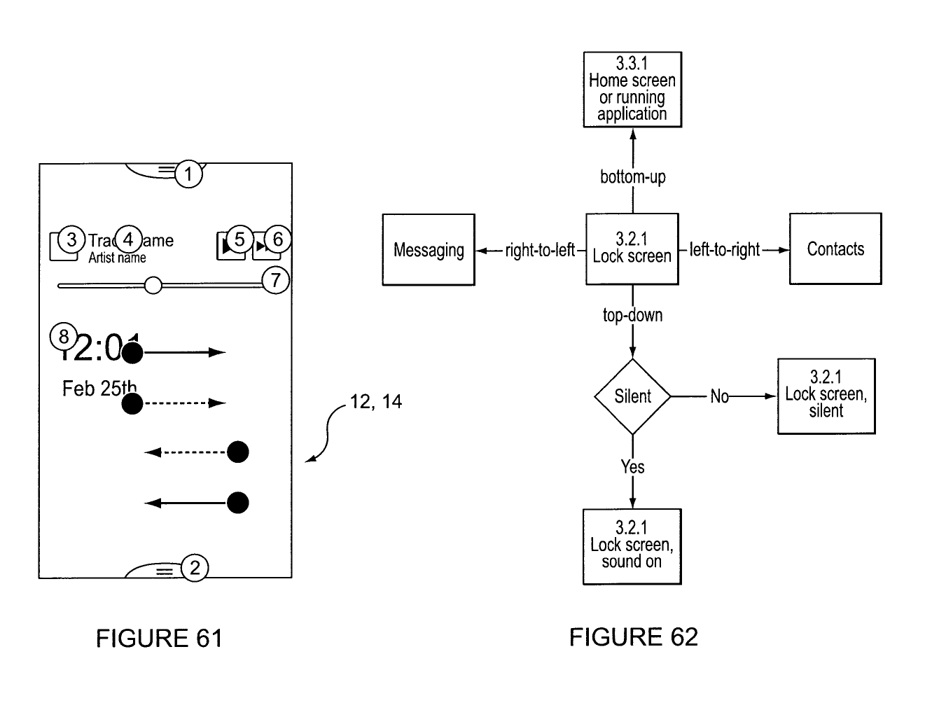

FIG. 61 shows an example of gestures on the back screen 12,14 of the device 10.

In an example, the lock screen is woken up by pressing the power button. The lock screen can show the same wallpaper 9,16,20 as the home screen.

As shown in FIG. 61, for example, swiping/panning left and right opens the device to specific applications that are user definable.

Default applications are

Left-to-right: Contacts

Right-to-left: Messaging

1. Pan or swipe down to silence device
2. Pan or swipe up to unlock device

Music controls are visible when a track is playing or paused

### 3. Album art

4. Track name and artist name

### 5. Play/pause

6. Skip to next track
7. Music volume
8. Date and time including standard Android system information, e.g. SIM missing

FIG. 62 shows examples of results that can be achieved as a result of defined gestures on the lock screen.

### EInk BackScreen Drawing API

Because we can use only limited electronic functionality from Back Screen (no touch interface, limited color space & refresh rate, etc.), we don't have to use full ‘rich’ API to draw on Back Screen.

Devices optionally need complete “dual screen” support in Android: we don't need to modify Activity, View and Layout framework. From Android platform point of view—BackScreen can be just some additional hardware (HW) device, and interaction with it is done via extensions in Android framework API. It can not use any major changes in Android framework, and won't break any compatibility.

Following changes on Android Java API's can be enough to implement Platinum Ux specification.

### EInk Screen 12,14 Drawing Terminology:

Update—Grey-level state change to an regional or global area of the display
Partial—Applying the waveform to only the pixels that change in a given region
Full—Applying a waveform to all pixels in a give region (Often confused with Global)
Regional Update—Only update a portion of the screen
Global Update—Entire screen area is updated
Concurrent Update—Multiple updates processed asynchronously
Waveform Modes (EINK 50-Hz Update Times): INIT, DU, GC4, GC16, etc.
Collision—Attempting to update pixel(s) that are currently being processed

### Waveform Selection

EInk has several waveform modes which are used for different greyscale depth and different update times
Longer waveform times will produce better greyscale accuracy
Waveform update characteristics are dependant upon the panel technology and can vary based on product generation or model

Application development has a trade-off between update speed and greyscale accuracy

### Screen Update Areas

Global
Regional

### Screen Update Types

Full
Partial

### Global and Regional Updates

A global update refers to updating the entire display while regional refers to updating only a portion of the screen
Up to 16 concurrent update regions can be processed asynchronously
Each regional update can select its own waveform

Application 32 can utilize regional updates to improve the effective frame rate of the display 12,14

### Utilizing Partial and Full Update Modes

Partial Update mode can be used to only update pixels that change for the update region of the display 12,14.
A Full update is often confused with Global. Full refers to applying a waveform to all the pixels for a global or regional update.
Ghosting can occur when using Partial updates.
Shorter waveforms will produce more ghosting than longer waveforms.
GC16 Full updates are used to remove any ghosting by driving the pixels to a known state (such as all black) before the final state.
A side effect of Full GC16 updates is a flashing effect that makes the update appear to flash during the transition.

Application can need to decide the usage of Full or Partial based on the user experience expectations.

### Collision Handling

A pixel can complete its transition before starting a new update
A collision can occur when attempting to change a pixel that is already in the update process
EPDC driver 36 can resolve collisions for the application 32
Application can experience a longer delay to the final image if collision occurs
Collision example—User presses character key and then immediately erases character; total update time can be 2× waveform update time

Application 32 can be designed to limit overlapping regions on a screen

All EInk function 36 calls can be synchronous (method can exit only when action is finished), or—asynchronous, but implemented with callback notifications on method completion. Asynchronous functions are preferred (if supported by EInk SW driver 36)

### EInk Drawing APIs 36:

To achieve perfect Back Screen Ux, get the best picture quality, and reduce post-refresh artifacts on eInk Back Screen, we use Android Java API 42 (of the device infrastructure 42) to access eInk refresh ‘waveforms’ 36:

public static final int WAVEFORM_MODE_INIT=0;
public static final int WAVEFORM_MODE_DU=1;
public static final int WAVEFORM_MODE_GC16=2;
public static final int WAVEFORM_MODE_GC4=3;
public static final int WAVEFORM_MODE_A2=4;
public static final int WAVEFORM_MODE_AUTO=5;
INIT—Initialization waveform (˜2000 ms)
DU—Black/White (Direct Update), ˜260 ms
GC4—4 level greyscale, ˜500 ms
GC16—16 level greyscale, ˜780 ms
A2—fast animation mode, ˜120 ms
AUTO—auto waveform selection mode (used when application doesn't know anything about image content)

Public void drawBitmapFull(int left, int top, Bitmap bitmap, int waveform) synchronous function

called for drawing bitmap on screen, makes a full-screen redraw, using current selected refresh waveform

### Parameters:

left—the position of the left side of the bitmap being drawn.
top—The position of the top side of the bitmap being drawn.
bitmap—the bitmap to be drawn.
waveform—waveform mode for transition.

If left=0, top=0 and bitmap width=screen width, bitmap height=screen height−full display update, full image size sweep can be performed.

Otherwise—full display update, user defined area sweep can be performed.

This function also can be available in Android NDK (The NDK is a toolset that allows developers to implement parts of their app using native-code languages such as C and C++. For certain types of apps, this can be helpful so that they can reuse existing code libraries written in these languages and possibly provide increased performance.):

static void draw_bitmap_full(AndroidBitmapInfo* info, void* pixels, int left, int top, int waveform)
public void drawBitmapFullAsync(int left, int top, Bitmap bitmap, int waveform, EInkCallback callback)
asynchronous function (if supported by electronic paper display (EPD))
public interface EInkCallback {

public void onEinkDrawComplete ( );

}

This function also can be available in Android NDK:

static void draw_bitmap_full(AndroidBitmapInfo* info, void* pixels, int left, int top, int waveform, EInkCallback* callback)
Public void drawBitmapPartial(int left, int top, Bitmap bitmap, int waveform) synchronous function
called for drawing bitmap on part of the screen (partial update), uses current selected refresh waveform. The region for the partial update is specified by it's top left corner+specified bitmap dimensions (X,Y pixels)

### Parameters:

left—the position of the left side of the bitmap being drawn.

top—The position of the top side of the bitmap being drawn.

bitmap—the bitmap to be drawn.

waveform—waveform mode for transition.

If left=0, top=0 and bitmap width=screen width, bitmap height=screen height—partial display update, full image size sweep can be performed.

Otherwise—partial display update, user defined area sweep can be performed.

### This Function can be Available in Android NDK:

static void draw_bitmap_partial(AndroidBitmapinfo* info, void* pixels, int left, int top, int waveform)
Public void drawBitmapPartialAsync(int left, int top, Bitmap bitmap, int waveform, EInkCallback callback)
asynchronous function (if supported by EPD)

### This Function can be Available in Android NDK:

static void draw_bitmap_partial(AndroidBitmapInfo* info, void* pixels, int left, int top, int waveform, EInkCallback* callback)

### EInk PIP (Picture-in-Picture) Mode Drawing API:

A PIP (picture-in-picture) Window overlays an new window (foreground image) on top of the currently displayed image (background image) without overwriting it. This function allows the background image to be restored without requiring the Host to rewrite the Image Buffer. PIP Windows are implemented using a separate PIP image buffer.

public void drawPIPBitmap(int left, int top, Bitmap bitmap, int alpha)
left—the position of the left side of the PIP bitmap being drawn.
top—The position of the top side of the PIP bitmap being drawn.
bitmap—the bitmap to be drawn.
alpha—transparency key value fot the bitmap to be drawn (0 . . . 255).
   public void movePIPBitmap(int left, int top)
left—new x position of the left side of the PIP bitmap being drawn.
top—new y position of the left side of the PIP bitmap being drawn.
   public void removePIPBitmap( )

Hides PIP window from the screen if any.

### EInk Thermal Warning API:

When EInk temperature reaches 63 C the broadcast notification 9,16,20 can be created:

public static final String BROADCAST_ACTION_EINK_TEMP63_WARNING=“com.yotadevices.BROADCAST_ACTION_EINK_TEMP63_WARNING”;

When EInk temperature reaches 68 C the system can perform system power off procedure. Additionally the broadcast notification can be created:

public static final String BROADCAST_ACTION_EINK_TEMP68_WARNING=“com.yotadevices.BROADCAST_ACTION_EINK_TEMP68_WARNING”;

### EInk Drawing API System Service:

For backscreen API calls we can have separate system service: com.yotadevices. BackscreenManager 36

Additional constant can be added to make this service available via getSystemService(String):

public static final String BACKSCREEN_SERVICE=“platinum.backscreen”;

Such service should be available only for trusted applications (which have corresponding permission). If such permission check fails, getSystemService( ) call should throw SecurityException

### High Level Application Platform API Extensions

### Notification Bar Events API:

We have to retrieve Android status bar notifications of the device infrastructure 42, to display notifications on the BackScreen too.

New status bar notification broadcast

NotificationManagerService 36 can be extended with additional broadcast (enqueueNotificationInternal)—new notification:

public static final String BROADCAST_ACTION_NOTIFICATION=“com.yotadevices.BROADCAST_ACTION_NOTIFICATION”;

Event can have extra with parceable Notification object:

public static final String EXTRA_NOTIFICATION=“com.yotadevices.intent.extra.NOTIFICATION”;

### Application Package Name (String) Extra:

public static final String EXTRA_PACKAGE=“com.yotadevices.intent.extra.PACKAGE”;

### Application Tag Name (String) Extra:

public static final String EXTRA_TAG=“com.yotadevices.intent.extra.TAG”;

### Notification Id (Int) Extra:

public static final String EXTRA_NOTIFICATION_ID=“com.yotadevicesIntent.extra.NOTIFICATION_ID”;

### Cancel Notification Broadcast

public static final String BROADCAST_ACTION_NOTIFICATION_CANCEL=“com.yotadevices.BROADCAST_ACTION_NOTIFICATION_CANCEL”;

### Application Package Name (String) Extra:

public static final String EXTRA_PACKAGE=“com.yotadevices.intent.extra.PACKAGE”;

### Notification Id (Int) Extra:

public static final String EXTRA_NOTIFICATION_ID=“com.yotadevices.intent.extra.NOTIFICATION_ID”;

### Cancel all Notifications Broadcast

public static final String BROADCAST_ACTION_NOTIFICATION_CANCEL_ALL=“com.yotadevices.BROADCAST_ACTION_NOTIFICATION_CANCEL_ALL”;

### Application Tag Name (String) Extra:

public static final String EXTRA_TAG=“com.yotadevices.intent.extra.TAG”;

### Clear all Notifications Broadcast

Occurs when “Clear all” Button Pressed:
public static final String BROADCAST_ACTION_NOTIFICATION_CLEAR_ALL=“com.yotadevices.BROADCAST_ACTION_NOTIFICATION_CLEAR_ALL”;

### Camera Events API:

We should have an ability to show some images 9,20 on the EInk screen while camera 32 is working 16.

Photo camera preview start broadcast (preview is working).

public static final String BROADCAST_ACTION_PHOTOPREVIEW_START=“com.yotadevices.BROADCAST_ACTION_PHOTOPREVIEW_START”;

Photo camera preview stop broadcast (preview is paused/closed).

public static final String BROADCAST_ACTION_PHOTOPREVIEW_STOP=“com.yotadevices.BROADCAST_ACTION_PHOTOPREVIEW_STOP”;

Camera photo capture button 47 is pressed.

public static final String BROADCAST_ACTION_PHOTOSHUTTER=“com.yotadevices.BROADCAST_ACTION_PHOTOSHUTTER”;

Video camera preview start broadcast (preview is working).

public static final String BROADCAST_ACTION_VIDEOPREVIEW_START=“com.yotadevices.BROADCAST_ACTION_VIDEOPREVIEW_START”;

Video camera preview stop broadcast (preview is paused/closed).

public static final String BROADCAST_ACTION_VIDEOPREVIEW_STOP=“com.yotadevices.BROADCAST_ACTION_VIDEOPREVIEW_STOP”;

Video camera recording start broadcast.

public static final String BROADCAST_ACTION_VIDEORECORDING_START=“com.yotadevices.BROADCAST_ACTION_VIDEORECORDING_START”;

Video camera recording stop broadcast.

public static final String BROADCAST_ACTION_VIDEORECORDING_STOP=“com.yotadevices.BROADCAST_ACTION_VIDEORECORDING_STOP”;

### Screenshot API:

Yota Devices engineers can implement Put To Back 18 feature, but each Put To Back call uses taking screenshot of current Front Screen content 16. After that it can be processed, and sent 18 to BackScreen to display 20.

public void takeScreenshot (String fileName) throws IOException;
takes current screen capture, and store it as PNG image file in file system.

### Parameters:

fileName—full path and file name for stored file (for example—“/mnt/sdcard/screenshot.png”)
   public Bitmap takeScreenshotToObject( );
   takes current screen capture, and returns it as Bitmap object in-RAM-memory

If such call is possible—it will be much faster, and easier, instead of writing file to internal memory storage.

### Volume Buttons API:

BackScreen eReading scenario uses hardware volume buttons 47 to switch pages (vol+/vol−).

When front screen 12 is turned off, user still can be able to scroll the book using volume keys. As a result—usement—volume keys can raise additional broadcasts notifications even when Front Screen 12 is turned off

public static final String BROADCAST_ACTION_VOLUME_UP=“com.yotadevices.gestures.BROADCAST_ACTION_VOLUME_UP”;
public static final String BROADCAST_ACTION_VOLUME_DOWN=“com.yotadevices.gestures.BROADCAST_ACTION_VOLUME_DOWN”;

To enable/disable this functionality when it not used—additional method should be added to the API

public void setVolumeButtonsEnabledWhenScreenOff(boolean enabled)
enabled—indicates whether to send additional volume buttons broadcasts when screen is off.

### High Level Application Platform API Extensions System Service:

For high level platform extension API calls we should have separate system service:

com.yotadevices.PlatinumExtension_Manager

Broadcast constants can also be defined in this class.

Additional constant should be added to make this service available via getSystemService(String):

public static final String PLATINUM_EXTENSIONS_SERVICE=“platinum.extensions”;

Such service should be available only for trusted applications (which have corresponding permission)

If such permission check fails, getSystemService( ) call should throw SecurityException

### Accessory API

Defines groups of function for extended accessory power monitoring. Especially for connected slave accessories, which uses power from the phone to charge their batteries.

### Accessory API System Service:

For Accessory API calls we should have separate system service:

com.yotadevices.PlatinumAccessoryManager

Broadcast constants can also be defined in this class.

Additional constant should be added to make this service available via getSystemService(String):

public static final String PLATINUM_ACCESSORY_SERVICE=“platinum.accessory”;

Such service should be available only for trusted applications (which have corresponding permission). If such permission check fails, getSystemService( ) call should throw SecurityException

### Accessory API Definition:

### Accessory Connection Status

public static final String BROADCAST_ACTION_EXTENDED_ACCESSORY_CONNECTED=“com.yotadevices. BROADCAST_ACTION_EXTENDED_ACCESSORY_CONNECTED”;
public static final String BROADCAST_ACTION_EXTENDED_ACCESSORY_DISCONNECTED=“com.yotadevices. BROADCAST_ACTION_EXTENDED_ACCESSORY_DISCONNECTED”;

Broadcast provides the ID of connected accessory.

Accessory ID (Int) Extra (32 Bytes of Accessory ID):

public static final String EXTRA_ACCESSORY_ID=“com.yotadevices.intent.extra.ACCESSORY_ID”;

### Accessory Battery Level Alarm

Android system can create notification when accessory battery level reaches N %

public static final String BROADCAST_ACTION_EXTENDED_ACCESSORY_LOW_BATTERY=“com.yotadevices. BROADCAST_ACTION_EXTENDED_ACCESSORY_LOW_BATTERY”;

### Battery Level (Int) Extra:

public static final String EXTRA_BATTERY_LEVEL=“com.yotadevices.intent.extra.BATTERY_LEVEL”;
public int getConnectedExtendedAccessoryId( ) throws AccessoryIsNotAvailableException;

Returns connected extended accessory ID.

public int getConnectedExtendedAccessoryBatteryLevel( ) throws AccessoryIsNotAvailableException;

Returns connected extended accessory battery level in % (0-100).

public void setMaximumExtendedAccessoryChargingAmperage (float amperage) throws AccessoryIsNotAvailableException;
amperage—charging current in mA

Method sets the maximum charging current.

public float getConnectedExtendedAccessoryChargingAmperage( ) throws AccessoryIsNotAvailableException;
Accessory charging amperage—returns current charging current in mA

### Temperature Broadcast Notification

public static final String BROADCAST_ACTION_EXTENDED_ACCESSORY_TEMPERATURE_CHANGED=“com.yotadevices.BROADCAST_ACTION_EXTENDED_ACCESSORY_TEMPERATURE_CHANGED”;

Android system can create the broadcast notification for every 5 C temperature change.

### Temperature (Int) Extra:

public static final String EXTRA_TEMPERATURE=“com.yotadevices.intent.extra.TEMPERATURE”;
public void setExtendedAccessoryChargingOn( ) throws AccessoryIsNotAvailableException;

Accessory Charging on—turns on accessory battery charging

public void setExtendedAccessoryChargingOff( ) throws AccessoryIsNotAvailableException;

Accessory Charging off—turns off accessory battery charging

Capacitive Touch Panel 47 Power Management API

Capacitive Touch Panel 47 Power Management API System Service 36:

For Capacitive Touch Panel Power Management API calls we should have separate system service:

com.yotadevices.PlatinumTouchManager 36

Additional constant should be added to make this service available via getSystemService(String):

public static final String PLATINUM_TOUCHPANEL_SERVICE=“platinum.touchpanel”;

Such service should be available only for trusted applications (which have corresponding permission)

If such permission check fails, getSystemService( ) call should throw SecurityException

Capacitive Touch Panel Power Management API Definition 36:

To minimize the power consumption the API for setting power save/active mode of capative touch screen 47 can be implemented with following parameters:

public void setRefreshRate(int rate);
rate—refresh rate (count per second). Low—5, Max—according to controller spec.

Sets touch panel refresh rate.

public void setHorizontallnterleaving(int lines);
lines—number of scanned lines (1-10)

Sets touch panel horizontal intreleaving (N=1-10, means that every N horizontal line will be scanned)

public void setVerticallnterleaving(int lines);
lines—number of scanned lines (1-10)

Sets touch panel vertical intreleaving (N=1-10, means that every N horizontal line will be scanned)

public void setScannedArea(int x1, int y1, int x2, int y2);

Defines the area (x1,y1, x2,y2) of touch panel that will be scanned

public void setFullTouchMode( );

Sets full touch mode—means that controller returns to the main operational mode

public void setStanbyTouchMode( );

Sets standby touch mode—means that controller is in low power mode and detects simple touch event only (without touch coordinates detection).

Screen (e.g. Back) Applications Management 36

There are three application 32 types for device 10:
Front screen application 32. The application that has no access to the back screen (e.g. YouTube application).
Back screen application 32. The service that has no front screen UI or only settings and has access to the back screen (e.g. wallpaper/clock application).
Back/front screen application 32. The application that has the main functionality at the front screen and additional functionality at the back screen (e.g. eReader application).

Different type of applications 32 can have different icon styles. See UI style guide for details.

There is a set of applications that can be preinstalled to the phone 10:
Wallpaper/clock application
eReader application
. . .

User can be able to make one back screen application 32 active and start displaying content at the back screen.

Only one back screen application 32 can access back screen 14 at one time.

User can be able to switch between active application 32 using back screen “application selection menu” that is available by long press at external capacitive area 47 under eInk screen. See gesture section for details.

Wallpaper/clock application can be active at the first phone start up.

Wallpaper/clock application can always be available at the first position in “application selection menu”

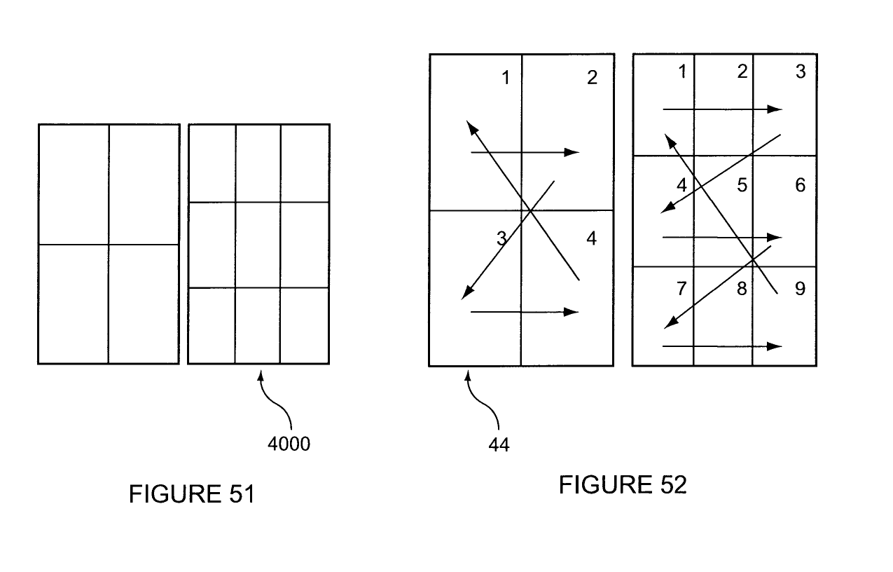

Back screen application selection menu can have two layouts 4000: 2×2 and 3×3. See for example FIG. 51. 2×2 Layout can be used if user has 1 to 4 recent back screen applications.

3×3 Layout can be used if user has 4 to 9 recent back screen applications.

Maximum 9 back screen applications can be available thru application selection menu.

Left/right cursor 44 selection navigation can work in the following way: see for example FIG. 52.

The most recent back screen application can be moved to the 2nd position (after wallpaper application) in the recent back screen application selection menu.

If there are 9 applications available in the recent back screen application menu, the 10th application can be moved to 2nd application position (as most recent) and the last application (at 9th slot) can be removed from the list.

Back screen applications and front/back screen application can have “move to back” screen switch according to Platinum UI guidelines.

Back screen application selection menu can also be available as front screen application.

Back screen application selection front screen application (BSFA) can be available as separate application shortcut at the home screen (at 1st phone startup).

The user can be able to remove back screen application from recent back screen applications list via BSFA.

Back screen settings options can be accessible via BSFA.

(e.g. Back) Screen Notifications

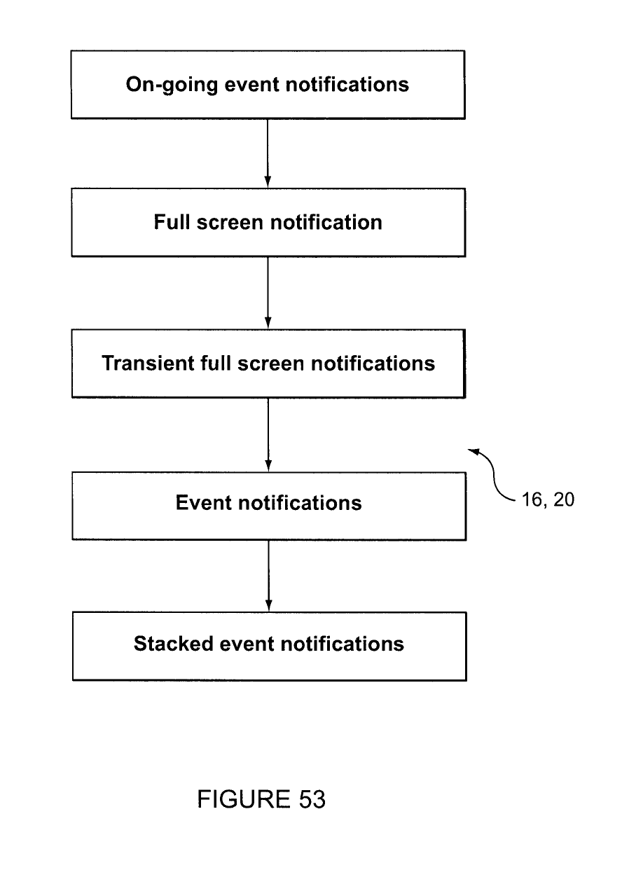

The can be four levels of notifications 16,20 that can be available in the framework. See for example FIG. 53. Ongoing event notification is high priority event from Android framework applications. The list of ongoing notification 16,20 events (in order of priority):
Incoming call
Ongoing call
Camera events
Alarm

Ongoing event notification cannot be dismissed by user from back screen. Full screen notifications are notifications that can be available at the back screen until dismissed. Full screen notifications can be dismissed by user using left/right flick/swipe at the external capacitive touch area. Full screen notifications 16,20 are stacked in order of appearance. 3rd party applications 32 can be able to show full screen notifications.

There are two notification 16,20 modes 4002, as implemented by the back screen display manager 36:
Public mode
Private mode

Modes can be switched in back screen settings menu.

Transient full screen notifications are available in public mode. Application can display full transient screen notification additionally to event notification for limited period of time (1 to 30 seconds).

### Example: Full Text SMS Message.

Transient full screen notifications can be dismissed using left/right flick/swipe at the external capacitive touch area.

If transient full screen notification is not dismissed by user—event notification will be shown instead.

If transient notification is dismissed by user—notification event can be stacked to wallpaper notification stack until cleared from front screen.

### Example: Missed SMS Message.

After left/right flick/swipe at the external capacitive touch area 47 each event notification can be stacked to wallpaper notification stack until cleared from front screen.

Event notification can not be displayed above wallpaper application—can be stacked automatically instead.

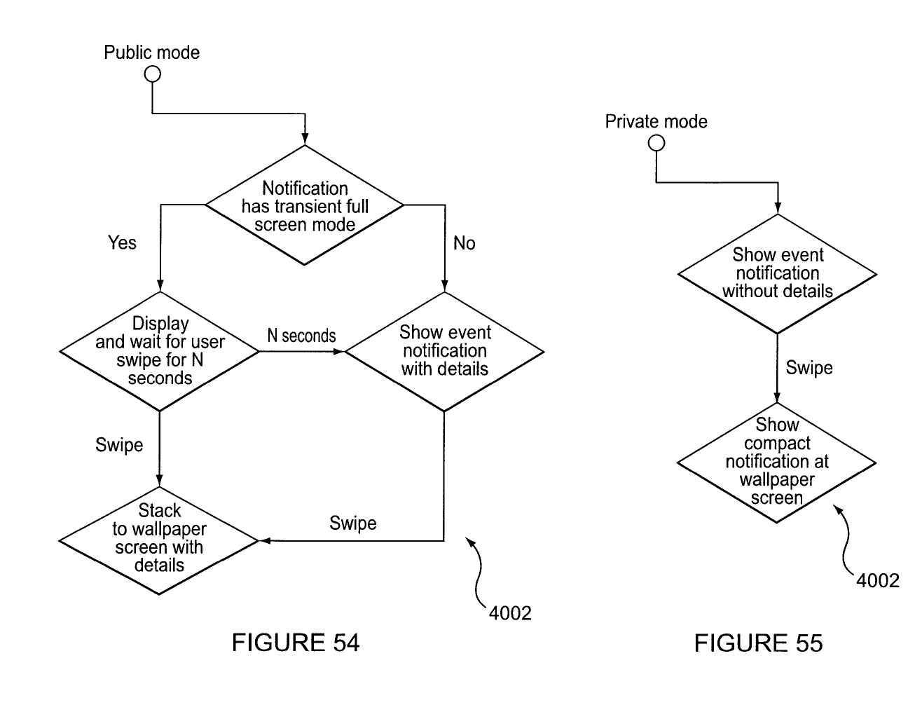

See for example FIG. 54 and FIG. 55.

The list of preloaded applications 32 that can display full screen transient notifications:
SMS message

The list of preloaded applications 32 that can display event notifications:
Missed call
SMS message
Calendar event

3rd party applications 32 that can copy 18 front screen notifications to the back screen out of the box:
Email
Gmail
Foursquare notifications
Facebook notifications
Instagram notifications
VKontakte notifications

User can be able to enable front screen notifications copy for any installed application 32.

The wallpaper stack can contain recent events in the following priority:
Missed call
SMS message
Calendar event
All other event in order of appearance

In private mode there can be icons with counters at wallpaper screen:
Missed calls
Missed SMS
Missed Events
Other events

In public mode there can be notification slots at wallpaper screen.

Missed calls from one person can always be collapsed in one item.

If there is no space for new notifications old notifications can be collapsed by type. If collapse by type is not possible—“other N notifications” message can be shown at last notification slot.

Event notifications also can be stacked in one event notification with the same rules as for wallpaper stack.

Stacked event notification can contain only events that have happened since last event notification was dismissed by swipe.

Back screen notifications can be cleared as soon as front screen notifications for the same events are cleared from notifications bar.

Back screen notification can not be displayed without front screen notification for notification bar.

User can disable each back screen notification (private mode, public mode) described in FIGS. 54 and 55 for example, and because for example Event notification can not be displayed above wallpaper application, Event notification can be stacked automatically instead.

User can enable private mode individually for each back screen notification described in FIGS. 54 and 55 for example, and because for example Event notification can not be displayed above wallpaper application, Event notification can be stacked automatically instead.

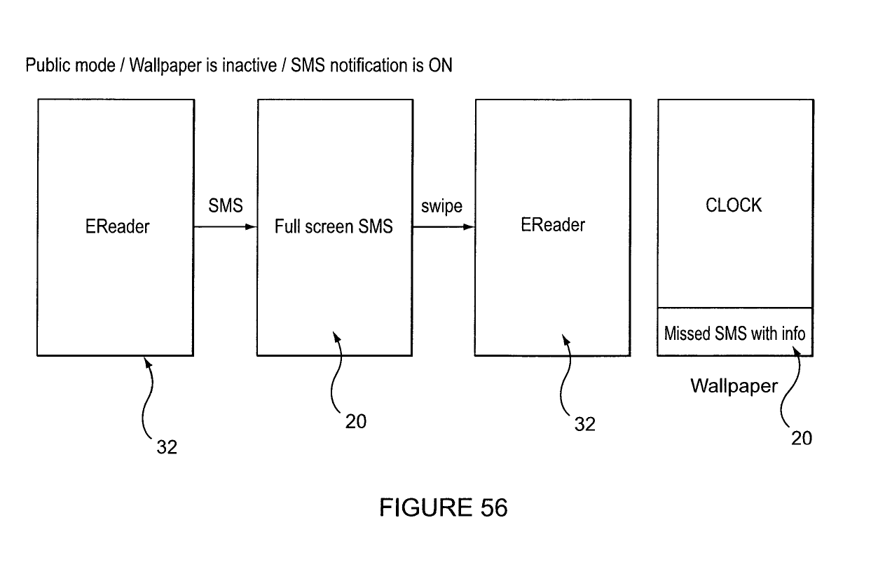

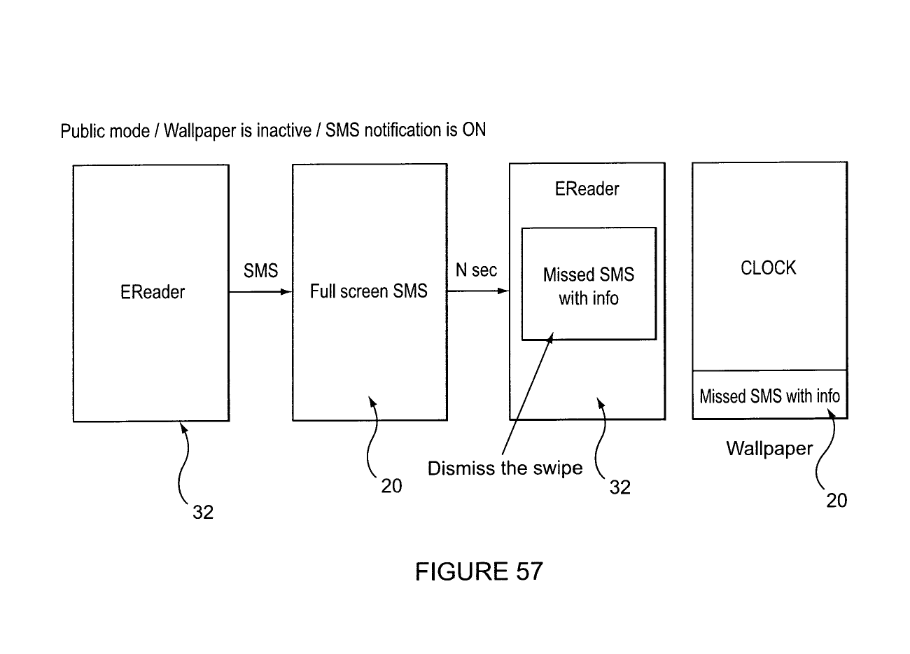

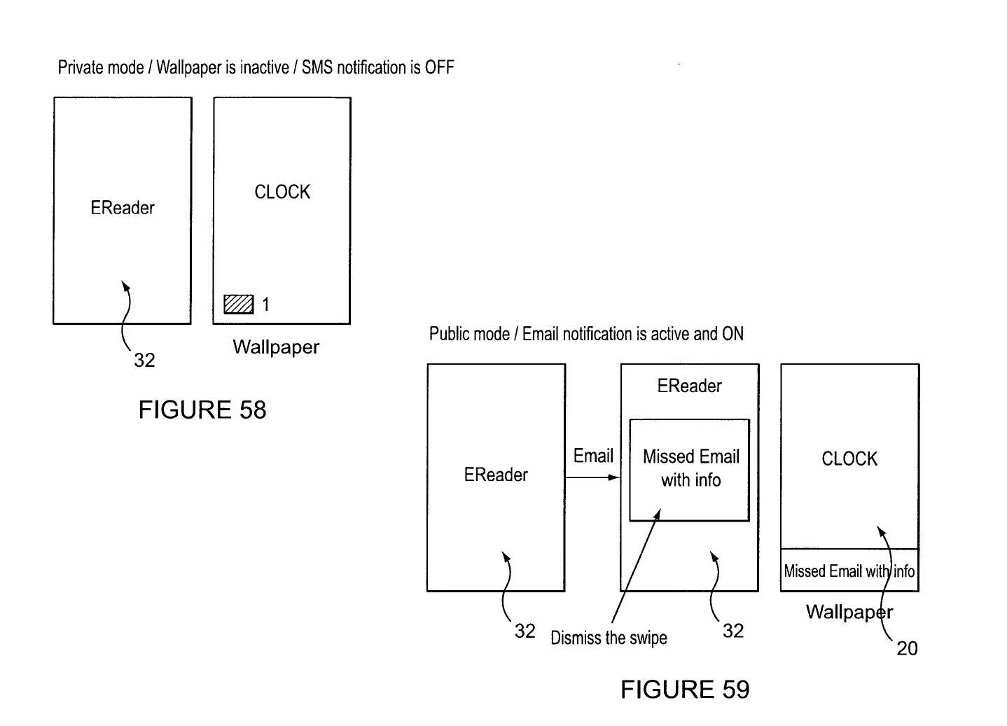

3rd party application can have an ability to create custom back screen notifications. See for example FIGS. 56-59.

All front screen notifications can be duplicated or reflected on the back screen.

(e.g. Back) Screen Settings

Back screen 14 settings can be available as separate application 32 icon at the home screen.

Back screen settings application can be available as separate application shortcut at the home screen (at 1st phone startup).

The following settings can be available in back screen settings menu:
Turn on/off notifications
Mode selection for notifications: private/public
The ability to disable public notifications for specific application
Music mode on/off for wallpapers application
Shortcut to wallpapers settings
   (e.g. Back) Screen Preinstalled Applications 32

### Wallpaper Application 32

Wallpaper application UI has a particular flow.

Wallpaper setup application can be available as separate application icon.

Wallpaper application icon can be placed to the phone home screen at the first start up.

User can be able to change clock style or turn it off.

User can be able to select active clock collection.

User can be able to select clock to display from the active clock collection.

User can be able to preview clocks from active clock collection using left/right swipe navigation at the front screen.

When active, clocks can not have seconds' indication and can be updated every minute.

Application can have preinstalled set of clock collections.

User can be able to install new clock collections as separate APKs.

User can be able to remove 3rd party clock collections.

Preinstalled clock collections cannot be deleted.

User can be able to invert clock if supported by selected clock type.

User can be able to change back screen wallpaper.

User can be able to select wallpapers from different sources. Wallpapers can be static (Gallery, Facebook, VKontakte, Instagram, 500px) or dynamic (live wallpapers).

Application can have preinstalled set of live wallpapers.

User can be able to install live wallpapers as separate APKs.

User can be able to remove 3rd party live wallpapers.

Preinstalled live wallpapers cannot be deleted.

User can be able to activate live wallpaper or select one or several sources for static wallpaper (Gallery, Facebook, VKontakte, Instagram, 500px). User can not be able to activate live wallpaper option with any other wallpaper option.

Static wallpapers can have 2 display modes: single and mosaic.

Static wallpapers can have update interval option: 5/15/30 minutes, 1/2/4/6/12/24 hours.

Gallery wallpaper options can have several modes: single wallpaper, multiple wallpaper and folder.

Single wallpaper gallery option can present crop dialog with aspect ratio equal to back screen resolution.

The list of wallpaper options can present additional information about selected options (e.g. single/multiple/folder for Gallery item).

User can be able to use his/her credentials to login to Facebook, VKontakte, Instagram and 500px services.

For Facebook/VKontakte wallpaper sources user can be able to select the following modes: single photo, multiple photos, album and user's news feed. Single and multiple photos can be selected from user's albums.

For Instagram wallpaper source user can be able to select the following modes: single photo, my stream, favorites, friends, tag.

For 500px wallpaper source user can be able to select the following modes: photos, stories, flow, favorites, popular, editor's choice, upcoming, fresh.

Application can include a least 3 types of preloaded live wallpapers: changing type, weather, all about me.

Changing types live wallpaper—is fractal/image/texture generation based on some rules.

Wallpaper can use phone system information (e.g. received calls/messages) as an input for generation algorithm.

Weather live wallpaper can use location information to provide user up to date information about weather. User can be able to choose one or several locations manually. Left/right external touch panel can be able to switch between several locations. Location can contain background photo based on current weather/city.

All about me live wallpaper can provide social user's information from different social networks: Facebook, VKontakte, twitter. Wallpaper can display public replies.

### Todo Application 32

Todo application settings can be available as front screen application icon.

User can be able to create several todo lists.

User can be able to select todo list and put it to back. Only one todo list could be active at one time.

User can be able to select todo list theme for each todo list.

User can be able to add/edit/remove items to the list.

Items count in the todo list can be limited to N items.

### Weather Application 32

Weather application settings can be available as front screen application icon.

Application can detect user location and suggest city at start up. Current location can be available as separate option and cannot be deleted.

User can be able to add several cities using text search with suggestions.

User can be able to switch between two navigation modes: one city and multiple cities.

In one city mode user can select only one city and switch between modes: day>week; day>next day; day>next week. Mode defines left/right swipes external touch sequence.

In multiple cities mode user can select several cities and switch between modes: day; week. Mode defines left/right swipes external touch sequence.

### Calendar Application 32

Calendar application settings can be available as front screen application icon.

If the phone has no accounts with calendar—add account screen can be displayed. Put to back button in action bar can be disabled in this case.

Add account option can open standard android account setup screen.

User can be able to choose one calendar from the list of available calendars at the phone.

User can be able to choose one of the following options for the back screen left/right navigation: event>next event> . . . ; day>next day> . . . ; week>next week> . . . ; event>day>week.

### Interactive Reminder Application 32

Interactive reminder application settings can be available as front screen application icon.

User can be able to choose from predefined list of interactive reminder templates.

User can be able to change repeating options.

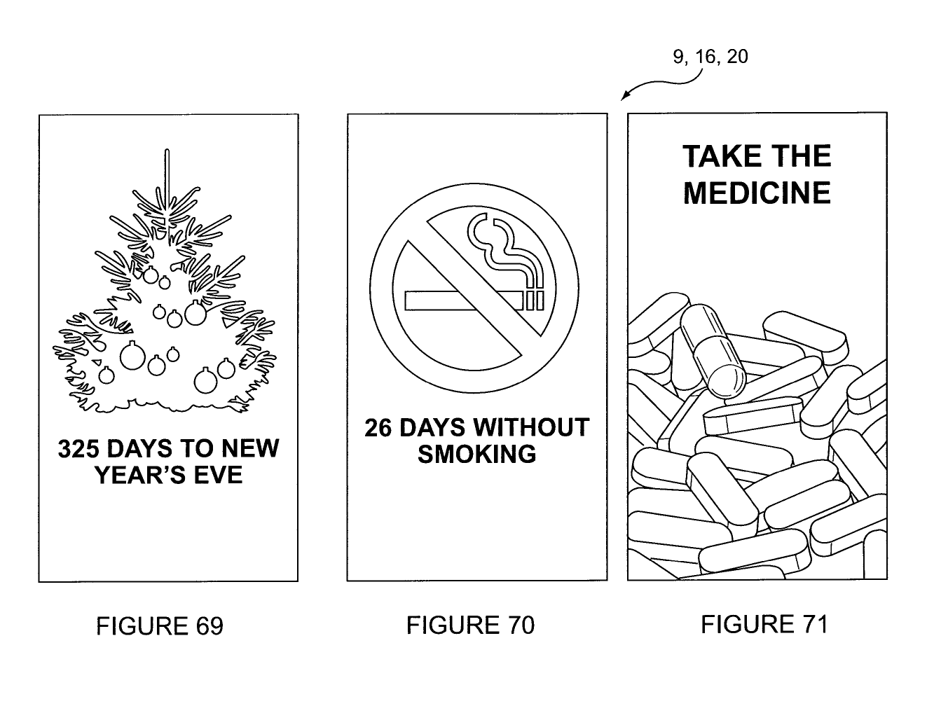

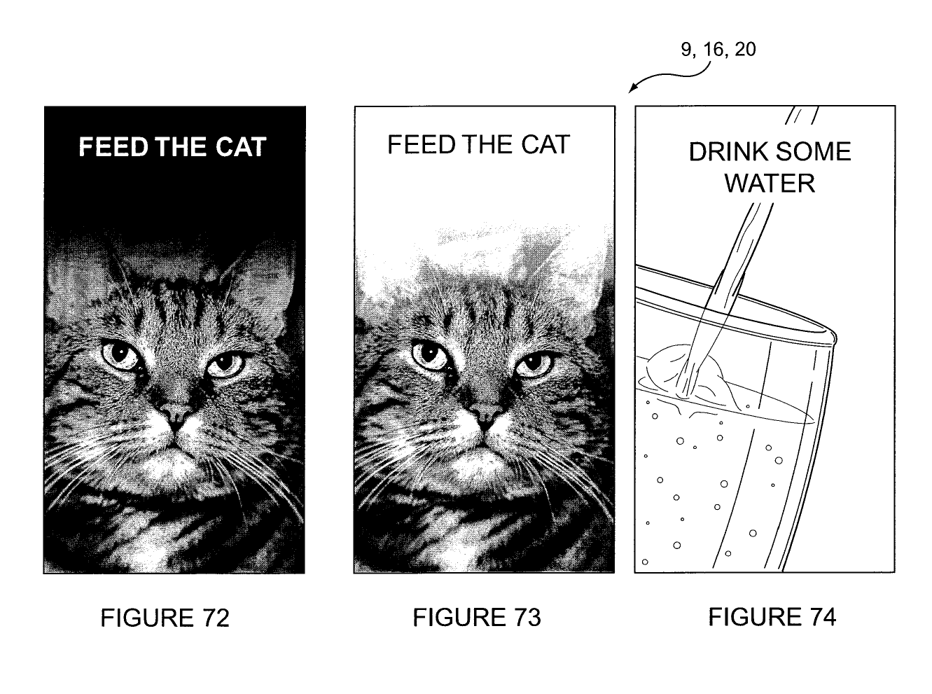

Interactive reminder application can not be available as separate back screen application. Only full screen notifications can be displayed. Examples of reminders displayed on the back screen are shown in FIGS. 68, 69, 72 and 73.

### Countdown Application 32

Countdown application settings can be available as front screen application icon.

User can be able to choose from predefined list of commitment templates.

User can be able to set date in two ways: starting from date, ending date.

User can be able to choose several commitments and switch with left/right swipes at the back screen between them.

User can be able to set custom commitment: change text and image.

User can be able to change reminder options for the each commitment (for ending date).

### Put to Back Application 32

Put to back screenshot history can be available as separate application icon at the front screen.

User can be able to use put to back gesture 18 to take screenshot and place it to the back screen without any additional action (see above for gesture description).

Put to back application can be available in the recent applications list.

User can be able to capture up to 10 screenshots and manage it via put to back front screen application.

User can be able to delete screenshots from history.

Left/right external touch panel swipes 18 can switch between put to back screenshots history.

If put to back history is empty—tutorial screen can be displayed in the front screen application. Put to back button in action bar can be disabled in this case.

User can be able to select screenshot from history and put it to back 18 from front screen application.

### Send Something Application 32

Send something application settings can be available as front screen application icon.

User can be able to choose from predefined list of send something templates.

User can be able to edit text in each template.

User can be able to add his/her own image.

User can be able to choose several send something screens and switch with left/right swipes at the back screen between them.

User can be able to add another device 10 and send something screens directly to it.

### Daily Quotes Application 32

Daily quotes application settings can be available as front screen application icon.

User can be able to select one or several quotes sources: famous people, jokes, etc.

User can be able to select refresh interval.

User can be able to switch between quotes using left/right external touch panel swipes.

### Birthday Application 32

Birthday application settings can be available as front screen application icon.

User can be able to select birthdays to remind from several sources: contacts, Facebook, VKontakte.

User can be able to add personal birthday's list to remind.

User can be able to view birthdays from all sources in one list.

Birthday application can not be available as separate back screen application. Only full screen notifications can be displayed.

Notification time settings can be available: previous day reminder time, birthday day reminder time.

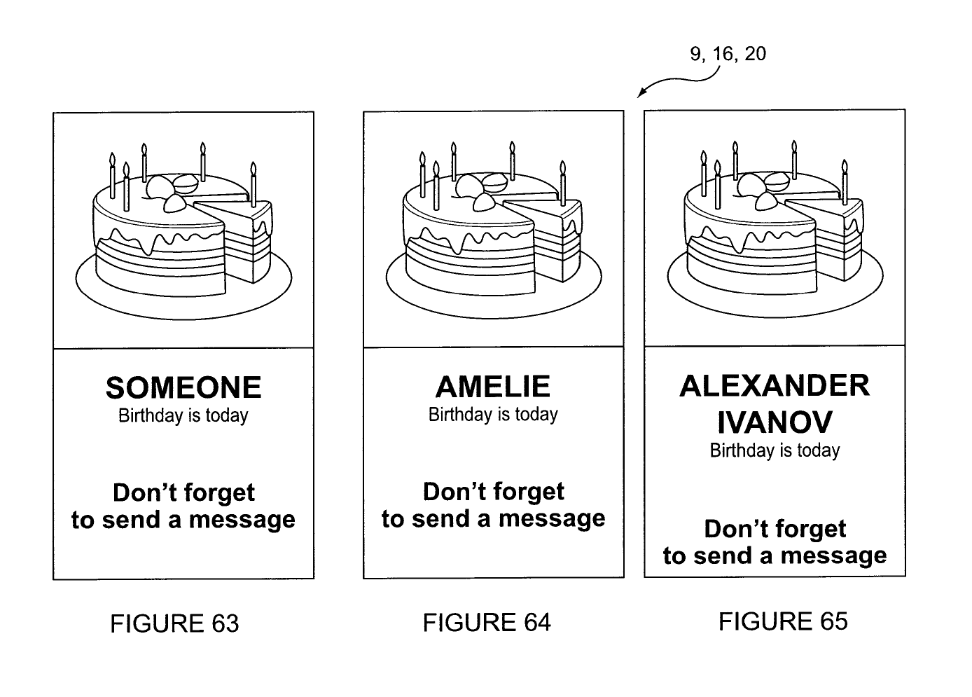

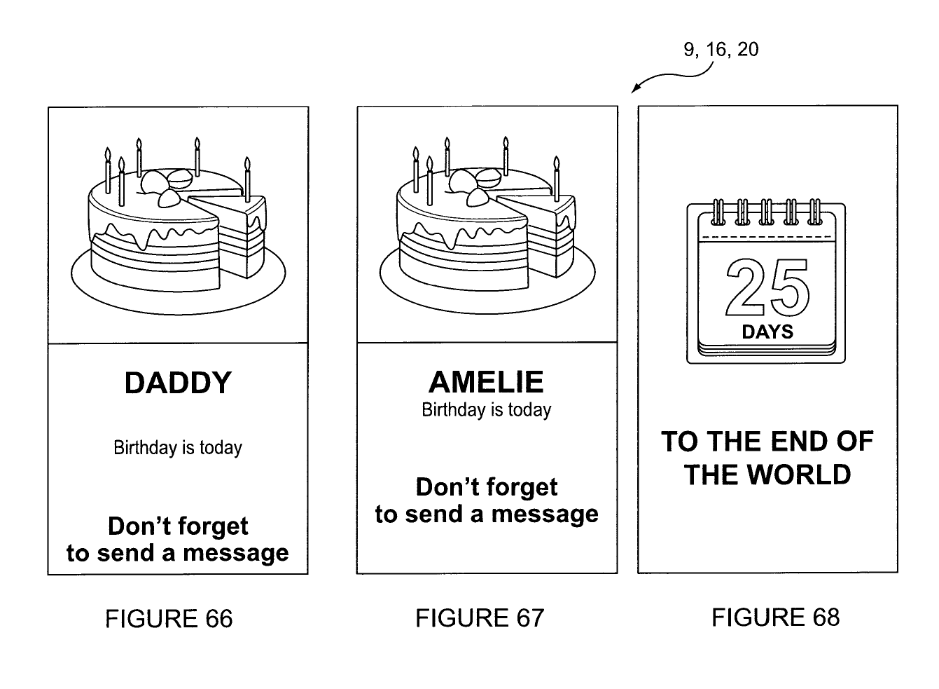

Examples of birthday reminder notifications on the back screen are shown in FIGS. 63 to 67.

RSS (“Rich Site Summary” dubbed “Really Simple Syndication”) reader application 32

RSS reader application settings can be available as front screen application icon.

User can be able to select one or more source from predefined RSS sources list. Sources setup screen can be displayed only at first start up.

User can be able to put RSS application to the back screen from front screen.

User can be able to add custom RSS link to the list. Link can be in RSS 2.0 on Atom format.

Application can display title, source name and time at the back screen.

User can be able to remove custom RSS links.

If RSS setup is complete, application icon can display the same tides list that available at the back screen. User can be able to select interesting tide and view full link in the web browser.

### Timer Application 32

Timer application settings can be available as front screen application icon.

User can be able to setup one timer at front screen settings.

User can be able to start timer with swipe at back screen touch area.

User can be able to stop timer with swipe at back screen touch area.

User can be able to reset timer at front screen settings.

User can be able to enable countdown timer (for hours, minutes and seconds).

This is a summary for an example design for the twin-screen smart phone 10 by Yota Devices. In it you can find our purpose, our vision and strategy for the brand, language, naming and visual storytelling principles. It outlines our go-to-market and social strategy and explores the many potential applications people can use with the device's unique properties.

Great smartphones are pretty much all made of the same stuff. But ours is made of love and wonder. This phone can be the physical manifestation of hope, hope for young makers and creatives. We believe creativity and innovation can come from everywhere, and it will. Our vision is for a truly social device.

### Our Uniqueness: Low-Fi is High-Emotion.

Tension between what you can select and programme onto the front screen with what you experience on the back. Opens up a huge new opportunity for unique aesthetics.

What it is: people will call it a smart phone, we know it's just about being social, about being human.

### Brand Principles:

Tone: “Made with love and wonder”

Humble and truly personal (because technology is rarely as as human relationships and interests)

Togetherness (both about people and the 2-sides of the device)

Surprise and Delight When you look at it you should smile.

Openness: The extraordinary potential of human creativity.

### Our Naming Strategy:

A description of the actual object

A description of how it is used

A description of emotional relationship

As short a word as possible

International

Unique and ownable

Dyad—from the Greek dyo meaning “two”

A dyad is the smallest possible social interaction between two people

Dyadic friendship is to have a ‘community of spirit’

And a dyadic communication is said to have ‘synchronicity of thought’

### User Behaviour Language:

“Twin” (verb) as in “can you twin that?”—as in, to copy, double or clone

“Duet” (noun) as in “let's have a duet”—as in, to speak together, in sync

“Yoke” (verb) as in “let's yoke the information”—as in, to bring together

What do we call the 2nd screen? Twin

### Tone of Voice

Who we are speaking to? Youthful, intelligent makers.

The character we speak to is that of a self-made creative entrepreneur.

“Made with love and wonder”
“You are made of infinite potential”
“No pixel count ever truly blew your mind”
“Social, not just social media.”

Aesthetic Description: how do we talk about what it looks like?

We cannot convince people this is a better smartphone. They will only believe what they want to believe. The challenge is to make them to want to believe it's better. Evoke the thought: “someone made this” (it could be me!)

“Cherished”

“Craft, etched, made, tools, canvas”

Subtle/quiet/humble visual stories

Full of life, full of emotion

Functional Description: how do we talk about what it does? Product messages

We cannot tell someone it is full of surprise and delight, we can surprise and delight them. We can make them to want to believe.

“Every maker can have her tools”

“Every artist needs the right canvas”

“Every craftsman can hone his craft”

### Going to Market:

The Dyad can inspire the next generation of creatives, designers and makers. They are our ambassadors, our army, and our Trojan horse.

To inspire them we can empower them.

We cannot not sell them our product. We will sell them our pursuit.

Our product is the physical manifestation of our pursuit. A souvenir of a belief system.

### Our First Customers:

Begin with those who have the most at stake, whose purpose is already aligned with our own. Show them the niche appeal and broad potential.

Empower them to create the future

Enable them to champion the brand

Transform them into our heroes, spokespersons and our brand's subculture tribe leaders

### Brand Messages:

Communicate our purpose: market our pursuit, not our product

Correct tone of voice to communicate: “made with love and wonder”

Creative hope and ambition is a global phenomenon, our messages are unified globally.

Align our customer's belief system to our product.

“Two sides of you.”

“Two sides of every story.”

“Smart and sensitive.”

“Be there. Be here.”

“It's time to share.”

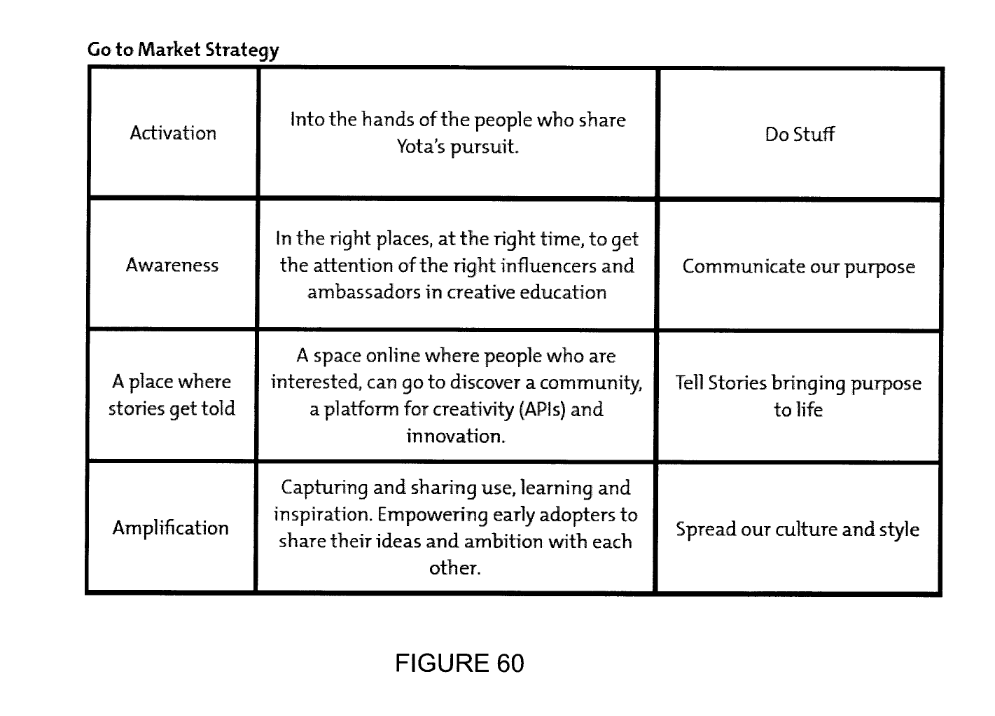

An example of a Go To Market Strategy is shown in FIG. 60.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

There are multiple examples, described as concepts ‘A-G’, in this disclosure. The following can be helpful in defining these concepts. Aspects of the concepts can be combined.

A. Bar Form Factor Display Device with Displayable Content

There is provided a bar form factor display device 10 comprising front and back major faces, the front major face arranged to present a first display and the back major face arranged to present a second display different to the first display, the device further comprising a computer system operable to run a plurality of application programs 32, wherein the computer system is configured to limit the arrangements in which content is displayable on the second display by the application programs.

The first display screen can be called the front display screen. The second display screen can be called the back display screen. The above can include additionally any of the following, alone or in combination:
arrangements are limited in that the entire second screen content is limited to being generated by a single application program at a given time.
arrangements are limited in that just a single screen type or layer is displayable on the second display at any one time.
Arrangements are generated by a dedicated set of routines callable by the application programs.
Arrangements are generated by a small set of possible applications.
Arrangements are generated by a small set of possible applications, in which the set contains less than ten applications.
different screen types are different information layers.
the screen type or layer is from a predefined hierarchy of screen types or layers and the highest screen type or layer in the hierarchy that is called by the computer system is displayed on the second display.
Hierarchy of screen types or layers includes: temporary modal notifications, render screen, temporary full screen notifications, time and date, notification collections, and wallpaper.
Displayed content includes location-dependent content.
Displayed content includes context-dependent content.
each screen type or layer stays on the second display until it is dismissed or until it is replaced by a screen of higher priority.
each screen type or layer stays on the second display until replaced by a new screen or layer.
When the second screen switches from one information layer type (e.g. notifications, commitments, wallpaper) to another, the entire second screen is replaced entirely with a different information layer image filling the entire second screen.
the second display screen automatically displays text or images that trigger memories or remind one of past moments.
the second screen automatically displays text or images that trigger memories or remind one of past moments in a way that is location dependent.
the second display screen displays simply a brand logo as a default screen, for a period controlled by the brand owner.
the second display screen is operable to display a brand logo as a reward.
the device is operable to distribute a reward to a user in response to the user allowing the device second display screen to carry a brand logo for a defined time.
TXT format messages from a defined set of users are automatically re-formatted to use a predefined stylised font with a predefined size.
TXT format messages from a defined set of users are automatically re-formatted to use a predefined stylised font, a predefined size and a predefined layout.
Phone can declare facts about itself with a human twist on the Essential screen—if it's dropped or banged an ‘Ouch’ message. If it's too hot, then an “I'm too hot” message. If it's lost, can declare ‘I'm lost!’
Context dependent wallpaper on the second display screen eg. an image of your home city when you′re travelling, showing a stylised simulation of how the city looks right now. When you′re at home, images reminding you of your next holiday.
Context dependent images—for example, if using the phone as a still camera, showing an image of the back of a still camera. If using it as a movie camera, then showing an image of the back of a movie camera.
social network feeds integrated into a wallpaper layer on the second display screen.
the device including cameras on the first major face and on the second major face, the computer system including facial recognition software detecting which display a user is looking at.
the application programs are of three types in general: applications displaying on first display only, applications displaying on the second display only, and applications displaying on the first display and on the second display.
Different types of applications have different icon styles.
There is a set of applications that is preinstalled on the device.
only one second screen application can display output on the second screen at one time.
Wallpaper/clock application is active at the first phone start up.
Back screen application selection menu has two layouts: 2×2 and 3×3.
2×2 Layout is used if user has 1 to 4 recent back screen applications.
3×3 Layout is used if user has 4 to 9 recent back screen applications.
applications which provide display output on the second display have a user-selectable option to move content from the first display to the second display.
applications which provide display output on the first display or on the second display have a user-selectable option to move content from the first display to the second display.
Back screen application selection menu is available as a front screen application.
user is able to remove back screen application from recent back screen applications list via front screen application for back screen application selection menu.
Back screen settings options are available via front screen application for back screen application selection menu.
full screen notifications are displayed on the second display until dismissed.
full screen notifications displayed on the second display are stacked in order of appearance.
full screen notifications displayed on the second display are stacked up to a maximum number of stacked notifications.
third party applications are operable to display full screen notifications on the second display.
the second display is operable to display notifications in two user-selectable modes, one mode showing notifications at a greater level of content detail than the other mode.
Back screen operable to display notifications in two user-selectable modes, one mode showing notifications at a greater level of content detail than the other mode, wherein both modes are operable to be user-disabled.
the device includes a setting according to which for any application a notification is displayed on the first display which corresponds to a notification displayed on the second display.
Back screen settings are available as separate application icon on the front screen.
back screen settings menu includes one or more of: Turn on/off notifications; Mode selection for notifications: private/public; The ability to disable public notifications for specific application; Music mode on/off for wallpapers application, and Shortcut to wallpapers settings.
User can select active clock collection.
User can select clock to display from the active clock collection.
Device includes preinstalled set of clock collections.
Device includes preinstalled set of selectable non-static wallpapers.
preinstalled set of selectable non-static wallpapers cannot be deleted.
User can activate or de-activate a selectable non-static wallpaper.
Weather live (i.e. non-static) wallpaper uses location information to provide user up to date information about weather.
User can choose manually one or several locations for Weather live wallpaper.
Left/right touch panel can switch between several locations for Weather live wallpaper.
Weather live wallpaper location includes background image based on current weather/city.
Social live wallpaper provides social user's information from different social networks.
the device is operable to receive a user instruction to select a todo list from first display and put it on the second display.
a put-to-back screenshot history of screenshots moved from the first display to the second display is selectable as a separate application icon in the first display screen.
the device is operable to receive a user instruction to select a screenshot from the history and put it to second display from the first display screen application.
the device is operable to receive a user instruction to take a first display screen screenshot and place it on the second display screen without any additional action.
Device includes an application in which a user can select from predefined message templates and send a message to the back screen of another user's device.
Rich Site Summary (RSS) reader application settings are available as front screen application icon.
User can put RSS application to the back screen from front screen.
Device includes a timer application, wherein a user can start the timer by performing a swipe gesture on the back screen touch area.
Device includes a timer application, wherein a user can stop the timer by performing a swipe gesture on the back screen touch area.

The above can include additionally any of the following, alone or in combination:
the second display screen uses electrowetting technology.
the second display screen is a bi-stable display screen.
Bar form factor display device is a slate device.
Bar form factor display device is a bar or candybar device.
Bar form factor display device is a slab-shaped form.
Bar form factor display device displays an image in the off state.
Bar form factor display device displays an image in a low power notification mode.
Bar form factor display device displays an image on the bi-stable display in the off state or in a low power notification mode.
Bar form factor display device first display screen is a liquid crystal display screen.
Bar form factor display device first display screen is an active-matrix organic light-emitting diode display screen.
Device appearance is context related.
Context related device appearance includes location-based advertising
Context related device appearance includes results of a location-based search.
The look of the device can be changed by changing what is displayed on the bi-stable screen.
The device skin can be changed.
The device skin is one or more of wallpaper, photos, movies, user-customized content.
The look of the device can be changed by changing what is displayed on the bi-stable screen to give the appearance of a different phone case.
There is provided a bi-stable active matrix and high-resolution display on the back panel of the device.
Regarding the back panel, user is able to display a pattern, picture or application interface to differentiate their phone from others.
any application or service executing on the device is able to display a notification on the back screen.
Notification time is not limited, because a bi-stable display is used.
The information remains on the back screen even when the phone itself is switched off.
in the off-state, the bi-stable display on the back face continues to display content, which can be viewed using external illumination.
the back face has an E-ink bi-stable display.
the front face has an AMOLED display, and the back face has an E-ink bi-stable display.
In the on state, the front face is back-illuminated and can display an image or other content; in the on-state, the bi-stable display on the back face also can display an image or other content.
front display is touch screen.
back screen is: Electronic Paper Display under glass.
back screen is: Grayscale panel.
back screen is: interferometric modulation technology panel.
back face is: perceived as part of case.
back face has low power consumption.
back screen resolution is similar to front display resolution.
back screen provides approximately at least 1000 full screen updates using 300 mAh of charge for a screen size of approximately 4 inches.
back screen update rate is the order of twice per minute.
back screen does not consume power or require power when in bi-stable state.
back screen output provides one or more of: Interactions, Control, Use cases,

Personalization, Widgets, Privacy.
back screen output provides Social aggregator output.
back screen output provides Latitude & Longitude eg. those of the device.
back screen output provides Location eg. device location.
back screen output provides Notifications.
back screen output provides Operator Push output.
back screen output provides news provided by a news service.
back screen output provides social messages provided by a social messaging service.
back screen output provides an indication of mobile phone signal strength.
back screen output provides an indication of battery charge state.
back screen output provides an indication of battery charge state in response to a battery charge level falling below a predefined level.
back screen output provides an indication of battery charge state in response to a battery charge level falling below a user-defined level.
back screen output provides an indication of battery charge state together with user-configurable content in response to a battery charge level falling below a predefined level.
back screen output provides an indication of battery charge state together with user-configurable content in response to a battery charge level falling below a user-defined level.
Back screen output provides an icon/image whose size depends on a quantity the icon/image represents.
Back screen output provides an icon/image whose size depends on a quantity the icon/image represents, wherein the quantity is user-configurable.
Back screen output is configurable as a configurable response to a selectable touch input gesture on the back screen of the device.
back screen output provides calendar information.
back display of the device is the only operational display of the device when the device operates in a low power notification mode.
when the device operates in a low power notification mode, the back display of the device displays content updates of one or more categories.
when the device operates in a low power notification mode, the back display of the device displays content updates of one or more categories, the categories including one or more of news, social messages, an emergency notification, financial news, earthquake, tsunami or weather.
when the device operates in a low power notification mode, the back display of the device displays content updates of one or more categories, wherein the categories are preselected
when the device operates in a low power notification mode, the back display of the device displays content updates of one or more categories, wherein the categories are preselected by a user
when the device operates in a low power notification mode, the back display of the device displays content updates of one or more categories, wherein the categories are preselected by a network services provider.
Bar form factor display device, wherein an application or service executing on the device is able to display a notification on the first screen.
Bar form factor display device, wherein any application or service executing on the device is able to display a notification on the first screen.
Bar form factor display device, wherein a message is provided on first screen and on second screen.
Bar form factor display device, wherein the second display screen output provides a social network screen.
Bar form factor display device, wherein the second display screen output provides social aggregator output or social network output.
Bar form factor display device, wherein the social aggregator output or social network output is a Facebook page.
Bar form factor display device, wherein the second display screen output provides a Google search page.
device is portable.
device is a mobile phone, a portable digital assistant, a laptop, or a tablet computer.
device includes a virtual keyboard.
device has a touch screen.
device has two screens each of which is a touch screen.
bi-stable screen is a touch screen.
bi-stable screen is not a touch screen.
A screen that is not a bi-stable screen is a touch screen.
device includes a second bi-stable screen.
device includes a second bi-stable screen which is a touch screen.
device includes a second bi-stable screen which is not a touch screen.
bi-stable screen occupies greater than 50% of the area of the major face of the device on which it is located.
bi-stable screen occupies greater than 70% of the area of the major face of the device on which it is located.
bi-stable screen occupies greater than 90% of the area of the major face of the device on which it is located.
bi-stable screen occupies greater than 95% of the area of the major face of the device on which it is located.
screen other than the bi-stable screen occupies greater than 50% of the area of the major face of the device on which it is located.
screen other than the bi-stable screen occupies greater than 70% of the area of the major face of the device on which it is located.
screen other than the bi-stable screen occupies greater than 90% of the area of the major face of the device on which it is located.
screen other than the bi-stable screen occupies greater than 95% of the area of the major face of the device on which it is located.
A second bi-stable screen occupies greater than 50% of the area of the major face of the device on which it is located.
A second bi-stable screen occupies greater than 70% of the area of the major face of the device on which it is located.
A second bi-stable screen occupies greater than 90% of the area of the major face of the device on which it is located.
A second bi-stable screen occupies greater than 95% of the area of the major face of the device on which it is located.
device comprises a single backlight module situated between its two major faces.
single backlight module illuminates one display on one major face.
single backlight module illuminates two displays each of which is situated on a different major face of the device to the other display
device comprises two backlight modules, each of which illuminates a display situated on a major face of the device
the two backlight modules each illuminates a respective display on a respective major face of the device
The two backlight modules are situated between two displays of the device, where each display is situated on a different major face of the device to the other display.
the device is a smartphone.

There is further provided a method of limiting the arrangement 9,16,20 in which content 9,16,20 is displayable on a bar form factor display device, the device comprising front and back major faces, the front major face arranged to present a first display and the back major face arranged to present a second display different to the first display, the device further comprising a computer system operable to run a plurality of application programs, wherein the computer system is configured to limit arrangements in which content is displayable on the second display by the application programs, the method comprising the step of: limiting the arrangement in which content is displayable on the second display by an application program.

There is further provided a computer program product for a bar form factor display device, the device comprising front and back major faces, the front major face arranged to present a first display and the back major face arranged to present a second display different to the first display, the device further comprising a computer system operable to run a plurality of application programs, wherein the computer system is configured to limit arrangements in which content is displayable on the second display by the application programs, the computer program product operable to limit the arrangement in which content is displayable on the second display by an application program.

B. Method of Providing Notification Messages in a Bar Form Factor Display Device with Limited Arrangement of Displayable Content

Method of providing notification messages on a bar form factor display device, the bar form factor display device comprising front and back major faces, the front major face arranged to present a first display and the back major face arranged to present a second display different to the first display, wherein the second display is a bi-stable display, comprising the steps of:
i) Executing software 45,48 on the device, the software operating the device in a low power notification mode in which the first display screen is off and in which the device is operable to receive a notification message;
ii) The software on the device receiving a notification message;
iii) The software on the device limiting an arrangement of the notification message 9,16,20 to a permitted arrangement, and
iv) Displaying the notification message 9,16,20 on the bi-stable display screen in the permitted arrangement based on any operational characteristics of the display screen.

The first display screen can be called the front display screen. The second display screen can be called the back display screen. The above can include additionally any of the following, alone or in combination:
the device further comprises a computer system operable to run a plurality of application programs.
the computer system is configured to limit arrangements in which content is displayable on the second display by the application programs.
the method comprising the step of: limiting the arrangement in which content is displayable on the second display by an application program.
arrangements are limited in that the entire second screen content is limited to being generated by a single application program at a given time.
arrangements are limited in that just a single screen type or layer is displayable on the second display at any one time.
Arrangements are generated by a dedicated set of routines callable by the application programs.
Arrangements are generated by a small set of possible applications.
Arrangements are generated by a small set of possible applications, in which the set contains less than ten applications.
different screen types are different information layers.
the screen type or layer is from a predefined hierarchy of screen types or layers and the highest screen type or layer in the hierarchy that is called by the computer system is displayed on the second display.
Hierarchy of screen types or layers includes: temporary modal notifications, render screen, temporary full screen notifications, time and date, notification collections, and wallpaper.
Displayed content includes location-dependent content.
Displayed content includes context-dependent content.
each screen type or layer stays on the second display until it is dismissed or until it is replaced by a screen of higher priority.
each screen type or layer stays on the second display until replaced by a new screen or layer.
When the second screen switches from one information layer type (e.g. notifications, commitments, wallpaper) to another, the entire second screen is replaced entirely with a different information layer image filling the entire second screen.
the second display screen automatically displays text or images that trigger memories or remind one of past moments.
the second screen automatically displays text or images that trigger memories or remind one of past moments in a way that is location dependent.
the second display screen displays simply a brand logo as a default screen, for a period controlled by the brand owner.
the second display screen is operable to display a brand logo as a reward.
the device is operable to distribute a reward to a user in response to the user allowing the device second display screen to carry a brand logo for a defined time.
TXT format messages from a defined set of users are automatically re-formatted to use a predefined stylised font with a predefined size.
TXT format messages from a defined set of users are automatically re-formatted to use a predefined stylised font, a predefined size and a predefined layout.
Phone can declare facts about itself with a human twist on the Essential screen—if it's dropped or banged an ‘Ouch’ message. If it's too hot, then an “I'm too hot” message. If it's lost, can declare ‘I'm lost!’
Context dependent wallpaper on the second display screen eg. an image of your home city when you′re travelling, showing a stylised simulation of how the city looks right now. When you′re at home, images reminding you of your next holiday.
Context dependent images—for example, if using the phone as a still camera, showing an image of the back of a still camera. If using it as a movie camera, then showing an image of the back of a movie camera.
social network feeds integrated into a wallpaper layer on the second display screen.
the device including cameras on the first major face and on the second major face, the computer system including facial recognition software detecting which display a user is looking at.
the application programs are of three types in general: applications displaying on first display only, applications displaying on the second display only, and applications displaying on the first display and on the second display.
Different types of applications have different icon styles.
There is a set of applications that is preinstalled on the device.
only one second screen application can display output on the second screen at one time.
Wallpaper/clock application is active at the first phone start up.
Back screen application selection menu has two layouts: 2×2 and 3×3.
2×2 Layout is used if user has 1 to 4 recent back screen applications.
3×3 Layout is used if user has 4 to 9 recent back screen applications.
applications which provide display output on the second display have a user-selectable option to move content from the first display to the second display.
applications which provide display output on the first display or on the second display have a user-selectable option to move content from the first display to the second display.
Back screen application selection menu is available as a front screen application.
user is able to remove back screen application from recent back screen applications list via front screen application for back screen application selection menu.
Back screen settings options are available via front screen application for back screen application selection menu.
full screen notifications are displayed on the second display until dismissed.
full screen notifications displayed on the second display are stacked in order of appearance.
full screen notifications displayed on the second display are stacked up to a maximum number of stacked notifications.
third party applications are operable to display full screen notifications on the second display.
the second display is operable to display notifications in two user-selectable modes, one mode showing notifications at a greater level of content detail than the other mode.
Back screen operable to display notifications in two user-selectable modes, one mode showing notifications at a greater level of content detail than the other mode, wherein both modes are operable to be user-disabled.
the device includes a setting according to which for any application a notification is displayed on the first display which corresponds to a notification displayed on the second display.
Back screen settings are available as separate application icon on the front screen.
back screen settings menu includes one or more of: Turn on/off notifications; Mode selection for notifications: private/public; The ability to disable public notifications for specific application; Music mode on/off for wallpapers application, and Shortcut to wallpapers settings.
User can select active clock collection.
User can select clock to display from the active clock collection.
Device includes preinstalled set of clock collections.
Device includes preinstalled set of selectable non-static wallpapers.
preinstalled set of selectable non-static wallpapers cannot be deleted.
User can activate or de-activate a selectable non-static wallpaper.
Weather live (i.e. non-static) wallpaper uses location information to provide user up to date information about weather.
User can choose manually one or several locations for Weather live wallpaper.
Left/right touch panel can switch between several locations for Weather live wallpaper.
Weather live wallpaper location includes background image based on current weather/city.
Social live wallpaper provides social user's information from different social networks.
the device is operable to receive a user instruction to select a todo list from first display and put it on the second display.
a put-to-back screenshot history of screenshots moved from the first display to the second display is selectable as a separate application icon in the first display screen.
the device is operable to receive a user instruction to select a screenshot from the history and put it to second display from the first display screen application.
the device is operable to receive a user instruction to take a first display screen screenshot and place it on the second display screen without any additional action.
Device includes an application in which a user can select from predefined message templates and send a message to the back screen of another user's device.
Rich Site Summary (RSS) reader application settings are available as front screen application icon.
User can put RSS application to the back screen from front screen.
Device includes a timer application, wherein a user can start the timer by performing a swipe gesture on the back screen touch area.
Device includes a timer application, wherein a user can stop the timer by performing a swipe gesture on the back screen touch area.

The above can include additionally any of the following, alone or in combination:
The software determines if the notification message is a new notification message, and the bi-stable display screen is updated only if the notification message is a new notification message.
notification messages are from a notification message provider.
The software on the device receiving a notification message from a notification message provider.
Displaying the notification message on the bi-stable display screen at a low screen update frequency.
the notification message comprises an image.
the notification message comprises text.
an application or service executing on the device is able to display a notification message on the back screen.
any application or service executing on the device is able to display a notification message on the back screen.
Notification message display time is not limited, because a bi-stable display is used.
Notification message remains on the back screen even when the phone itself is switched off.
the back face has an E-ink bi-stable display.
back screen is: Electronic Paper Display under glass.
back screen uses interferometric modulation display technology.
back screen resolution is similar to front display resolution.
back screen provides approximately at least 1000 full screen updates using 300 mAh of charge for a screen size of approximately 4 inches.
back screen update rate is the order of twice per minute.
Notification message is of one or more categories, the categories including one or more of news, social messages, an emergency notification, financial news, earthquake, tsunami or weather.
Notification message is a social network message provided on a social network screen.
Notification message is a social network message provided on a Facebook page.
Notification message is a social message provided by a social messaging service.
Notification message is a social message provided by a social networking service.
Notification message is of one or more categories, wherein the categories are preselected.
Notification message is of one or more categories, wherein the categories are preselected by a user.
Notification message is of one or more categories, wherein the categories are preselected by a network services provider.
Notification message is text message from a blog site.
Notification message is privacy controlled.
Maximum screen update frequency is a user settable parameter in the software.
device is portable.
the device is a mobile phone, a portable digital assistant, a laptop, a digital audio player (eg. ipod), or a tablet computer (eg. ipad).
device includes a virtual keyboard.
device has a touch screen.
Including the step of changing the skin of the bi-stable display screen.
The step of changing the skin of the bi-stable display screen comprises providing a skin which is one or more of: wallpaper, photos, movies, or user-customized content.
Including the step of providing context-related content on the bi-stable display screen.
The step of providing context-related content on the bi-stable display screen includes providing location-based advertising.
The step of providing context-related content on the bi-stable display screen includes providing results of a location-based search.
the device is a smartphone.
   C. Bar Form Factor Display Device with Hierarchy of Displayable Content

There is provided a bar form factor display device comprising front and back major faces, the front major face arranged to present a first display and the back major face arranged to present a second display different to the first display, the device further comprising a computer system, the computer system configured to display full screen content on the second display, wherein the full screen content display is prioritized according to a hierarchy of content types.

The first display screen can be called the front display screen. The second display screen can be called the back display screen. The above can include additionally any of the following, alone or in combination:
computer system is operable to run a plurality of application programs.
second display displayed content is limited in that the entire second screen content is limited to being generated by a single application program at a given time.
Arrangements are generated by a dedicated set of routines callable by the application programs.
Arrangements are generated by a small set of possible applications.
Arrangements are generated by a small set of possible applications, in which the set contains less than ten applications.
different screen types are different information layers.
the screen type or layer is from a predefined hierarchy of screen types or layers and the highest screen type or layer in the hierarchy that is called by the computer system is displayed on the second display.
Hierarchy of screen types or layers includes: temporary modal notifications, render screen, temporary full screen notifications, time and date, notification collections, and wallpaper.
the second display is a bi-stable display.
the first display is a touch screen, or the second display is a touch screen, or the first display and the second display are touch screens.
the device is portable.
the device is a mobile phone.
the device is a smartphone.

There is further provided a method of displaying content on a bar form factor display device comprising front and back major faces, the front major face arranged to present a first display and the back major face arranged to present a second display different to the first display, the device further comprising a computer system, the computer system being configured to display full screen content on the second display, the method including the steps of prioritizing the full screen content display according to a hierarchy of content types, and displaying the prioritized full screen content on the second display.

There is further provided a computer program product for performing a method of displaying content on a bar form factor display device comprising front and back major faces, the front major face arranged to present a first display and the back major face arranged to present a second display different to the first display, the device further comprising a computer system, the computer system being configured to display full screen content on the second display, the computer program product operable to perform the method steps of prioritizing the full screen content display according to a hierarchy of content types, and displaying the prioritized full screen content on the second display.

D. Bar Form Factor Display Device with Screen-Movable Content

There is provided a bar form factor display device comprising front and back major faces, the front major face arranged to present a first display and the back major face arranged to present a second display different to the first display, the device further comprising a computer system, the computer system configured to receive user input, the computer system operable to move content displayed on the first display to the second display in response to the user input.

The first display screen can be called the front display screen. The second display screen can be called the back display screen. The above can include additionally any of the following, alone or in combination:
first display is a touch screen display, and the user input is a predefined gesture on the first display.
First major face is operable to receive touch input, and the user input is a predefined gesture on the first major face.
Screenshots can be captured from the front screen and put on the back-screen.
There's a special application slot for the screenshot in the Home screen mode on the back-screen.
There is the the possibility to replace what is currently placed on the back-screen or to simply remove what is currently there.
A gesture first triggers a dialog which gives the user the possibility to replace what is currently placed on the back-screen or to simply remove what is currently there.
An option removes the Put to back application from the back-screen.
The Put to back application can be added to the back-screen again once the user chooses to place something new on the back screen.
Haptic feedback 18 is provided upon receipt of an input to move content displayed on the first display to the second display.
A Put to back screenshot history is available as separate application icon at the front screen.
User is able to use put to back gesture to take screenshot and place it to the back screen without any additional action.
User is able to capture up to a maximum number of screenshots and manage them via a put to back front screen application.
computer system is operable to run a plurality of application programs.
computer system is operable to display full screen content on the second display, wherein the full screen content display is prioritized according to a hierarchy of content types.
second display displayed content is limited in that the entire second screen content is limited to being generated by a single application program at a given time.
Arrangements are generated by a dedicated set of routines callable by the application programs.
Arrangements are generated by a small set of possible applications.
Arrangements are generated by a small set of possible applications, in which the set contains less than ten applications.
different screen types are different information layers.
the screen type or layer is from a predefined hierarchy of screen types or layers and the highest screen type or layer in the hierarchy that is called by the computer system is displayed on the second display.
Hierarchy of screen types or layers includes: temporary modal notifications, render screen, temporary full screen notifications, time and date, notification collections, and wallpaper.
the second display is a bi-stable display.
the first display is a touch screen, or the second display is a touch screen, or the first display and the second display are touch screens.
the device is portable.
the device is a mobile phone.
the device is a smartphone.

There is further provided a method of moving 18 content between displays on a bar form factor display device comprising front and back major faces, the front major face arranged to present a first display and the back major face arranged to present a second display different to the first display, the device further comprising a computer system, the computer system configured to receive user input, the method comprising the steps of the computer receiving an input signal 18 corresponding to a predefined instruction to move content displayed on the first display to the second display, and the computer system moving content displayed on the first display to the second display.

There is further provided a computer program product 48 operable to move 18 content 9,16,20 between displays on a bar form factor display device comprising front and back major faces, the front major face arranged to present a first display and the back major face arranged to present a second display different to the first display, the device further comprising a computer system, the computer system configured to receive user input 18, the computer program product operable to perform the steps of receiving an input signal 18 corresponding to a predefined instruction to move content displayed on the first display to the second display, and moving content displayed on the first display to the second display.

E. Bar Form Factor Display Device with Two Gesture-Input Faces

There is provided a bar form factor display device comprising front and back major faces, the front major face arranged to present a first display and the back major face arranged to present a second display different to the first display, the device further comprising a computer system configured to receive input gestures from the front major face, wherein the computer system is further configured to receive input gestures from the back major face.

The first display screen can be called the front display screen. The second display screen can be called the back display screen. The above can include additionally any of the following, alone or in combination:
front major face gesture input is received via a front major face capacitive panel.
front major face gesture input is received via the first display which is a touch screen.
Back major face gesture input is received via a back major face capacitive panel.
back major face gesture input is received via the second display which is a touch screen.
computer system is operable to run a plurality of application programs.
computer system is operable to display full screen content on the second display, wherein the full screen content display is prioritized according to a hierarchy of content types.
second display displayed content is limited in that the entire second screen content is limited to being generated by a single application program at a given time.
second display displayed content arrangements are generated by a dedicated set of routines callable by the application programs.
second display displayed content arrangements are generated by a small set of possible applications.
second display displayed content arrangements are generated by a small set of possible applications, in which the set contains less than ten applications.
different screen types are different information layers.
the screen type or layer is from a predefined hierarchy of screen types or layers and the highest screen type or layer in the hierarchy that is called by the computer system is displayed on the second display.
Hierarchy of screen types or layers includes: temporary modal notifications, render screen, temporary full screen notifications, time and date, notification collections, and wallpaper.
the second display is a bi-stable display.
the device is portable.
the device is a mobile phone.
the device is a smartphone.

There is further provided method of receiving gestures input 18 in a bar form factor display device comprising front and back major faces, the front major face arranged to present a first display and the back major face arranged to present a second display different to the first display, the device further comprising a computer system configured to receive input gestures 18 from the front major face, wherein the computer system is further configured to receive input gestures from the back major face, the method comprising the steps of receiving an input gesture from the front major face, and receiving an input gesture from the back major face.

There is further provided a computer program product operable to receive gestures input 18 in a bar form factor display device comprising front and back major faces, the front major face arranged to present a first display and the back major face arranged to present a second display different to the first display, the device further comprising a computer system configured to run the computer program product and to receive input gestures 18 from the front major face, wherein the computer system is further configured to receive input gestures from the back major face, the computer program product implementing the method steps of identifying an input gesture from the front major face, and identifying an input gesture from the back major face.

F. Bar Form Factor Display Device with Second Screen Supported as an Additional Hardware Device

There is provided a bar form factor display device comprising front and back major faces, the front major face arranged to present a first display and the back major face arranged to present a second display different to the first display, the device further comprising a computer system running an operating system, wherein the second display is supported in the operating system as an additional hardware device.

The first display screen can be called the front display screen. The second display screen can be called the back display screen. The above can include additionally any of the following, alone or in combination:
operating system is an Android operating system.
interaction with second display is done via small extensions in Android framework API.
Second display support does not use any major changes in Android framework,
Second display support does not break any compatibility.
all additional API's supporting the second display are NOT available for call from any 3rd party user application.
To access additional API's supporting the second display, applications can have permission and correct signature.
Producing output on the second display is performed by a dedicated software module.
Producing output on the second display is performed by a dedicated software module integrated into the platform build.
Producing output on the second display is performed by a dedicated software module signed with a platform certificate for access to second screen drawing API and broadcasts.
computer system is configured to receive input gestures from the front major face.
computer system is configured to receive input gestures from the back major face.
front major face gesture input is received via a front major face capacitive panel.
front major face gesture input is received via the first display which is a touch screen.
Back major face gesture input is received via a back major face capacitive panel.
back major face gesture input is received via the second display which is a touch screen.
computer system is operable to run a plurality of application programs.
computer system is operable to display full screen content on the second display, wherein the full screen content display is prioritized according to a hierarchy of content types.
second display displayed content is limited in that the entire second screen content is limited to being generated by a single application program at a given time.
second display displayed content arrangements are generated by a dedicated set of routines callable by the application programs.
second display displayed content arrangements are generated by a small set of possible applications.
second display displayed content arrangements are generated by a small set of possible applications, in which the set contains less than ten applications.
different screen types are different information layers.
the screen type or layer is from a predefined hierarchy of screen types or layers and the highest screen type or layer in the hierarchy that is called by the computer system is displayed on the second display.
Hierarchy of screen types or layers includes: temporary modal notifications, render screen, temporary full screen notifications, time and date, notification collections, and wallpaper.
the second display is a bi-stable display.
the device is portable.
the device is a mobile phone.
the device is a smartphone.

There is further provided a method of supporting a second display in a bar form factor display device comprising front and back major faces, the front major face arranged to present a first display and the back major face arranged to present the second display different to the first display, the device further comprising a computer system 42 running an operating system, the method comprising the step of supporting the second display in the operating system as an additional hardware device.

There is further provided a computer program product operable to support a second display in a bar form factor display device comprising front and back major faces, the front major face arranged to present a first display and the back major face arranged to present the second display different to the first display, the device further comprising a computer system 42 running an operating system, the computer program product supporting the second display in the operating system as an additional hardware device.

G. Bar Form Factor Display Device with Haptic Feedback

There is provided a bar form factor display device comprising front and back major faces, the front major face arranged to present a first display and the back major face arranged to present a second display different to the first display, the device further comprising a computer system, the computer system arranged to receive gesture input from the front face, the back face, or the front face and the back face of the device, and wherein the device is configured to provide haptic feedback from one or more components of the user interface 44 (e.g. screens 12,14, speakers, sensors, vibration device, etc.) in response to gesture input.

The first display screen can be called the front display screen. The second display screen can be called the back display screen. The above can include additionally any of the following, alone or in combination:
device provides haptic feedback in response to a long press.
device provides haptic feedback in response to a long press of at least 500 ms duration.
device provides haptic feedback in response to a two finger pan or flick.
device provides haptic feedback in response to a two finger pan or flick starting from outside the top of the screen.
device provides haptic feedback in response to a Screen Off gesture.
Haptic feedback is provided on the border where the Screen Off command is activated.
device provides haptic feedback in response to a Screen On gesture.
Haptic feedback is provided on the border where the Screen On command is activated.
device provides haptic feedback in response to a put-to-back gesture, which copies or moves first display displayed content to the second display.
Computer system has operating system.
operating system is an Android operating system.
the second display is supported in the operating system as an additional hardware device.
Second display support does not break any compatibility.
front major face gesture input is received via a front major face capacitive panel.
front major face gesture input is received via the first display which is a touch screen.
Back major face gesture input is received via a back major face capacitive panel.
back major face gesture input is received via the second display which is a touch screen.
the second display is a bi-stable display.
the device is portable.
the device is a mobile phone.
the device is a smartphone.

There is further provided a method of providing haptic feedback in a bar form factor display device comprising front and back major faces, the front major face arranged to present a first display and the back major face arranged to present a second display different to the first display, the device further comprising a computer system, the method comprising the steps of (i) the computer system receiving a gesture input from the front face, the back face, or the front face and the back face of the device, and (ii) the device providing haptic feedback in response to gesture input.

There is further provided a computer program product operable to provide haptic feedback in a bar form factor display device comprising front and back major faces, the front major face arranged to present a first display and the back major face arranged to present a second display different to the first display, the device further comprising a computer system, the computer program product when running on the computer system operable to perform the steps of (i) receiving a gesture input from the front face, the back face, or the front face and the back face of the device, and (ii) providing haptic feedback in response to gesture input.

### Further Use Cases

### 1. Visual SMS

1. User can sent any SMS message from any device, and if this SMS is received on YotaPhone—it will be processed by specific embedded algorithm
2. Algorithm processes SMM text, analyzing key words, phrases, tone, a many other parameters
3. As result of analysis, user of YotaPhone will not only see SMM text, but also some visual graphics/picture/icon representing SMS text
4. Example: SMS “I love you darling” will be shown on YotaPhone as SMS text on part the EPD screen and specific love illustration on another part of the screen

### 2. Themes/Dynamic Wallpapers

1. User can select and setup theme, which is specific application, drawing on the back screen specific image
2. Image is changing dynamically on the back screen according to pre-defined (specific for each theme) algorithm
3. Example: daytime—EPD screen image is changing depending on real time of the day
4. On the same image there are a specifically designed zones, where user information is shown, such as calendar events, battery status, incoming/missed calls/sms/messages/social network notifications
5. Image on EPD can be changed depending on the notification/real user data, e.g. Tree has a total number of leafs=total number of user's emails

### 3. Easy Reply to SMS/any Other Incoming Message

1. Once user receives SMS, it's shown on the back screen
2. By swiping on the back touch zone from the left to right—on the front screen—user is placed directly to target SMS reply input field

### 4. Sending Content Between YotaPhones

1. User selects image and put his text
2. User selects target contact from their address book, and sends this image+text
3. If user has YotaPhone—he will see received message (image+text) on his back screen, and could use this as wallpaper
4. If user doesn't have YotaPhone—he will receive weblink where same image will be stored

### 5. Smart Filtering

1. User of YotaPhone is able to control his privacy for BackScreen
2. User can select in settings either he wants that incoming messages from his favorite contacts will be shown in “big” format (with messages text/image) OR text/image/name will be hided

### 6. Reading

1. User opens reading app on front screen
2. User selects mode to read on back screen and book is transferred there
3. While reading, user meets footnotes on the pages. One it happens. User can just rotate the phone and see that footnotes of current page are described on front screen
4. Front screen window with footnotes explanation is changing else pending on book page on the back screen

### 7. Bookmate

1. User is easing book on the back screen
2. User rotates the phone and is able to put some notes about the content of the page
3. So user notes are linked with the current page and later user can find notes by page or vice versa

### Further Embodiments

A display assembly device comprising first and second faces, the first face arranged to present a first display and the second face arranged to present an optional second display, the device further comprising a computer system operable to run a plurality of application programs using one or more processors to execute a set of stored instructions, wherein the one or more processors is configured by the set of instructions to limit arrangements in which content is displayable on at least one of the displays as display content associated with an application program provisioned on a device infrastructure of the display assembly device. Device, wherein arrangements are limited in that just a single screen type or layer is displayable on the second display at any one time. Device, wherein the screen type or layer is from a predefined hierarchy of screen types or layers and the highest screen type or layer in the hierarchy that is called by the computer system is displayed on the second display. Device, wherein the hierarchy of screen types or layers includes: temporary modal notifications, render screen, temporary full screen notifications, time and date, notification collections, and wallpaper. Device, wherein each screen type or layer stays on the second display until it is dismissed or until it is replaced by a screen of higher priority. Device, wherein each screen type or layer stays on the second display until replaced by a new screen or layer. Device, wherein when the second screen switches from one information layer type (e.g. notifications, commitments, wallpaper) to another, the entire second screen is replaced entirely with a different information layer image filling the entire second screen. Device, wherein the arrangements are limited in that the entire second screen content is limited to being generated by a single application program at a given time. Device, wherein the arrangements are generated by a small set of possible applications. Device, wherein the set contains less than ten applications. Device, wherein the arrangements are generated by a dedicated set of routines callable by the application programs. Device, wherein full screen notifications are displayed on the second display until dismissed. Device, wherein full screen notifications displayed on the second display are stacked in order of appearance. Device, wherein full screen notifications displayed on the second display are stacked up to a maximum number of stacked notifications. Device, wherein third party applications are operable to display full screen notifications on the second display. Device, wherein the second display is operable to display notifications in two user-selectable modes, one mode showing notifications at a greater level of content detail than the other mode. Device, wherein the two user-selectable modes are operable to be user-disabled. Device, wherein the device includes a setting according to which for any application a notification is displayed on the first display which corresponds to a notification displayed on the second display. Device, wherein the application programs are of three types in general: applications displaying on first display only, applications displaying on the second display only, and applications displaying on the first display and on the second display. Device, wherein the different types of application programs are presented on the first display or on the second display in different icon styles. Device, wherein applications which provide display output on the second display have a user-selectable option to move content from the first display to the second display. Device, wherein applications which provide display output on the first display or on the second display have a user-selectable option to move content from the first display to the second display. Device, wherein only one second screen application can display output on the second screen at one time. Device, wherein the device is operable to receive a user instruction to select a todo list from first display and put it on the second display. Device, wherein the device is operable to receive a user instruction to take a first display screen screenshot and place it on the second display screen without any additional action. Device, wherein a put-to-back screenshot history of screenshots moved from the first display to the second display is selectable as a separate application icon in the first display screen. Device, wherein the device is operable to receive a user instruction to select a screenshot from the history and put it to second display from the first display screen application. Device, wherein displayed content includes location-dependent content. Device, wherein displayed content includes context-dependent content. Device, wherein the second display screen automatically displays text or images that trigger memories or remind one of past moments. Device, wherein the second screen automatically displays text or images that trigger memories or remind one of past moments in a way that is location dependent. Device, wherein the second display screen displays simply a brand logo as a default screen, for a period controlled by the brand owner. Device, wherein the second display screen is operable to display a brand logo as a reward. Device, wherein the device is operable to distribute a reward to a user in response to the user allowing the device second display screen to carry a brand logo for a defined time. Device, wherein TXT format messages from a defined set of users are automatically re-formatted to use a predefined stylised font with a predefined size. Device, wherein TXT format messages from a defined set of users are automatically re-formatted to use a predefined stylised font, a predefined size and a predefined layout. Device, wherein the device can declare facts about itself with a human twist on the second display screen. Device, including context dependent wallpaper on the second display screen. Device, including social network feeds integrated into a wallpaper layer on the second display screen. Device, the device including cameras on the first major face and on the second major face, the computer system including facial recognition software detecting which display a user is looking at.

Referring to FIGS. 1 to 84, shown are alternative examples of display data 9 shown on the two different display screens 12,14 due to the event 18. However, it is also recognised that the display data 16,20 can both be shown simultaneously or sequentially on a single display 12 (i.e. same display) as provided by the mobile assembly 10.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

APPENDIX OF MULTIPLE EXAMPLE USER CASES FOR THE FRONT AND BACKSCREEN OF THE MOBILE ASSEMBLY 10 (E.G. PHONE) AS DESCRIBED ABOVE, SUCH THAT SIMILAR TERMINOLOGY BELOW CAN BE ASSOCIATED WITH SIMILAR TERMINOLOGY PROVIDED ABOVE

1. A display assembly device comprising first and second faces, the first face arranged to present a first display and the second face arranged to present an optional second display, the device further comprising a computer system operable to run a plurality of application programs using one or more processors to execute a set of stored instructions, wherein the one or more processors is configured by the set of instructions to limit arrangements in which content is displayable on at least one of the displays as display content associated with an application program provisioned on a device infrastructure of the display assembly device.

2. Device of claim 1, wherein the second display is a bi-stable display.

3. Device of claim 1, wherein the first display is a touch screen, or the second display is a touch screen, or the first display and the second display are touch screens.

4. Device of claim 1, wherein the second display is a touch screen, and wherein second screen output is configurable as a configurable response to a selectable touch input gesture on the second screen of the device.

5. Device of claim 1, wherein the first display is a bi-stable display.

6. Device of claim 1, wherein the device is a bar factor mobile phone.

7. Device of claim 1, wherein the device assembly is a bar factor mobile phone coupled to a device cover.

8. Device claim 1, wherein the computer system is configured to limit arrangements in which content is displayable on the second display in that the computer system includes a secure processor configured to limit arrangements in which content is displayable on the second display.

9. Method of limiting the arrangement in which content is displayable on a bar form factor display device, the device comprising front and back major faces, the front major face arranged to present a first display and the back major face arranged to present a second display different to the first display, the device further comprising a computer system operable to run a plurality of application programs, wherein the computer system is configured to limit arrangements in which content is displayable on the second display by the application programs, the method comprising the step of: limiting the arrangement in which content is displayable on the second display by an application program.

10. Computer program product for a bar form factor display device, the device comprising front and back major faces, the front major face arranged to present a first display and the back major face arranged to present a second display different to the first display, the device further comprising a computer system operable to run a plurality of application programs, wherein the computer system is configured to limit arrangements in which content is displayable on the second display by the application programs, the computer program product operable to limit the arrangement in which content is displayable on the second display by an application program.

11. The device of claim 1, wherein the display content is based on an identified state of the application program to result in display data transferred from the first display to the second display.

12. The device of claim 1, wherein the display content is based on an identified state of the device infrastructure to result in display data transferred from the first display to the second display.

13. The device of claim 1, wherein the display content is based on an identified state of the device infrastructure to result in display data redirected from display on the first display to display on the second display.

14. The device of claim 13, wherein the device infrastructure has the state of the first display in a powered off mode.

15. The device of claim 1, wherein the display content represents a notification message.

16. The device of claim 1, wherein the display content is from the software program that is authenticated to display data on the first display.

17. The device of claim 1, wherein the display content is based on an identified event of the application program to result in contextual display data displayed on the second display based on application workflow event performed by the software application via the first display.

18. The device of claim 1, wherein the display content is based on an identified event of the device infrastructure to result in contextual display data displayed on the second display based on application workflow event performed by the device infrastructure via the first display.

19. The device of claim 1, wherein the display content is based on an identified event of the device infrastructure or the application program to result in display data redirected from display on the first display to display on the second display, wherein the device infrastructure has a state of the first display in a powered off mode.

20. The device of claim 1, wherein the display content is based on haptic input and output related to a user interface operation of the user interface of the device and haptic related data received by a network device over a communications network, a network interface of the device connected to the network interface to send and receive haptic related data.
